(19) United States
(12) Patent Application Publication
(10) Pub. No.: US 2014/0231512 A1
(43) Pub. Date: Aug. 21, 2014

(54) COMPUTERIZED VOTING SYSTEM

(71) Applicant: Daniel W. ONISCHUK, Edmonton (CA)

(72) Inventor: Daniel W. ONISCHUK, Edmonton (CA)

(21) Appl. No.: 13/769,354

(22) Filed: Feb. 17, 2013

(51) Int. Cl. G07C 13/00

(52) U.S. Cl. CPC G07C 13/00
USPC 235/386

(57) ABSTRACT

Officials using computers research and create lists of Certified Registered Voters and Proxies whom are sent computer encoded ballots and return containers. Each Ballot and correlated Receipt(s) share a unique Random Symbolic Identifier (RSID) and use embedded Security Elements to prevent counterfeiting. For privacy, before voting, Voters-Proxies optionally exchange ballots and return containers within their Voting Region, validating ballots electronically or in-person by submitting Ballot Validation RSID to Officials. Voter-Proxy completes ballot(s), adds Personal Security Identifier(s), receives ballot receipt, delivery receipt upon sending ballot to Officials via postal mail, Interactive Television, Internet, Telephone, Fax, Email, In-person. Received ballots are electronically-optically recorded; if timely and authentic, voter selections are extracted, tallied if properly marked, and published to Voters' private data area accessed via Receipt RSID. Official devices, communications computer processing partially managed and optimized by computers running artificial intelligence software programs. After voting ends, Officials publish all data for integrity verification.

claims international filing rights of Paris Convention Treaty for Canada Patent App. 2,469,598

### PURPOSE OF INVENTION

Secure, Accurate, Rapid Processing of Voter Ballots & Registrations

### TECHNICAL PROBLEMS RESOLVED

1. improve accuracy, time and money savings of compiling voter lists;

2. extend the process of voting to encompass more voters by providing significantly easier access to the process of voting;

3. extend the process of voting to encompass candidates, proposals or any combination of candidates and proposals;

4. maintain security, privacy and anonymity of voter ballots cast;

5. enable voters to anonymously verify and correct the accuracy of official records of any ballots they have cast, by using electronic devices connected to communications networks;

6. prevent counterfeit ballots by special security elements and methods;

7. enable voters to verify ballots authenticity and validity by using electronic devices connected to communications networks;

### INVENTION USES

1. Elections to select political candidates to Government duty.

2. Corporate group of stockholders vote to elect a Chief Executive Officer.

3. Public vote on passing a Government Bill Proposal as a Public Law.

4. Stockholders vote to accept or reject proposals on business activities.

### BACKGROUND OF INVENTION

Although this invention was conceived without reference to existing patents, this invention differs from several existing patents significantly. The purpose of this patent is to overcome the following issues and limitations of existing patents:

### CROSS REFERENCE TO RELATED APPLICATIONS

| | | | | | |
|---|---|---|---|---|---|
| 3,141,976 | May 1974 | Hune | 6,688,517 | Febuary 2004 | McClure |
| 6,640,138 | April 2003 | Hall & Schwartz | 6,457,643 | October 2002 | May |
| 6,722,562 | April 2004 | Weiss | 6,726,090 | April 2004 | Kargel |
| 7,975,920 | July 2011 | Chung & Dong | 7,861,918 | January 2011 | Strabone |
| 7,451,928 | November 2008 | Peterson | 8,024,570 | September 2011 | Noble |
| 6,888,898 | May 2005 | Chenes | 7,847,696 | December 2010 | Karjoth, et al |

Although Hall & Schwartz et al—U.S. Pat. No. 6,054,0138 refer to the use of scanning devices and scannable barcodes, the barcodes themselves are not easily human readable, nor easily compatible with translation for telephone use. Furthermore, the process of Hall & Schwartz et al implicitly violates Voter privacy as the there are means to link any persons vote to the ID number they are assigned for voting, such as visual observations of ID number, electronic interception of a generated ID number. Any Voter can also be linked to a ballot by witnesses as to the date, time and place where the ballot is cast.

The same implication of linking of a specific ballot to a specific Voter can also be said for the patent of Way—U.S. Pat. No. 6,457,643 Way remarks “7. A ballot paper as claimed in claim 5 or claim 6 wherein the unique identifier is generated from a Voter's position on an electoral roll, the date and time the ballot paper was issued, and an external value contributed by a key.”; Thus Officials could know when & where the specific ballot identifier was issued to a specific person, therefore the alleged privacy is penetrable through observation and deduction. Electronic surveillance technology could be used to detect electromagnetic waves emitted from devices issuing IDs which could then be sent to a portable computer that use software to determine an ID. The patent of Weiss U.S. Pat. No. 6,722,562 involves the use of Automated Teller Machines also links a Voter to a specific card and their personal identity number (PIN). Although ATM voting cards could be exchanged among Voters, ATM machines have cameras which would record the Voters face, along with the location, date and time of the ballot cast from that particular ATM. The massive coordination of banks with government. computer software adaptation and privacy issues may prevent adopting this method. Furthermore, the magnetic field of ATM cards may be easily corrupted by mistake or intent. However due to some similarities, it should be re-emphasized that this patent was developed without prior knowledge of Kargel U.S. Pat. No. 6,726,090 or any of the other patents, especially recent patents (Chung, Strabone, et al) which several years after my filing, and previously published patent applications. Chung appears to have copied various concepts including imaging entire ballots using high speed scanning devices, use of ATM smart cards for ballots and voter information, and Strabone appears to reworded my previously filed descriptions of voting regions; Yet, this invention overcomes disadvantages of Kargel, Chung and other patents by unique methods of:

a. creating computer data lists to identify eligible Voters;

b. unique identifiers to trace/link Registration Forms to Voters;

c. unique identifiers to trace/link Ballots distribution to Voters;

d. providing Voters with information to facilitate voting;

e. decoupling Voters from specific ballots to provide vote anonymity;

f. collecting ballots and registrations from Voters and tracking the items received;

g. telephonic and/or internet voting that does not enable the Official person to link a specific ballot ID to a specific Voter (in Kargel, Official person does not know if the Voter is legitimate, cannot protect Voter privacy when using an identifiable ballot)

h. to use unique identifiers to distinguish MASTER Ballots and their duplicates to prevent multiple voting using both ballots at different voting locations;

i. of using at least one computer or telephone communication network; to facilitate ballot issuance, ballot replacement, ballot Validation, private verification of voting;

j. ensuring ballots may not be counterfeited, to prevent unfair influence in results;

k. providing ballots with Security Elements to assist with Authentication;

l. providing symbols and data on the ballot to reduce human processing;

m. voting to include people, proposals, or, any combination of people, proposals.

n. providing an expiry time and/or date on the ballot to limit ballot use;

o. providing additional information on the ballot to facilitate accurate completion;

p. providing additional information to help the Voter via a Voter Information Forms;

After considering Chung, this invention is different and unique as there is no requirement to identify and link any specific Voter to any Ballot or the Ballot container (Chung & Dong claims 9,11,29)—instead, this invention provides Voter privacy and prevents Official knowledge of any Voter link to a particular Ballot and the selections and write-in choices thereon;

After considering Hune—U.S. Pat. No. 3,941,976 it should be noted this invention also adds:

(i) assists the principles of democracy by making it easier for people to participate in voting, enabling the more accurate representation of Voters choices.

(ii) ensures the integrity of the ballots so that the processing and voting selections may be verified and adjusted by the Voter and Official persons upon detection of any processing errors after the ballot has been processed.

(iii) use of a Random Symbolic ID (RSID) and other security elements and processes so as to ensure the integrity of Ballots so that a WHOLE Ballot, MASTER part of a WHOLE Ballot, and the RECEIPT part of a WHOLE Ballot (and/or Voter Registration Form, or any other document-form of this invention) may not be easily duplicated in any quantity to significantly affect the overall percentage of vote tallies, and any such duplicates would be immediately detected and removed for investigation to guarantee integrity of the final certified tally.

(iv) additional security by use of Random Symbolic Identifiers (RSID's) or other Security Elements, which are evaluated to determine data accuracy and/or authenticity of Ballots, Registration forms, Containers, data transmissions.

(v) optionally applying tamper-proofing methods of signatures, dates, private passwords;

(vi) utilizing ballot activation documents prior to voting;

(vii) providing Voters receipts to confirm voting successful completing and a copy of voting;

### SUMMARY OF INVENTION

The present invention provides a method and system that improves and extends the tasks of certifying eligible voters, voter participation, ensuring accurate vote reception, tallying, verification, and error reporting. The major components of the method involve providing specially designed Ballots to a group of voters; recording Ballots received from the group of voters; tallying the votes from Ballots that were authenticated and validated; publishing the vote tallies from the group; verifying the published Ballot votes and tallies on a per-voter basis; and certifying the groups tallied Ballot votes were accurately recorded and counted. Systems are also taught herein for accomplishing these tasks in many ways, by use of:

1. acquiring information from computer databases and other sources to organize and construct any number of Lists of Eligible Voters; and furthermore, Lists of Officials, and other data relevant to the Voting Session.

2. a Paper Voting method employing the use of a carbon copy or carbonless copy paper WHOLE Ballot which comprises of a unique identifier; furthermore that this identifier be extremely difficult to guess, Random Symbolic Identifiers, or, sequential series of unique identifiers, or, a hybrid of random and sequential identifiers;

3. specially designed Security Elements for authentication and LIMITS OF USE data;

4. optical barcodes and other codes to facilitate computer processing;

5. Telephone Voting methods described herein this invention;

6. electronic facsimile (FAX) Voting methods described herein this invention;

7. Internet Voting methods secure web-pages);

8. audio voting methods;

9. video voting method with optional audio voting methods;

However, the particular systems discussed herein are given as some of the illustrations of particular embodiments of the invention. Other embodiments of the invention are expected to employ differing degrees of automation in providing, validating, authenticating, recording, tallying, publishing, certifying recorded and tallied votes. The systems taught and described herein are not intended to limit the application of the method claimed. The method of the invention must involve instrumentalities and combinations having different manifestations of representation, physical sizes and characteristics to suit the many corresponding physical limitations, abilities, and requirements that bear on a particular voting session or the available technology used to achieve some purpose for any voting session. The spirit of this invention will be fulfilled as long as the principles of ensuring all Eligible Voters have anonymity when casting their initial ballots, and may anonymously verify or report errors regarding the record of their ballots, thus ensuring the election system provides the intended equality for each vote cast. Accordingly, it is an object of the present invention to provide a voting method and system that allows one or more voters to completely verify the accurate recording, tally and publication of each vote on any Proposal or Candidate or any number of combinations of candidates and proposals; and it is a further object of the invention to provide: (a) a voting method and system that allows each Voter and Official to verify their votes on any Proposal or Candidate was correctly recorded, tallied and published; (b) each voter with a private RECEIPT ballot record of the voter's MASTER ballot vote; (c) a public post-polling record of all votes cast on a proposal or candidate; (d) the capability for voters to use their private RECEIPT ballot records of their cast MASTER ballot votes to verify or authorize correction of the public record of all ballots and votes cast; (e) the capability for voters to use the verified or corrected public record of all votes cast to verify or authorize correction of the tallies or summaries of votes; (f) vote verification and/or vote correction capabilities in a voting method or system that utilizes any physical, or, electronic, or, optical means of providing, receiving, recording validating, verifying, authenticating, tallying, summarizing, publishing and certifying: votes, ballots records, tallies, summaries or results; (g) a voting system the capability for voters to use the records of all Eligible Voters to verify or authorize correction of their name and contact information to any list of Eligible Voters; (h) vote verification and/or vote correction capabilities in a voting method or system that utilizes any physical, or, electronic, or, optical means of providing, receiving, recording validating, verifying, authenticating, tallying, summarizing, publishing and certifying any records, tallies, summaries or publications of any List of Eligible Voters. In addition to the foregoing, further, objects, features, and advantages of the present invention should become more readily apparent to those skilled in the art upon a reading of the following detailed description in conjunction with the drawings, wherein there are shown and illustrated as examples of embodiments of the invention. It is evident that those skilled in the art may now make numerous other uses and modifications of and departures from the specific embodiments described herein without departing from the inventive concepts. Consequently, this invention is to be construed as embracing each novel feature or novel combination of novel features present in or possessed by the methods and techniques herein disclosed and is not to be limited to the spirit or scope of these descriptions, disclosures, appended claims or drawings.

There are 32 (Thirty-Two) drawings included for this invention:

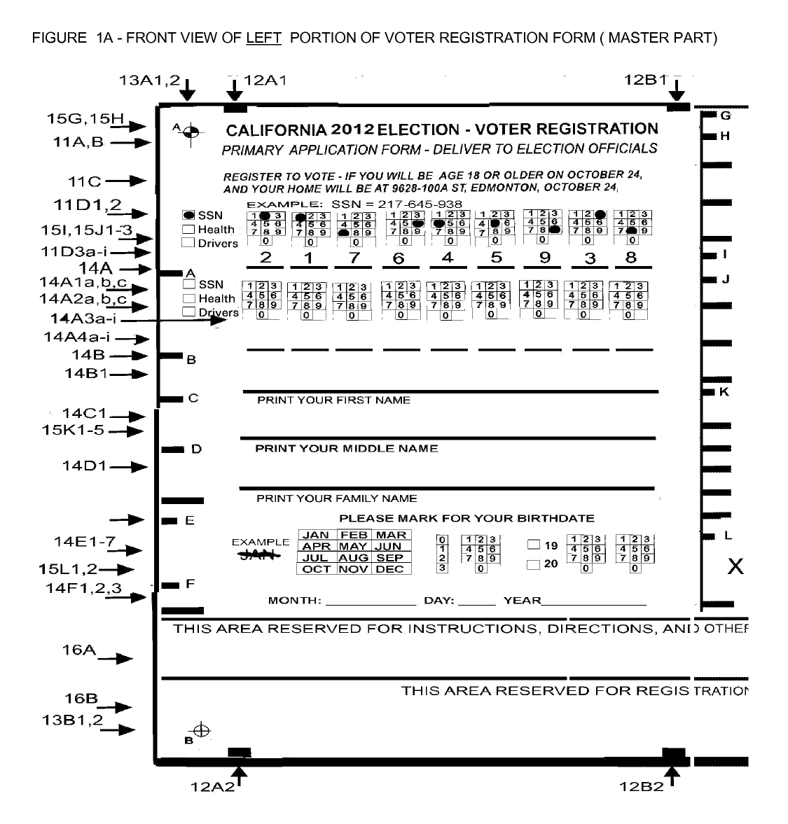

FIG. 1: is a site plan view for the FRONT side of a FIRST embodiment of a Voter Registration MASTER part a WHOLE Voter Registration Form (whereby a WHOLE form is comprised of ONE MASTER part and any number of RECEIPT part(s))—whereby the Voter Registration MASTER part is comprised of two portions: FIG. 1A, 1B such that:

FIG. 1A: a site plan view for the FRONT side of a FIRST embodiment of a Voter Registration MASTER part, showing the LEFT SIDE portion of a Voter Registration MASTER part—which with some modifications may also be the left side portion of a Proxy Voter Registration Master part;

FIG. 1B: a site plan view for the FRONT side of a FIRST embodiment of a Voter Registration MASTER part, showing the RIGHT SIDE portion of a Voter Registration MASTER part—which with some modifications may also be the right side portion of a Proxy Voter Registration Master part;

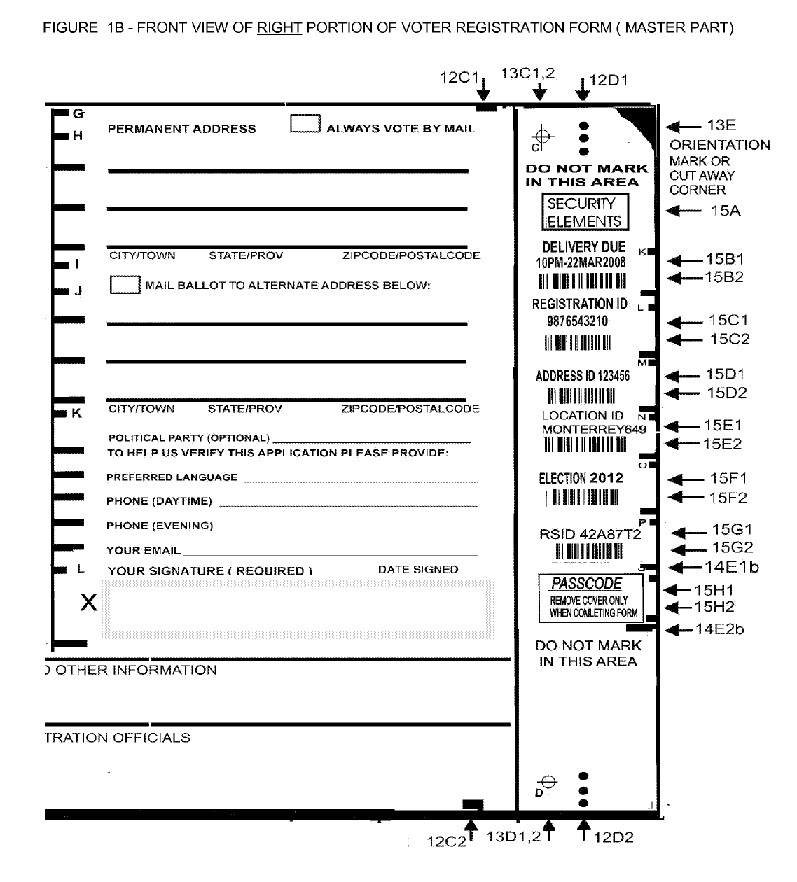

FIG. 2: is a site plan view for the FRONT side of a FIRST embodiment of a Voter Registration RECEIPT part a WHOLE Voter Registration Form—whereby the Voter Registration RECEIPT part is correlated to FIG. 1 and is comprised of two portions: FIG. 2A, 2B such that:

FIG. 2A: a site plan view for the FRONT side of a FIRST embodiment of a Voter Registration RECEIPT part, showing the LEFT SIDE portion of a Voter Registration RECEIPT part—which with some modifications may also be the left side portion of a Proxy Voter Registration Receipt part;

FIG. 2B: a site plan view for the FRONT side of a FIRST embodiment of a Voter Registration RECEIPT part, showing the RIGHT SIDE portion of a Voter Registration RECEIPT part—which with some modifications may also be the left side portion of a Proxy Voter Registration Receipt part;

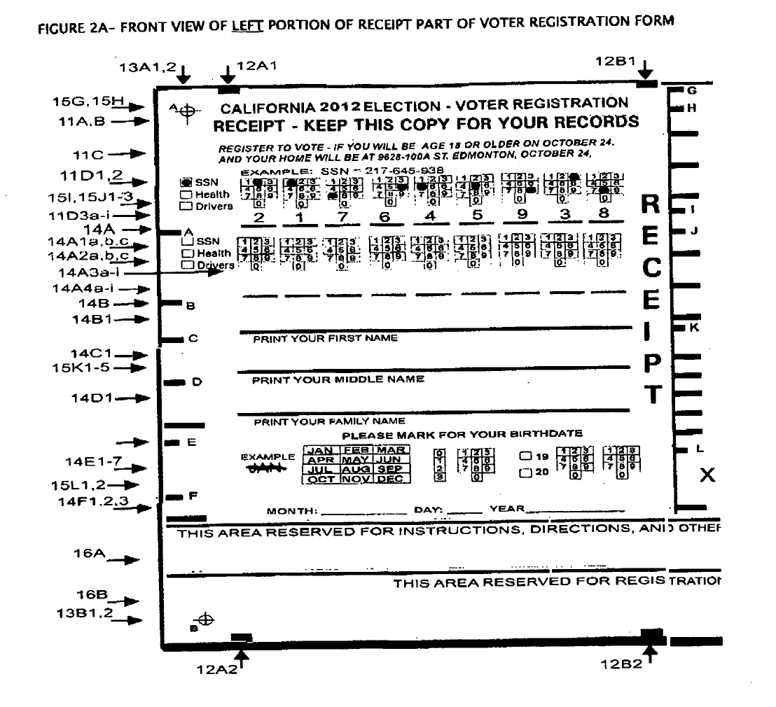

FIG. 3: a site of view for the FRONT side of a FIRST embodiment of a MASTER Voter Language Registration part of the WHOLE Voter Language Registration;

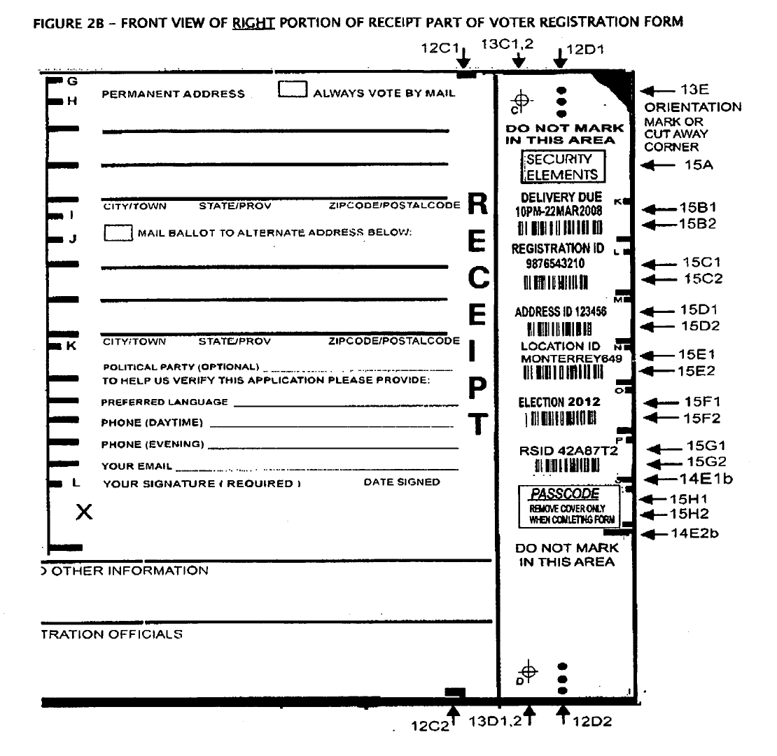

FIG. 4: a site of view for the FRONT side of a FIRST embodiment of a Voter-Proxy Language Registration RECEIPT part of the WHOLE Voter-Proxy Language Registration;

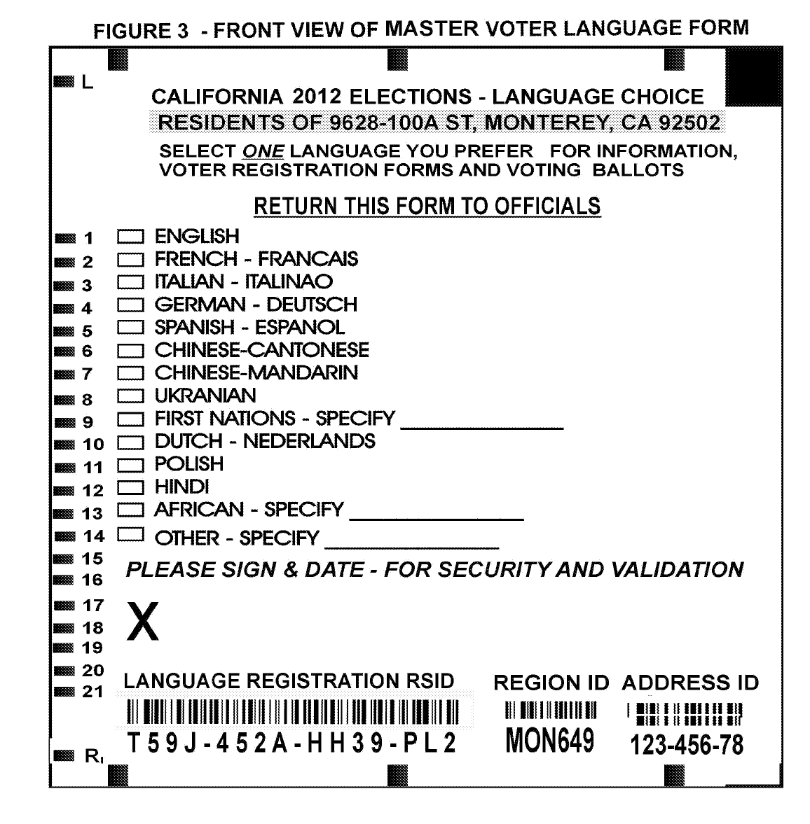

FIG. 5: a site plan view for the FRONT side of a FIRST embodiment of a MASTER Ballot part of a WHOLE Ballot of the invention.

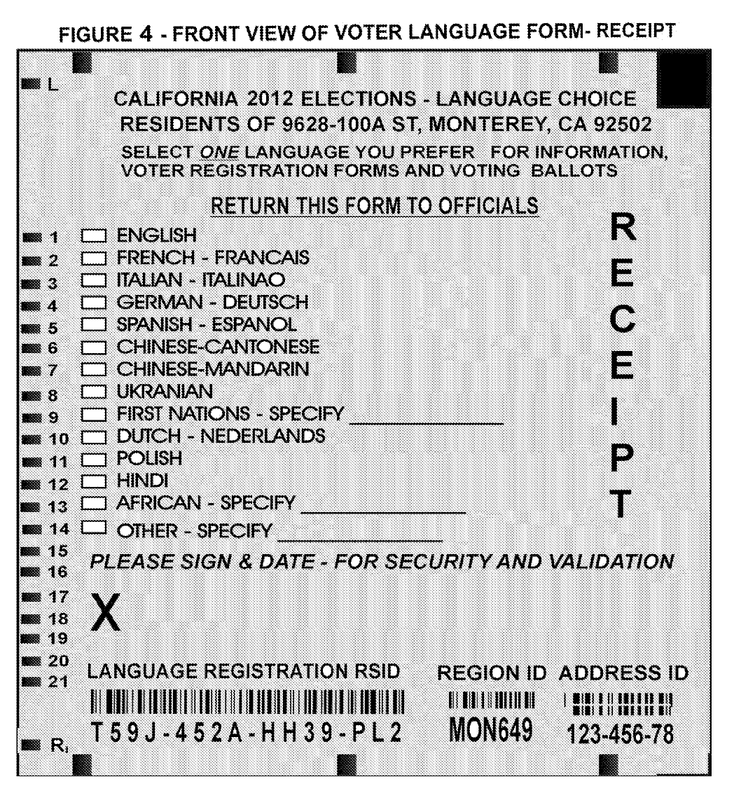

FIG. 6: a site plan view for the FRONT side of a FIRST embodiment of a RECEIPT Ballot part of a WHOLE Ballot that is correlated to FIG. 5 of this invention.

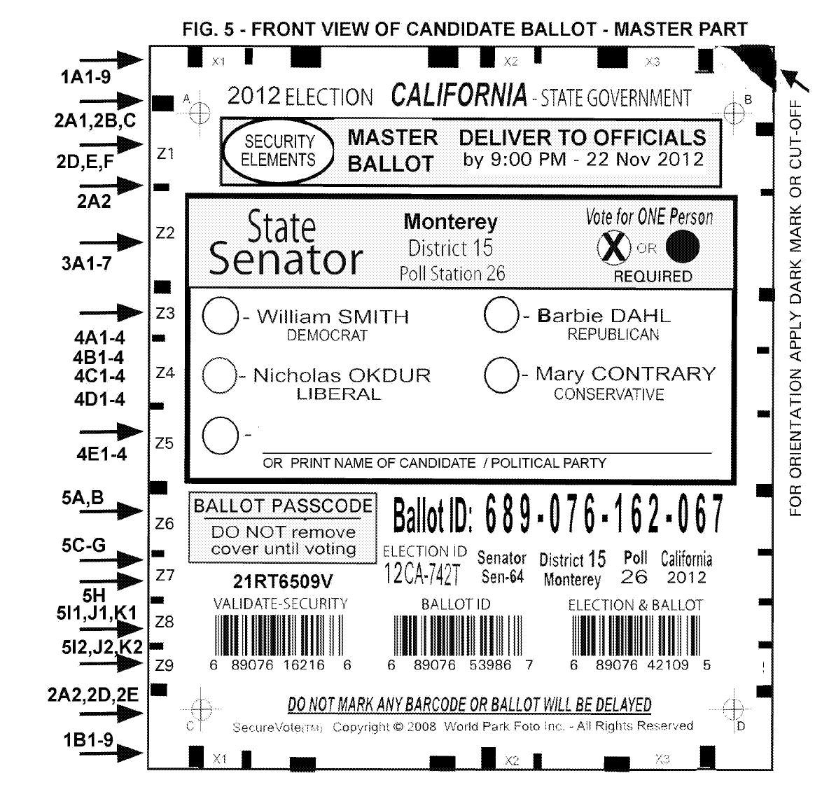

FIG. 7: a site plan view for the FRONT side of a SECOND embodiment of a MASTER BALLOT part of a WHOLE Ballot of this invention;

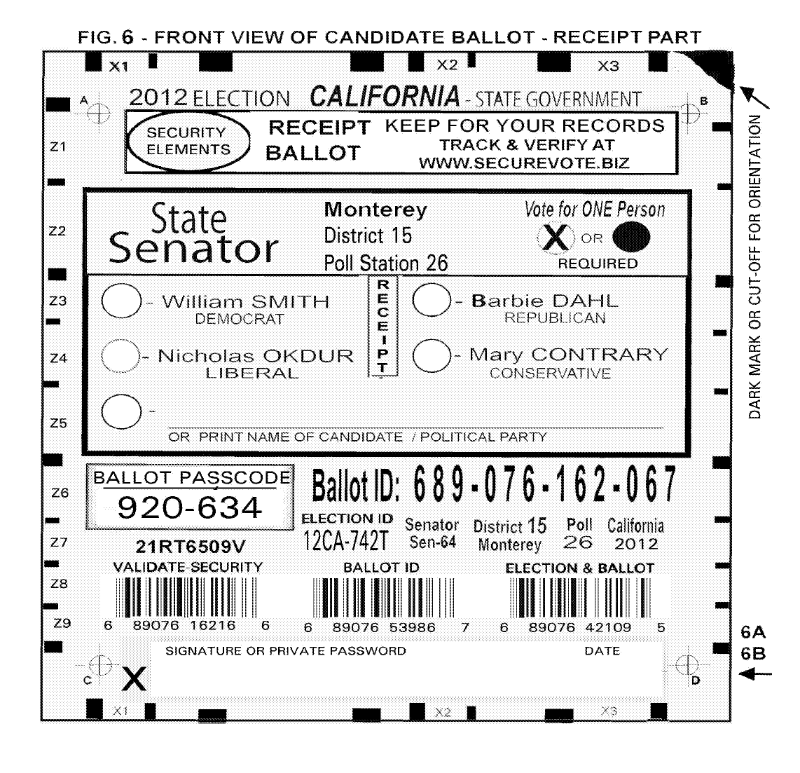

FIG. 8: a site plan view for the FRONT side of a SECOND embodiment of a RECEIPT BALLOT part of a WHOLE Ballot correlated to FIG. 7 of this invention.

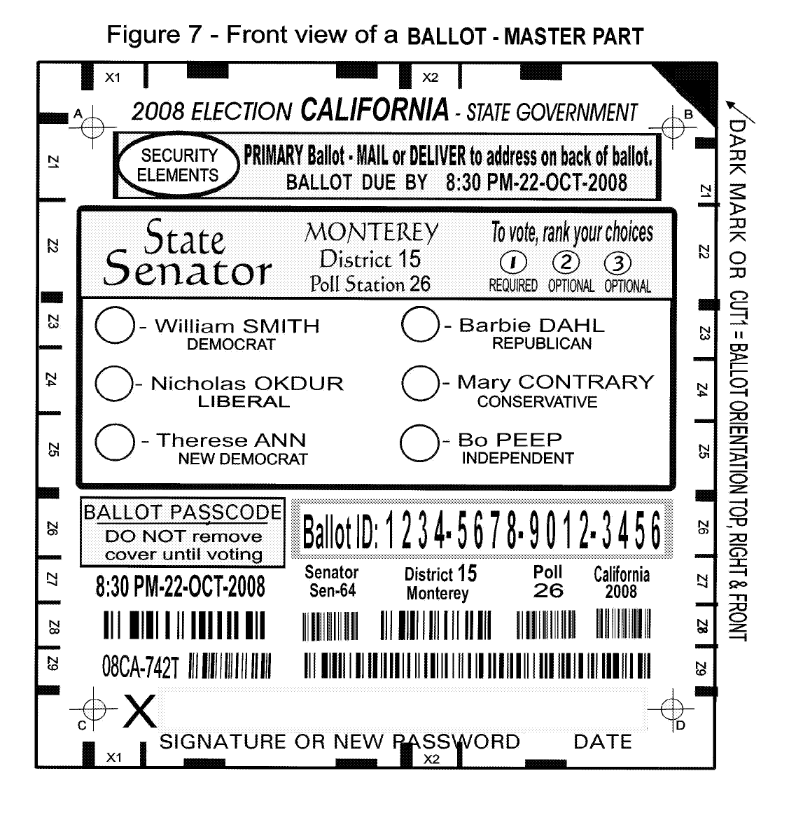

FIG. 9: a site plan view for the FRONT side of a THIRD embodiment of a MASTER BALLOT part of a WHOLE Ballot of the invention;

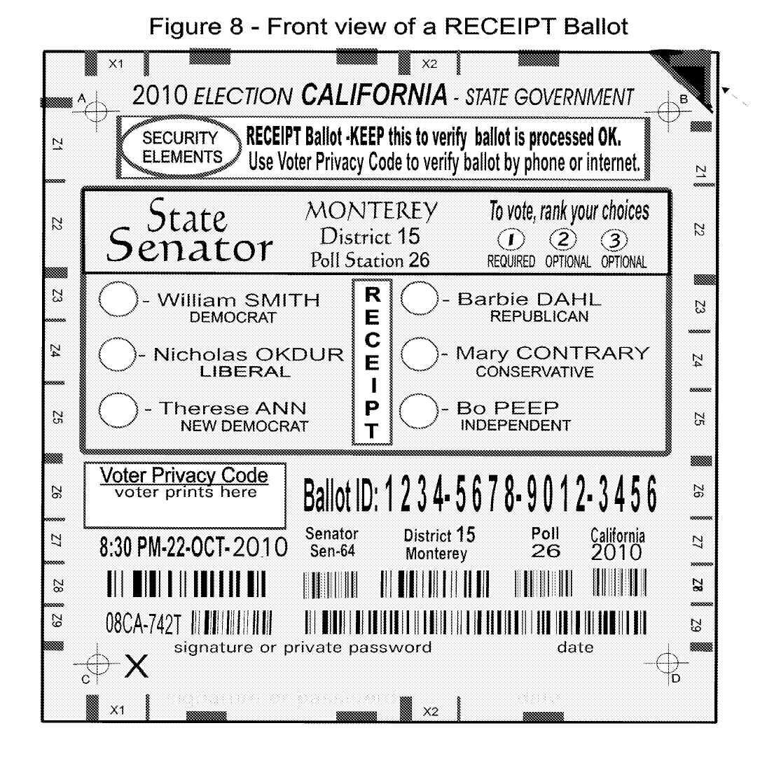

FIG. 10: a site plan view for the FRONT side of a THIRD embodiment of a RECEIPT part of a WHOLE Ballot correlated to FIG. 9 of the invention;

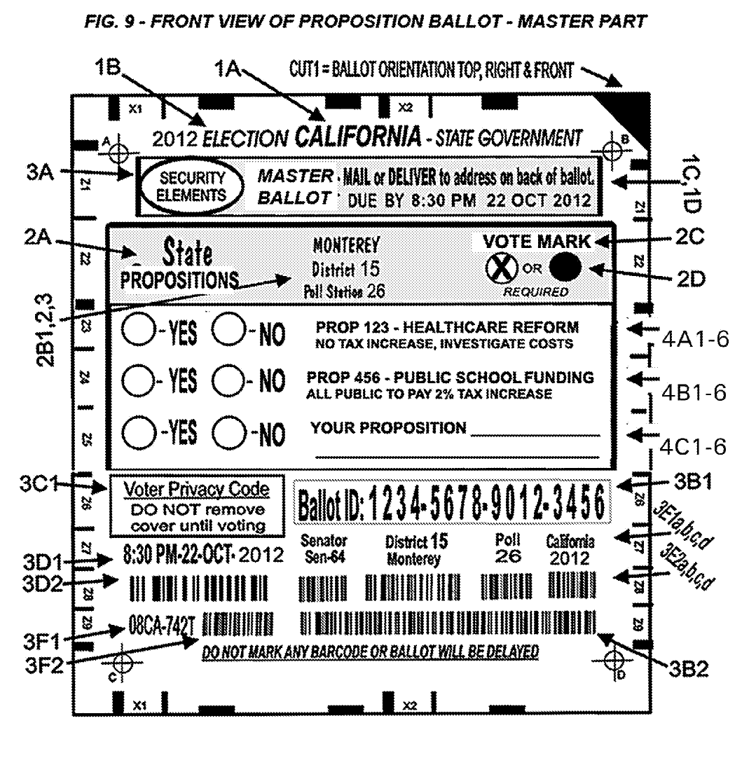

FIG. 11: a site plan view for the FRONT side of a FIRST embodiment of the Voter Ballot Information Sheet document of the invention;

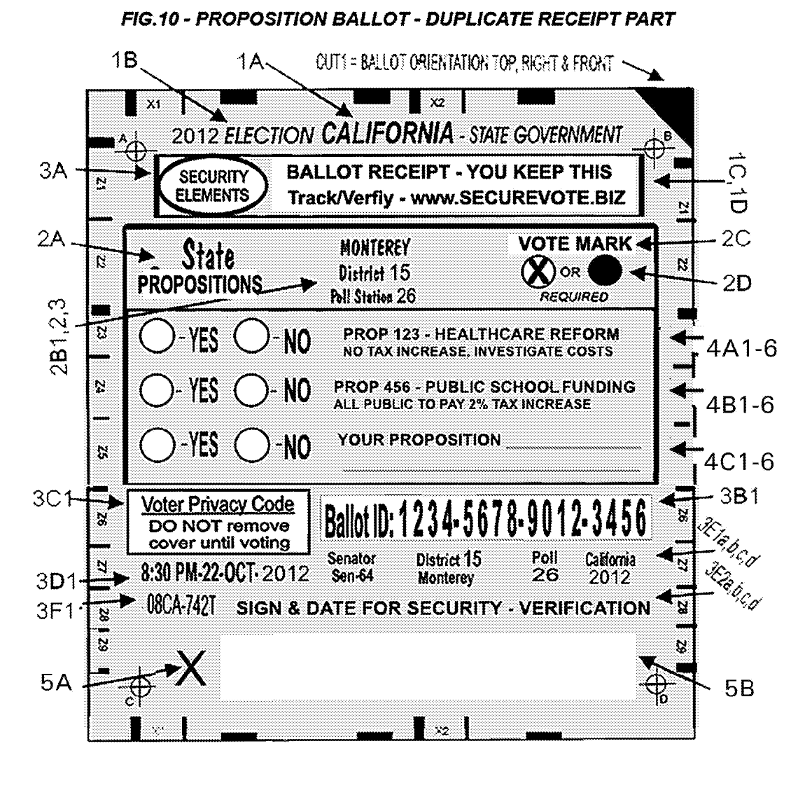

FIG. 12: a site plan of the FRONT side of a FIRST embodiment of Container Markings;

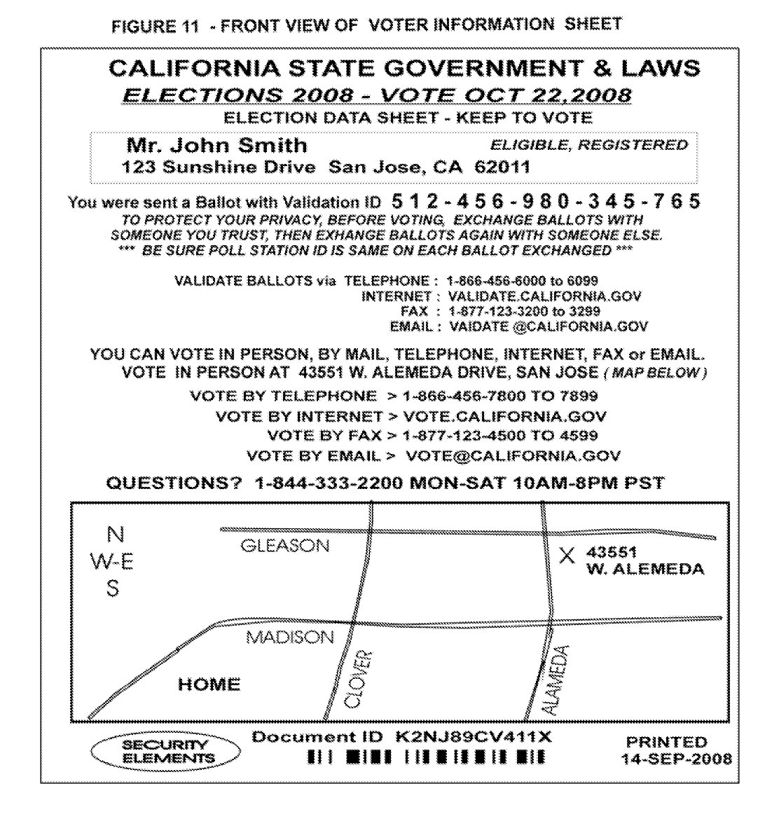

FIG. 13: a FIRST embodiment of Venn Diagram of Ballot Relationships;

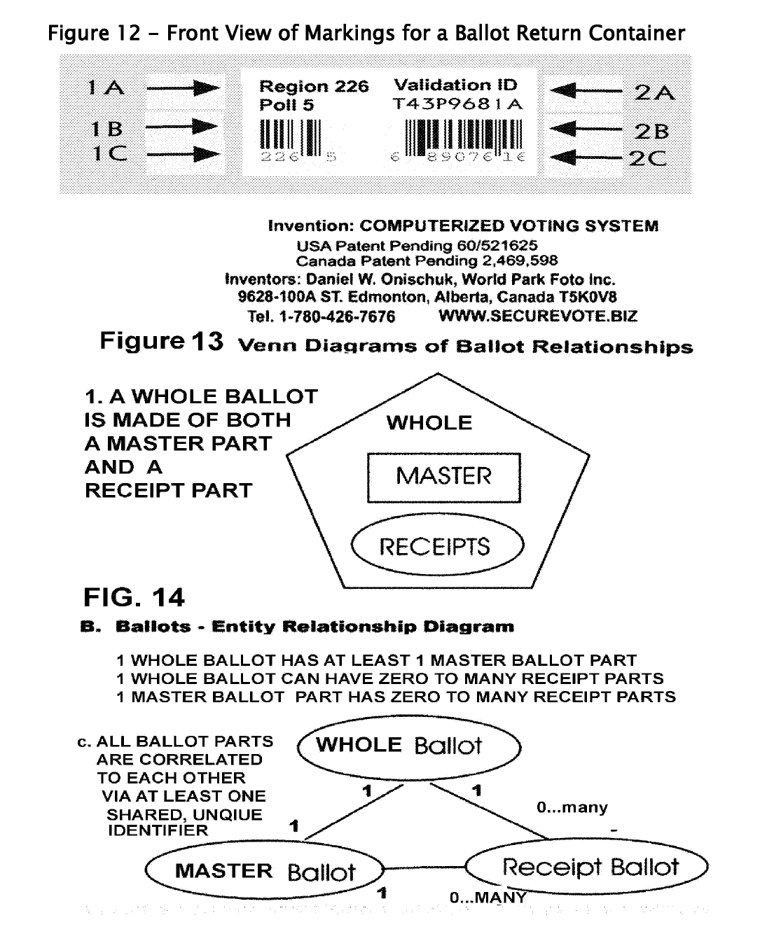

FIG. 14: a FIRST embodiment of a BALLOTS—ENTITY RELATIONSHIP DIAGRAM

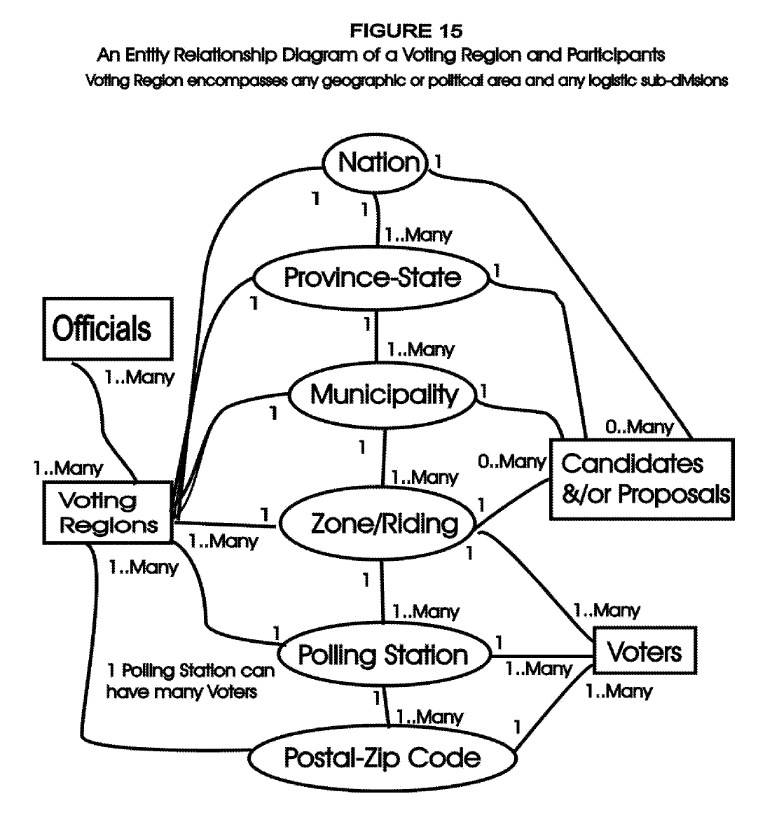

FIG. 15: a site plan view of a FIRST embodiment of an Entity Relation Diagram of Voting Regions and Participants of the invention;

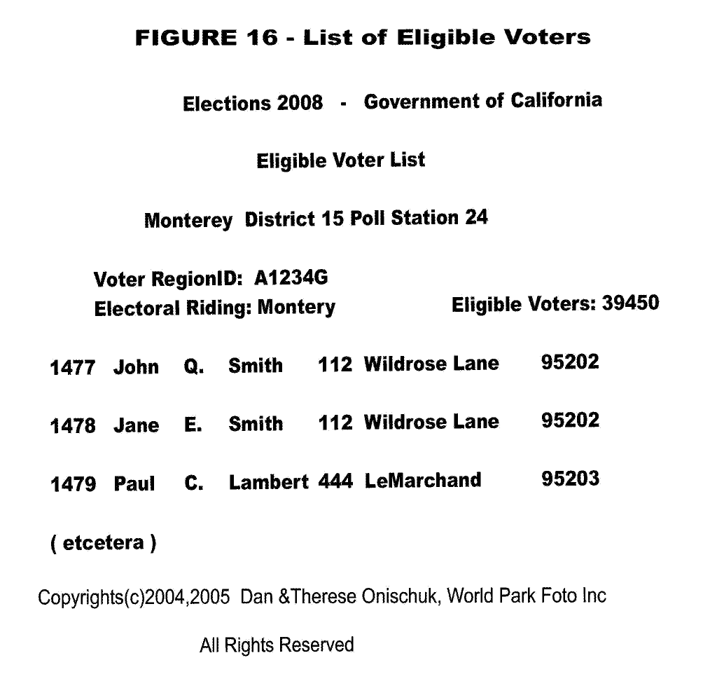

FIG. 16: a site plan view of a FIRST embodiment of a List of Eligible Voters;

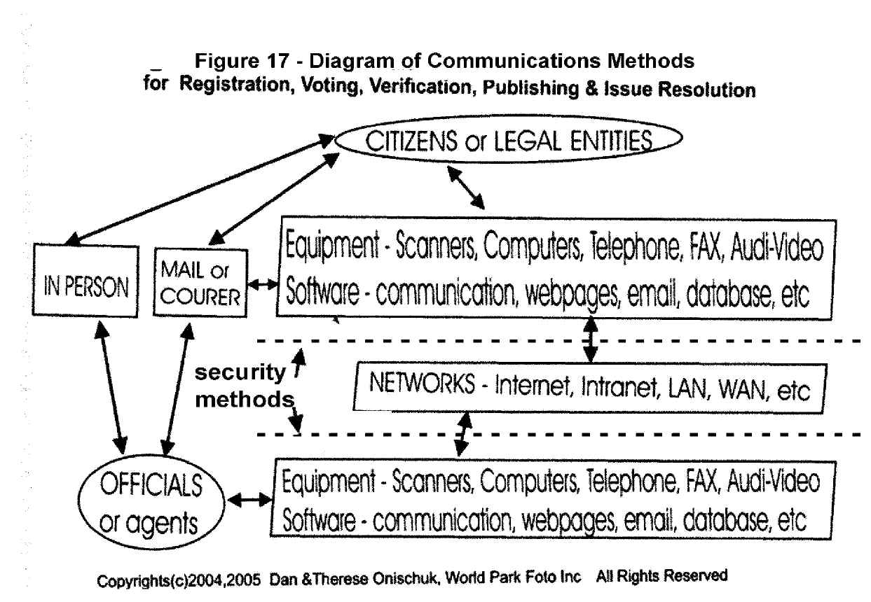

FIG. 17: a site plan view of a FIRST embodiment of a Diagram of Communication Methods for Registration, Voting, Verification, Publishing. Issue Resolution

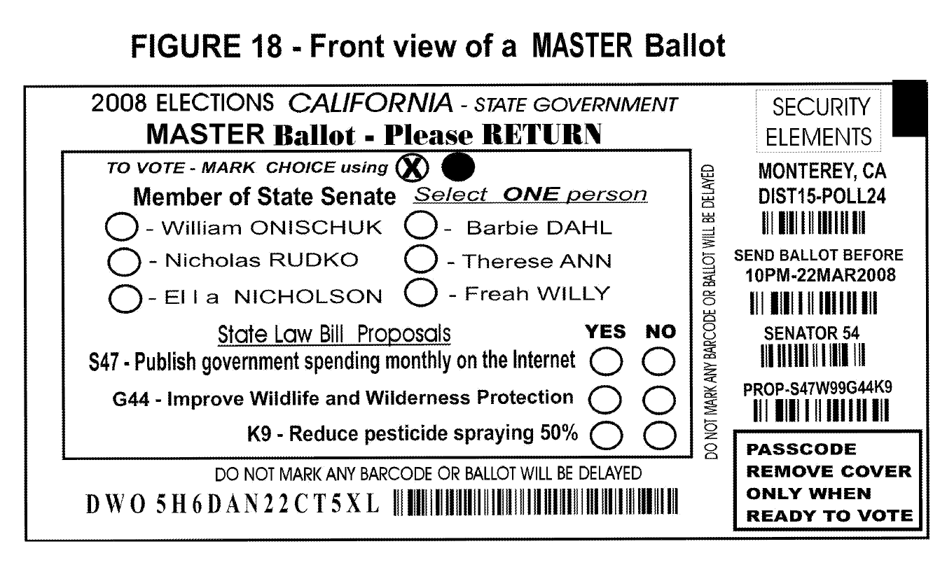

FIG. 18: a site plan view for the FRONT side of a FOURTH embodiment of a MASTER Ballot part;

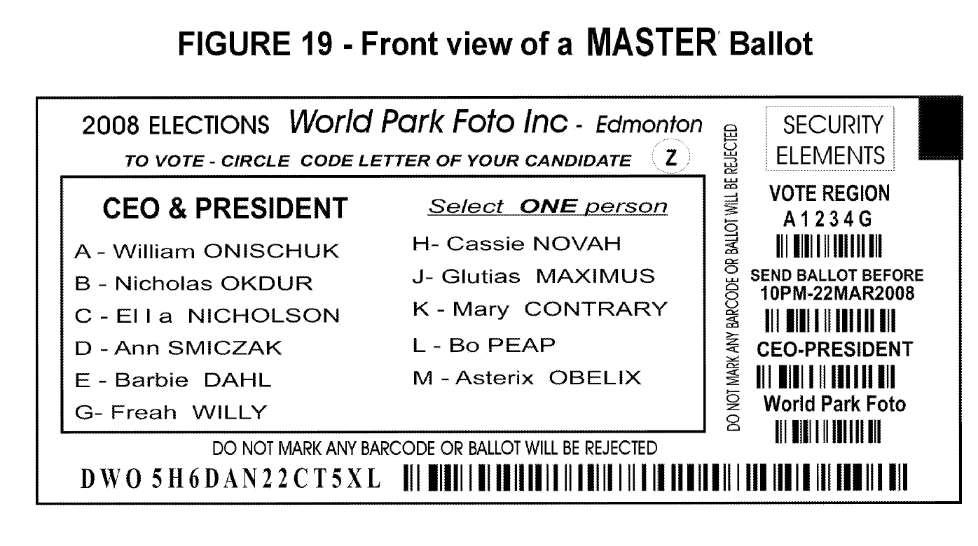

FIG. 19: a site plan view for the FRONT side of a FIFTH embodiment of a MASTER BALLOT part;

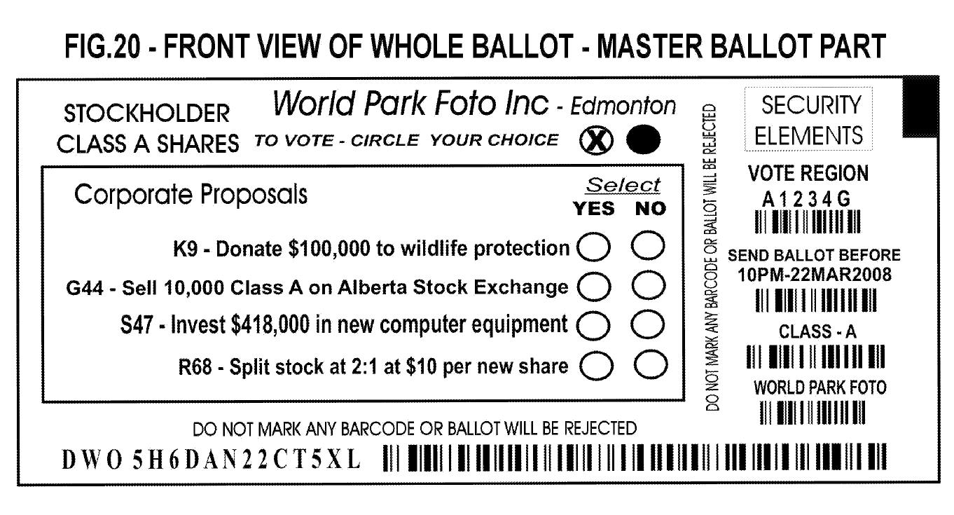

FIG. 20: a site plan view for the FRONT side of a FIFTH embodiment of a MASTER Ballot part of a WHOLE Ballot (which is comprised of a MASTER & RECEIPT parts);

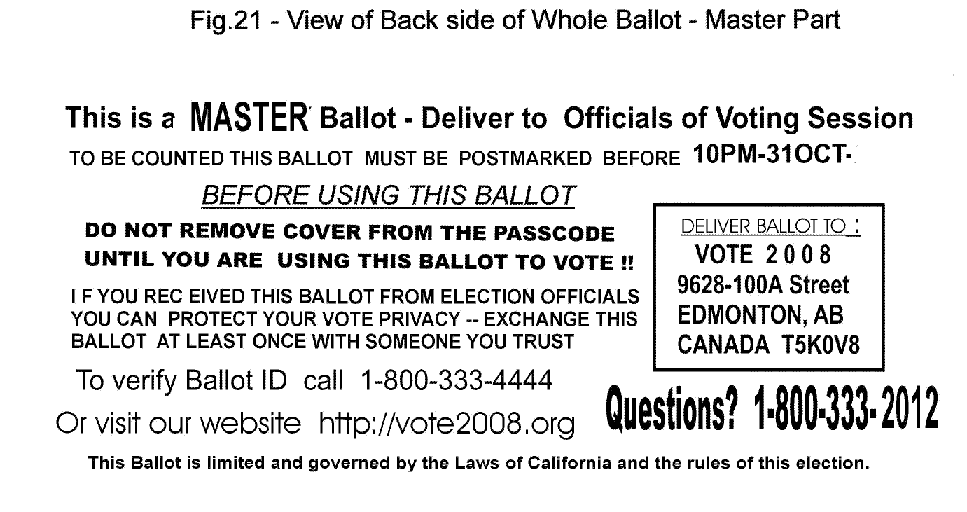

FIG. 21: a site plan view for a FIRST embodiment of the BACK side of a MASTER Ballot, OPTIONALLY correlated to FIGS. 5,7,9,18,20,23 of this invention; and with further modification, FIG. 21 may be correlated to FIG. 1 for Voter Registration Form—MASTER part, or correlated to FIG. 3 Voter Language Form—MASTER part;

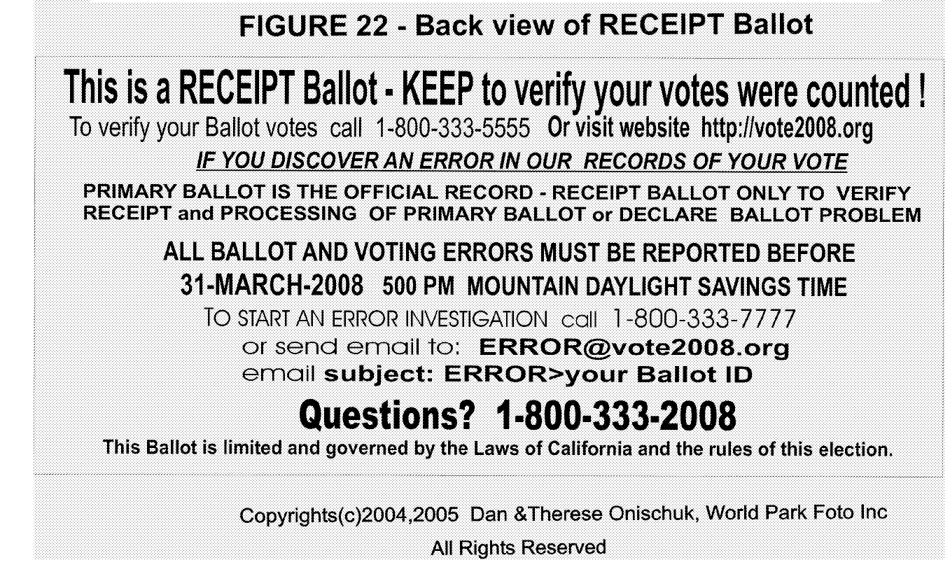

FIG. 22: a site plan view for a FIRST embodiment of the BACK side of a RECEIPT Ballot, correlated to FIGS. 6,8,10 of this invention; and with further modifications, may be correlated to FIG. 2 for Voter Registration—RECEIPT part, and/or, for any embodiment of the Voter Language Form—RECEIPT part of this invention;

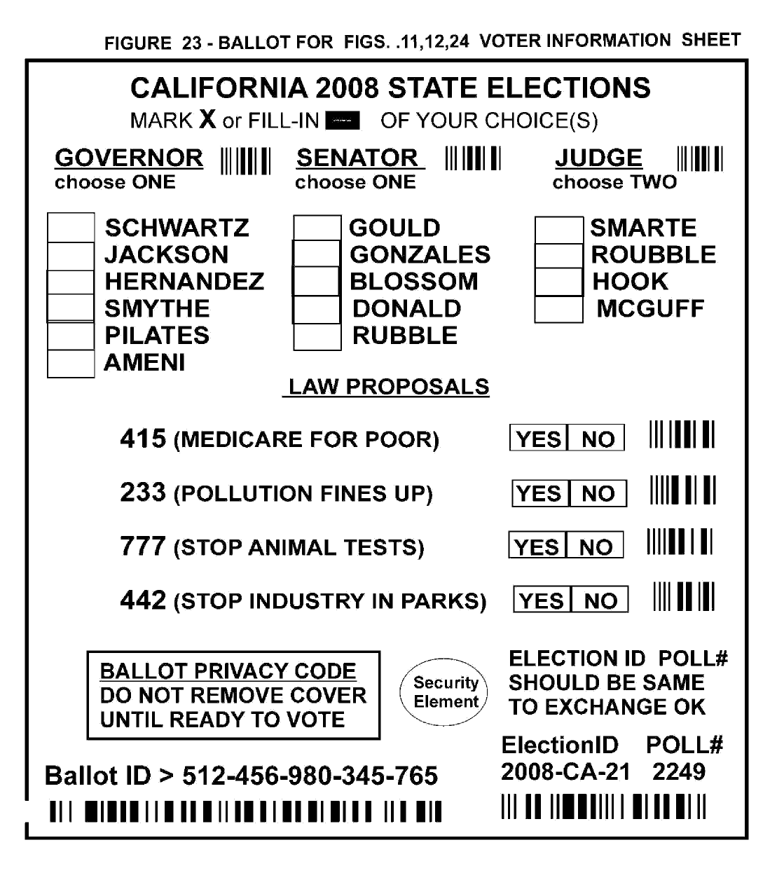

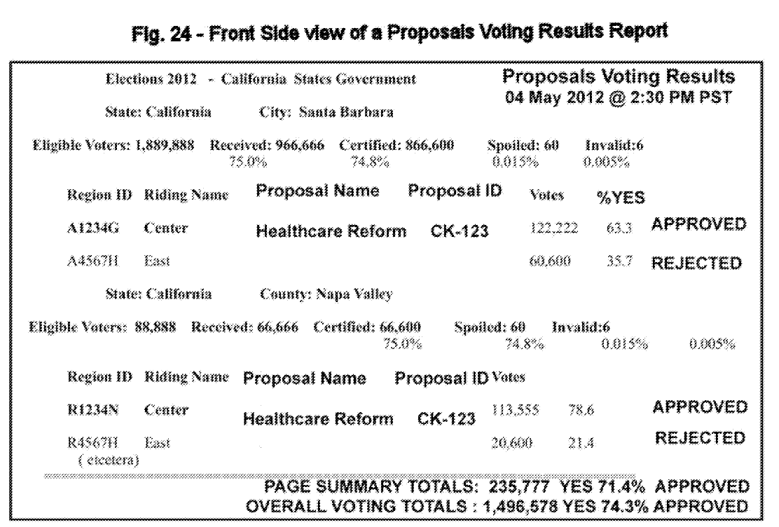

FIG. 23: a site plan view for the FRONT side of an SIXTH embodiment of a MASTER Ballot of the invention, that may be correlated to FIG. 21 of this invention which could then be the BACK side for this FIG. 23, or, alternatively, FIG. 21 or 24;

FIG. 24: a site plan view for the FRONT side of a first embodiment of a a Proposals Voting Results Report of the invention;

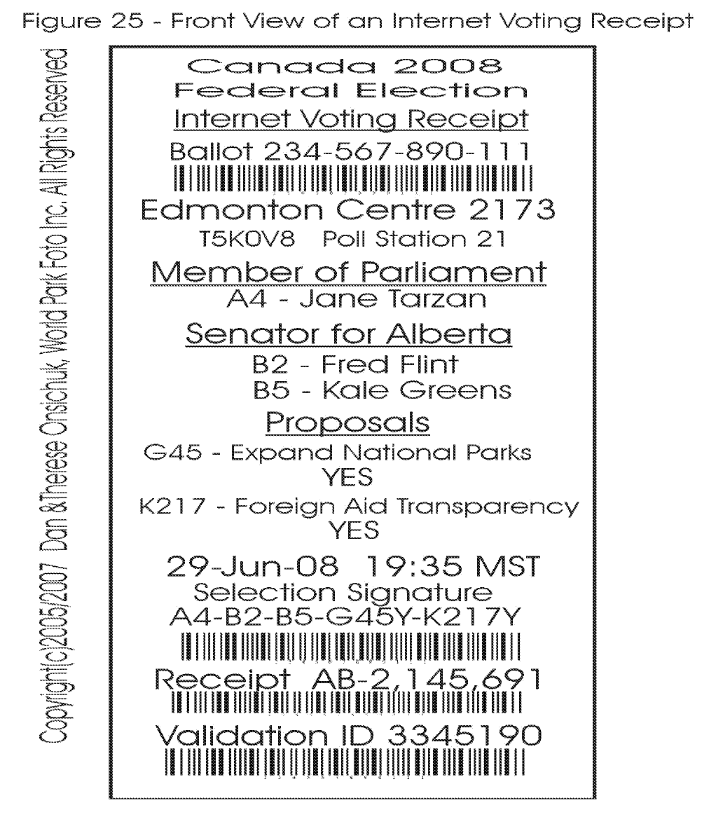

FIG. 25: a site plan view for the FRONT side of a first embodiment of an Internet Voting RECEIPT of this invention, correlated to FIGS. 5,6,8,9,10,13,18,19,20,23 and with further modifications, may be correlated to FIG. 3,4,12,21,22,24;

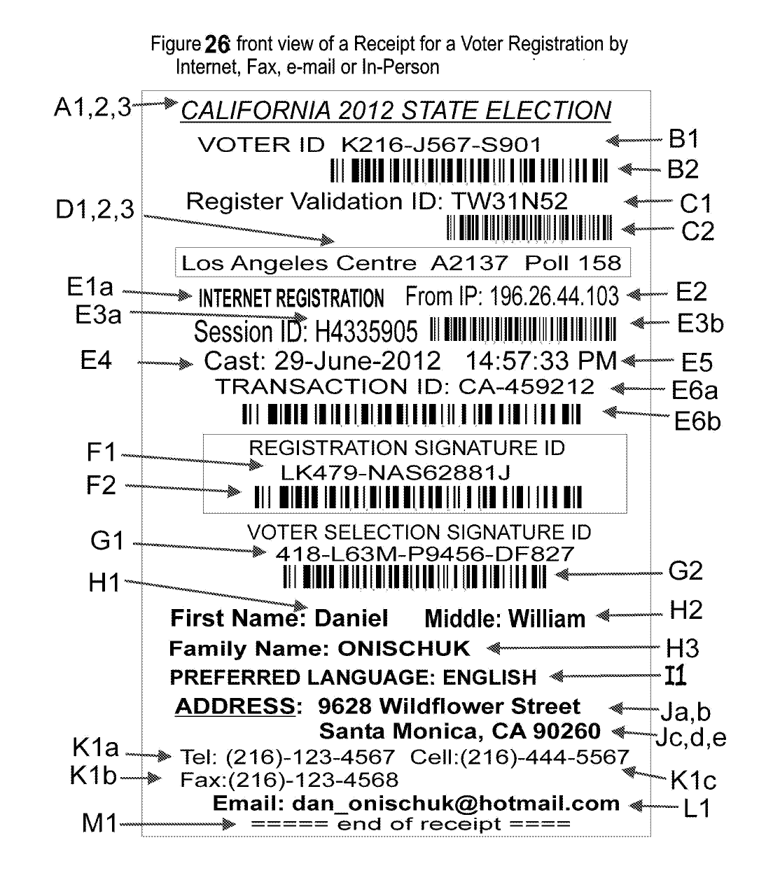

FIG. 26: a site plan view for the FRONT side of a first embodiment of a RECEIPT for Voter Registration by Internet, Fax, email, or In-Person of the invention.

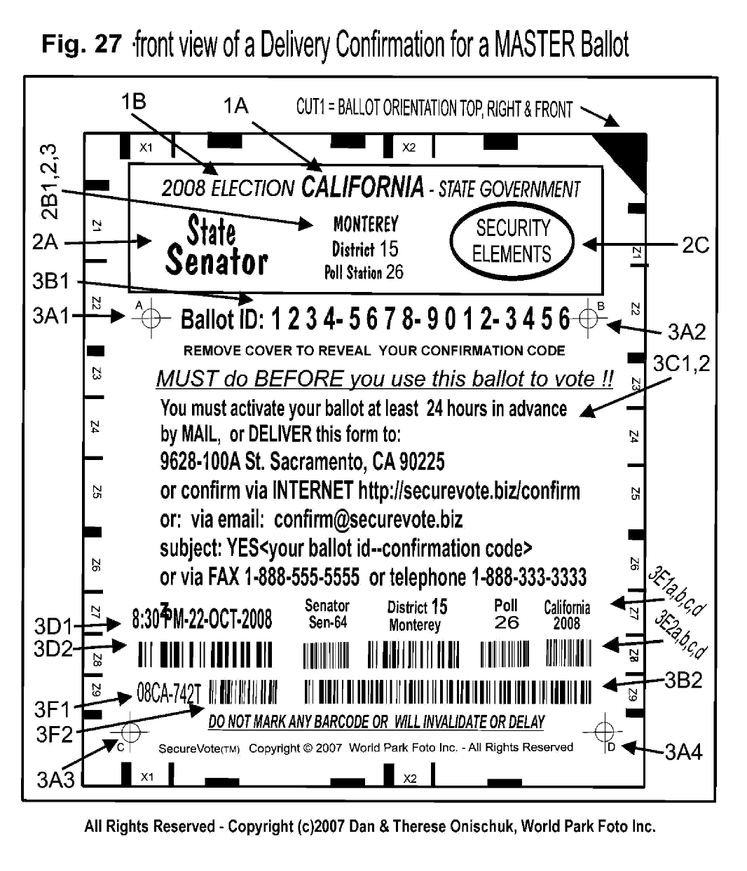

FIG. 27: a site plan view for the FRONT side of a first embodiment of a Delivery Confirmation for a MASTER Ballot of this invention;

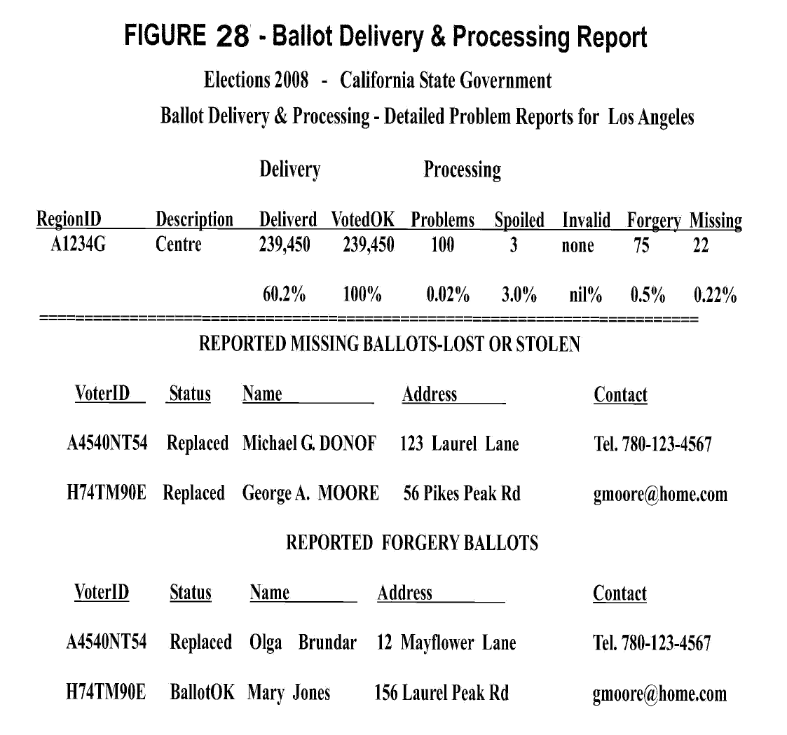

FIG. 28: a site plan view for the FRONT side of a first embodiment of a Ballot Delivery and Processing Report of the invention;

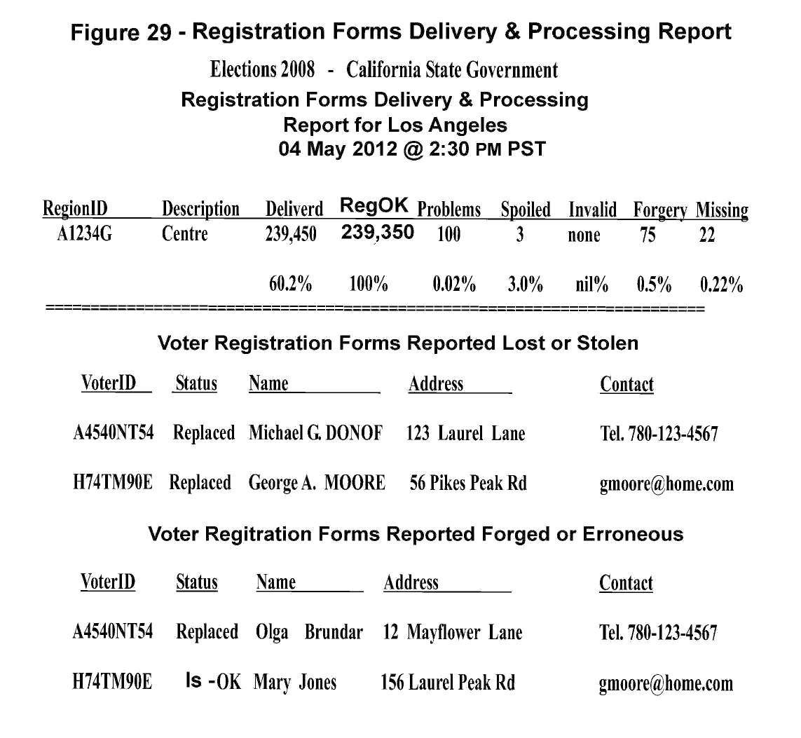

FIG. 29: a site plan view for the FRONT side of a first embodiment of a Voter Registration Forms Delivery and Processing Report;

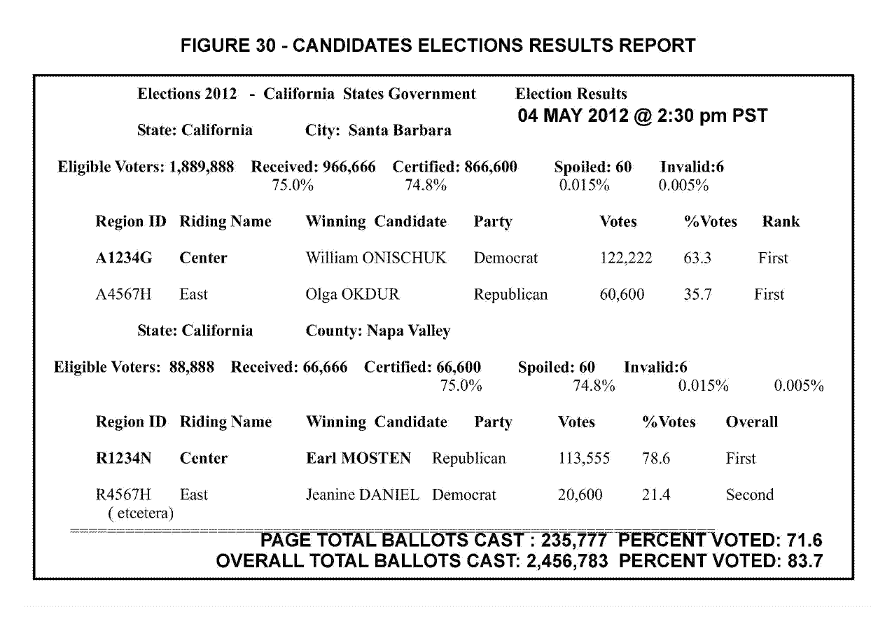

FIG. 30: a site plan view for the FRONT side of a first embodiment of a a Candidates Election Results Report of the invention;

### DISCLOSURE OF INVENTION

The methods and steps involved in the assembly of a List of Eligible Voters is unique and the first of many improvements to existing patents in this scope of invention.

### A) Definitions of Terms

1) Official, or, Officials—refers to any number and any combination of:

2) persons, devices, computer systems or communication networks appointed by the Hosts of the Voting Session to participate in at least one role or function to facilitate the Voting Session;

3) Voter, or, Voters, Eligible Voter, or, Eligible Voters—refers to any number of, persons, or, business entities, or any group of people or business entities, that are, or may be, entitled to participate in the Voting Session for the purpose of select any number of candidates and/or proposals, thereafter delivering their ballots to Officials for authentication and tallying;

4) Voting Session—refers to a process or series of steps and methods for at least one purpose: (i) to select candidate(s), or, (ii) to select to affirm or deny proposal(s), or (iii) any combination of selecting any number of candidates and to affirm or deny any number of proposals;

5) Voting Region is used to describe the Scope of a Voting Session—refer to Entity-Relation Diagrams of FIG. 15. Voting Region may also refer to a variable group of attributes—Province/State, Municipality, Zone, Poll Station, Postal or Zip Code.

6) The attributes are used for data storage, and may also be components of the Voting REGION, depending on the Scope of the Voting Session. Any number of Voting Region attributes may be visible on Ballots, Reports, Calculations, Tallies, Summaries, etcetera as set by Officials to meet Voting Session goals.

### B) Disclosure of Invention—Details

B) i) an initial assessment is made to define the required tasks and estimate the labor time required to complete the required tasks to complete the Official Voting Session in the time allotted, and to justify the acquisition of materials, devices and people to enable completion of the Voting Session in a timely manner;

B) ii) people, computers, devices, software programs, and communication systems are acquired and developed to complete the tasks of the Official Voting Session;

B) iii) a determination is made for the number of Potential Voters that could participate in the Voting Session, using data from reliable sources (such as census population data, immigration data, social security numbers or tax data for governments, stockholders or employee data for businesses, membership data for groups or professional associations;

B) iv) Officials enquire about remote sources of information that could be used to identify Potential Voters or Eligible Voters, then contact owners of each selected remote data source to obtain agreements, access permissions and methods. A unique source identifier (SID) is assigned to each remote source permission is obtained by, from, or for.

B) v) for a remote source of records to be accepted, it undergoes a preliminary inspection to assess whether it will meet standards for acceptable regarding the relative age of the data, reliability, consistency of data among records, or other quality control methods;

B) vi) remote sources of data that DO NOT pass preliminary inspection requirements are ignored or designated for further investigation at some later time and date; For remote sources of data which DO meet First Inspection requirements:

B) vii) to determine which people or businesses are eligible to vote, Official people, or, Official computers running software programs designed to determine who are Eligible Voters, access computer databases such as those affiliated with sources such as census population data, immigration data, social security and tax data for governments; stockholders or employee data for corporations or businesses; memberships data for groups or organizations, and other information sources (e.g. paper records, microfilm) which contain relevant data about Voters;

B) viii) to accurately determine and make verifiable records of people and/or business entities that are eligible to vote, remote data source(s) records containing data about people and/or business entities are retrieved by Officials using computers running research programs;

B) ix) remote source records that contain sufficient data to identify and fulfill the requirements for an Eligible Voter record, are duplicated; and the duplicate copy is verified, then transferred to the record storage facilities and computer data storage systems of the Officials of the Voting Session; furthermore, each of the records transferred is assigned a unique Potential Voter Identifier (PVID), and is marked with a remote datas source identifier (RDSID) so as to describe the information as being from a remote source, as well as date and time of transfer, identities of Officials authorized the transfer and data acceptance.

B) x) remote source records that are missing data are then marked as ;Research; Voter for further investigation, and each Research Voter record is assigned a unique identifier (RVID); each Research Voter record is unique in every List of Eligible Voters, and is further unique among all pluralities of Lists of Eligible Voters;

B) xi) Officials assigned to investigate, update, report on each Research Voter record;

B) xii) when each Research Voter record is updated, it is also checked to determine whether it contains sufficient information to satisfy the requirements of data acceptance standards of an Eligible Voter; if so, then it is copied, the original Research Voter record status is marked RESEARCH-ELIGIBLE, the copy record is marked as Eligible Voter, then the copy record is added to the group of Eligible Voter records; and assigned a unique Eligible Voter Identifier (EVID), while also retaining the RVID identifier to enable auditing;

B) xiii) Official people or Official computers running software programs, determine which Research Voter records and which Potential Voter records meet the criteria of the Voting Session to be assigned the designation of Eligible Voter; furthermore, each voter meeting the criteria is designated an Eligible Voter record, and assigned a unique Eligible Voter ID;

B) xiv) Official people or Official computers running software programs, assemble and organize at least one List of Eligible Voters based on Voting Session criteria, at least comprised of, but not limited to: the first name and family name of the voter, their last known physical address for mail delivery, electronic address or any other method for delivery (such as a private fax machine number, or, forwarding contact address), home phone number, business phone number, a portion for the voter signature or initials, a portion for the signature date, and any number of portions for voter proxy information, any number of portions for officials information; furthermore said voter registration can be modified for use as a proxy voter registration form using the same or similar data fields; furthermore, each List of Eligible Voters is assigned an Eligible Voter List Identifier (LEVID); for example, each List of Eligible Voters may be organized by any number of applicable sub-groups of political areas, geographic areas, electoral boundaries or voting castes of people (such as but not limited to: citizens of a country, group membership, stockholders voting shares) for a Voting Session;

B) xv) identical, duplicated records of Eligible Voters found in any one, or existing within several, Lists of Eligible Voters, are removed so that only one instance of a unique Voter remains, so as to prevent multiple ballots delivery to a single voter;

B) xvi) if the rules of the Voting Session, or, any group of people or business entities, or members of a business allow multiple listing of a unique Eligible Voter, then that instance is also an instance or part of this invention; and preceding step B) xv) will be done in another manner so as to accommodate the integrity of the Voting Session, for any group of people or business entities, or any members of a group or business.

B) xvii) Officials publish any number of List(s) of Eligible Voters—using media such as, but not limited to Internet website pages;

B) xviii) Officials advertise the location and methods of accessing each List of Eligible Voters; this step may include sending confirmation notices to each Eligible Voter on each List of Eligible Voters, or, alternatively, placing the responsibility upon eligible voters to remain informed and take any required “self-service” steps to register for voting;

B) xix) Officials provide means and opportunities to all Potential Voters and Eligible Voters to verify or amend each List of Eligible Voters;

B) xx) Officials provide means and opportunities to any subset of any, or, all Potential Voters, Research Voters, and Eligible Voters to contact Officials to amend the List of Eligible Voters—by telephone, Internet, postal Mail, delivery courier, electronic mail, facsimile (fax) transmission, personal data device, interactive television, any other remote communication methods, or in person.

B) xxi) Officials investigate each Potential Voter, Research Voter and Eligible Voter request for amendment and report the findings to Officials and the voter;

B) xxii) Officials amend any number of Lists of Eligible Voters;

B) xxiii) Officials and Voters verifies the amendments are completed accurately;

C) i) Official people or Official computers run software programs to design, and produce any form of specially designed WHOLE Ballots; using the official language of the Voting Session; or language selected by the Eligible Voter;

C) ii) Official people or Official computers run software programs to print or generate any form of representation, of specially designed WHOLE Ballots; using the official language of the Voting Session; or, language selected by the Eligible Voter;

C) iii) the number of WHOLE Ballots printed or generated is determined by the number of Eligible Voters plus an estimated number to accommodate Lost, Stolen, Damaged, or Spoiled Ballots, and an estimated number of additions to every List of Eligible Voters used for each Voting Session;

C) iv) each WHOLE Ballot is tested to be both VALID and AUTHENTIC;

C) v) for each WHOLE Ballot is passing tests to be AUTHENTIC and VALID according to step C) vi) the further step of designating the WHOLE Ballot, and its constituent parts, to having a Verification Status identifier designated as CERTIFIED;

C) vii) Delivery Status identifier of WHOLE Ballots of step 3.e. designated as READY;

C) viii) Activity Status identifier of WHOLE Ballots of step 3.f. is set to be DORMANT;

C) ix) the number of WHOLE Ballots printed or generated is very carefully controlled, monitored and regulated by Officials of the Voting Session;

C) x) Official people or Official computers run software programs to arrange delivery of any number of WHOLE Ballots to each Eligible Voter on every Eligible Voter List;

C) xi) as each WHOLE Ballot is processed through the final steps for delivery, the value of the Delivery Status identifier changes from READY to DELIVERED;

C) xii) as each WHOLE Ballot is processed through the final steps for delivery, the value of the Activity Status identifier changes from DORMANT to ACTIVE;

D) i) Officials prepare and publish any number of Voter Data Sheets which describes any combination of candidates, proposals, voting session rules, voting instructions, polling station maps, etc. This may also be repeated on the Officials website.

D) ii) Eligible Voters receive at least one WHOLE Ballot from Officials or appointees;

D) iii) Eligible Voters receive any number of optional, Voter Data Sheets;

D) iv) Eligible Voters receive any number of MASTER Ballot return envelopes;

E) i) Any Eligible Voter or Official may obtain a replacement WHOLE ballot in exchange for a DAMAGED or SPOILED ballot that has an Activity Status of ACTIVE;

E) ii) any number of Voters (Applicants) or Officials (Applicants) deliver any number of, and any number of types of WHOLE, MASTER, RECEIPT Registrations, and/or Ballots submitted IN-PERSON, by POSTAL MAIL, DELIVERY COURIER, ELECTRONIC MAIL, TELEPHONE, INTERNET, FACSIMILE, INTERACTIVE TELEVISION, PERSONAL DATA DEVICE to any number of Officials;

E) iii) Voters or Officials use the pre-marked or otherwise properly mark, affix sticker labels, associate electronic data, include Voter Information documents, and optionally place their personal signature or private password INSIDE or OUTSIDE of each VOTER REGISTRATION RETURN CONTAINERS and/or upon each Voter Registration Form;

E) iv)a) Voters then mail or otherwise deliver to any number of Voter Registrations;

E) iv)b)i) Officials receive any number of Registrations and/or Ballots from Applicants;

E) iv)b)ii) Officials and/or subordinate electronic devices running computer programs use information of the RETURN CONTAINERS to sort, verify, process each Voter Registration;

E) iv)c) Officials record at least the names and address of each Applicant requesting Ballot Replacement; as well as the date and time of filing the request for replacement; as well as additional identification such as social security number, drivers license number, passport identifier, may also be recorded;

E) iv) d) if the Applicant claims to be an Eligible Voter, Officials search each current List of Eligible Voters for that Voting Session until a determination can be made;

E) iv) e) if the Applicant claims to be an Official of the current Voting Session, other Officials search each List of Officials of the Voting Session for a verification;

E) iv) f) Each Qualified Applicant becomes a Registered Voter status, and is then given or sent at least one specially marked and unique WHOLE Ballot with which to vote with;

E) iv) g) Each Registered Voter then marks the Master Ballot part of their WHOLE ballot, and manually or automatically, generates a duplicate copy on the RECEIPT part of the WHOLE ballot.

E) iv) h) Each Voter then uses the MASTER BALLOT RETURN CONTAINER (which is pre-marked or alternatively the Voter properly marks and/or affixes sticker label(s) to the external surface, or otherwise associates electronic data to their personal BALLOT RETURN CONTAINER, and may also optionally include a duplicate or RECEIPT of their MASTER Voter Registration, and the further step for each Master Ballot part of optionally placing their signature or private password and date on the INSIDE (or the OUTSIDE) of any number of MASTER BALLOT RETURN CONTAINER(S) that are then sent to Officials for authentication, tallying and reporting.

E) iv)b)ii) Officials and/or subordinate electronic devices running computer programs use information of the MASTER BALLOT RETURN CONTAINERS to sort, verify, process any verification of any included Voter eligibility information (Voter Registration copy-receipt, Voter signature, etc.) prior to SEPARATE processing for each MASTER BALLOT part.

E) v) a) Officials accept or reject each received MASTER ballot based on the findings of tests applied to confirm the authenticity and validity of each ballot; for example, by verifying Security Element of the Ballot; verifying the Random Symbolic Identifier is Officially valid; verifying LIMITS OF USE (Preamble-data acquisition, transmission, etc.);

E) v) b) Officials may further accept or reject each received ballot based on the Activity Status attribute of the ballot, whereby the Officials accept VALID, ACTIVE ballots;

E) v) c) i) Providing the Applicant, Affidavit, and Ballot submitted are all valid, the ballot receiving Officials cancels the correlated ballots (for example by referring to the Ballot Random Symbolic Identifier), and records the relevant details of each ballot cancellation;

E) v) c) ii) Officials amend all Voting Session records for ballot Activity Status attribute as being designated CANCELLED for all MASTER ballots with identical RSID's;

E) v) c) iii) Officials verify the SPOILED or DAMAGED Ballot Activity Status attribute is designated as CANCELLED, on all Voting Session records.

E) v) c) iv) Officials select one WHOLE Ballot, designated as a REPLACEMENT Ballot, for each Ballot that was CANCELLED; whereby each REPLACEMENT Ballot is identical to the CANCELLED ballot, except for at least one Random Symbolic Identifier of the REPLACEMENT Ballot being distinctly different from every Random Symbolic Identifier of the CANCELLED Ballot; each REPLACEMENT Ballot is tested to be both VALID and AUTHENTIC; each REPLACEMENT Ballot passing tests of preceding steps has a Verification Status designated as ACTIVE;

E) v) c) v) at least one Official delivering, or arranging the delivery of, a correlated number of REPLACEMENT Ballots to each Applicant; whereupon the Ballot is now designated as a WHOLE ballot, and Delivery Status attribute of each delivered REPLACEMENT Ballot becomes DELIVERED;

E) v) c) vi) any number of Officials record the quantity and type of REPLACEMENT—WHOLE Ballots delivered to every Applicant;

E) v) c) vii) any number of Applicants receive any number of uniquely different REPLACEMENT—WHOLE ballots of the same type submitted for replacement;

E) v) c) viii) Any Eligible Voter or Official may obtain a replacement WHOLE ballot in exchange for any LOST or STOLEN ballot having an Activity Status of ACTIVE;

E) vi) a) any number of Voters (Applicants) or Officials (Applicants) deliver any number of WHOLE, MASTER, RECEIPT, PHONE, INTERNET Ballots to any number of Officials;

E) vi) b) Officials receive any number of Ballots of the preceding steps;

E) vi) c) Officials record at least the names and address of each Applicant requesting Ballot Replacement; recording the date and time of filing the Affidavit along with additional identification such as social security number, drivers license number;

E) vi) d) any number of Officials provides any number of Applicants with at least one Affidavit form for the purpose of declaring a Ballot to be either LOST, or, STOLEN;

E) vi) e) each Applicant completes the Affidavit of previous step E)Vi)d) whereby:

E) vi) f) each Applicant provides their full legal name with the Affidavit;

E) vi) g) each Applicant provides their address, when applicable, with their Affidavit;

E) vi) h) each Applicant provides at least one form of Voter identification to verify their identity according to the Affidavit;

E) vi) i) each Applicant signs the Affidavit, physically, electronically, or by any other acceptable means according to the Rules of the Voting Session;

E) vi) j) each Applicant delivers, or arranges delivery of their Affidavit to Officials;

E) vi) k) Officials receives any number of Affidavits and identification;

E) vi) l) if the Applicant claims to be an Eligible Voter, Officials determine if the claim is valid by searching every List of Eligible Voters for that Voting Session;

E) vi) m) if the Applicant claims to be an Official of the current Voting Session, other Officials determine whether the Applicant is valid by searching every List of Officials for that Voting Session until a determination can be made;

E) vi) n) Officials may further accept or reject each received ballot based on the Activity Status attribute of the ballot, accepting to tally only ACTIVE ballots;

E) vi) o) any number of Officials, computers, optical or electronic devices, or humans accepts or rejects all other information provided for each Applicant, Affidavit or Ballot; (Recal; Preamble—data acquisition, transmission, etc.);

E) vi) p) for each valid Applicant whose Affidavit that has been sufficiently verified, at least one Official amends the Voting Session computer records to CANCEL each LOST or STOLEN Ballot that was previously delivered to the Applicant;

E) vi) q) at least one Official verifies that each LOST or STOLEN Ballot according to the preceding steps, is designated as CANCELLED on all Voting Session records; and the Activity Status attribute for each CANCELLED ballot record is set to CANCELLED;

E) vi) r) at least one Official replaces or arranges to replace each LOST or STOLEN ballot, comprising of at least the steps whereby: 5.b.11.a. selecting one WHOLE Ballot designated as a REPLACEMENT Ballot for each Ballot that was CANCELLED; 5.b.11.b. each REPLACEMENT Ballot is identical to the CANCELLED ballot, except for at least one Random Symbolic Identifier of the REPLACEMENT Ballot being different from every Random Symbolic Identifier of the CANCELLED Ballot; each REPLACEMENT Ballot of claim is tested to be both VALID and AUTHENTIC; each REPLACEMENT Ballot passing tests has a Verification Status designated as CERTIFIED; the REPLACEMENT Ballot of Activity status is set to ACTIVE;

E) vi) s) for each verified Applicant whose Affidavit was also verified, at least one Official delivers, or arranges delivery of, at least one, REPLACEMENT Ballot to the Applicant(s);

E) vi) t) at least one Official delivers, or arranges the delivery of, any number of REPLACEMENT Ballots; whereupon delivery, the Ballot is now designated as a WHOLE ballot; and the Delivery Status attribute of each delivered REPLACEMENT Ballot is now DELIVERED;

E) vi) u) any number of Officials record the quantity/type of REPLACEMENT-WHOLE Ballots delivered to each Applicant;

E) vi) v) any number of Applicants receive any number of unique, different REPLACEMENT-WHOLE ballots of the same type submitted for replacement;

F) WHOLE Ballot Exchange—this method is unique among registered US patents, and provides a significant improvement in the arts pertinent to this invention.

F) a) Eligible Voters are entitled to exchange with someone they trust, any number of WHOLE Ballots they possess for identical, authentic WHOLE ballots that are valid per LIMITS OF USE. Voters can authenticate the ballot in person, by telephone or Internet by verifying the Random Symbolic Identifier. Security Elements may be used to determine if a ballot is a forgery.

F) b) To protect privacy, Voters are instructed to swap the ballot the Voter received, at least once, with someone they trust for a similar ballot that is valid within the geographic—political boundary of the Voting Session. This random, private ballot exchange decouples the Ballot recipient from the Eligible Voter List that was used to deliver the unique BALLOT VOTING RSID to a specific person and address. This can be done many times to increase the anonymity of the Voter. The privacy of the Voter is still enabled even if a Voter does not exchange WHOLE Ballots, as the Voting Session Officials likely have no easy method to determine whether or not any WHOLE Ballot was exchanged before being returned to them for tallying. Thus, Voter privacy is assured. (Inventor comments: This step methods are unique among inventions to preserve the anonymity of any Voter, and thus, for every Voter, since Voting Session Officials cannot determine which Voters used these steps/methods; In essence, Ballots are like treated like currency, whereby any Eligible Voter can use the WHOLE Ballot, which would be exchanged in kind for an identical WHOLE Ballot in a Voting Region-Zone, as per the Election Rules; Even if a PassCode RSID or Ballot Voting RSID were revealed, the voter can determine electronically or in person, whether the Ballot has already been used to Vote; By using hard to fake Security Elements, and nearly impossible to guess traceable BALLOT-ID RSIDs, traceable BALLOT VOTING RSIDs, and dealing with known to be trustworthy people, ensures the integrity of the voting system and assists Voters to be sure a Voter exchanges their valid, authentic WHOLE Ballot(s) only for valid, authentic WHOLE Ballot(s));

G) a) Each WHOLE Ballot has two parts—a MASTER Ballot and at least one RECEIPT Ballot (refer Entity Relation Diagram describing WHOLE Ballot and constituent parts)

G) b) Each WHOLE, MASTER and RECEIPT Ballot has at least one status attribute each attribute remains static in value until redefined by Officials;

G) c) The paper version of a WHOLE, MASTER, or RECEIPT Ballot shall include any number of alignment marks and indices for orientation of optical, magnetic, electronic scanning device(s) so as to facilitate the accurate scanning of data on any reasonable ballot.

G) d) Each part of the WHOLE Ballot, both the MASTER Ballot and any number of RECEIPT Ballots, share an identical, unique group of symbols as a correlating identifier.

A unique feature of this invention is a Random Symbolic Identifier (RSID) as the unique correlating identifier, discussed in following sections of H)e)1) to H)e)4), H)f) to H)h);

G) e) the second ballot part of the WHOLE Ballot is referred to as a RECEIPT Ballot; a unique feature of this invention is that each RECEIPT Ballot is manufactured so as to be easily and readily distinguishable from the MASTER Ballot, to the unaided human eye using any combination of methods and drawings described herein so as to readily distinguish the RECEIPT Ballot part from the correlated MASTER Ballot part;

H) a) To understand the MASTER Ballot part referred to in G) a), G) b) (refer to FIGS. 5,6,7,8 site plans for embodiment of MASTER and RECEIPT parts of a WHOLE Ballot;

H) b) BALLOT HEADER portion—this portion improves the invention of Kargel by providing information to enable the voter to independently make clearly informed decisions regarding the ballot by providing information to the voter: (i) as to the source of the ballot (FIG. 5 item 2A1,2,B,C=Ballot Source); (ii) defining the purpose of the ballot (FIG. 5 item 3A1-7=ballot purpose) including specific information as to the title of political position (FIG. 5 item 3A1,2=candidate position description), the political voting region details (FIG. 5 items 3A3,4,5=voting region info) for which the candidates of FIG. 5, items 4A1-4 to 4E1-4 are applying for as correlated to the political position of FIG. 5, items 3A1,2); (iii) clearly identifying the type of ballot (FIG. 5 item 2E-ballot type); (iv) instruction as to what to do with the completed ballot (FIG. 5 item 2F-ballot delivery instruction). FIG. 5 items 3A1-5 can be correlated to FIG. 5C-G.

H) c) BALLOT VOTING portion—this portion (FIG. 5, items 4A1-4 to 4E1-4) improves the invention of Kargel by providing vital information to enable the voter to independently make clearly informed decisions regarding the ballot selection options by providing specific instructions (i) as to how many candidates to select (FIG. 5 item 3A6=voting instructions); (b) and information as to how to properly select the candidates of choice (FIG. 5 item 3A7=candidate selection methods) which pertains to the correlated Candidates Selection Area (FIG. 5, Item 4A1 to 4E1=candidate selection area) that is used for marking to select any number of candidate(s); (iii) and specific descriptions of each candidates to significantly reduce selection errors (FIG. 5 item 4A2,3 to 4E2,3=candidate names) (iv) with an optional description of the candidate political party affiliation (FIG. 5—items 4A4 to 4E4); (v) and the further degree of democratic freedom of choice is given in FIG. 5 whereby a voter may print the name and/or political party description of their preferred candidate(s) or political party(s) for their voting region that are not already printed on the ballot, and thereafter vote for or against their “write-in” candidate(s) and/or political party(s).

H) d) BALLOT ID portion—this portion is unique among registered patents, providing significant improvements by this invention in the arts of invention of this invention type.

H) e) Although this invention was conceived without knowledge of Kargel's invention, there is a common thread whereby each WHOLE ballot, and the constituent parts comprising the MASTER Ballot, and any number of RECEIPT Ballots, share an identical, identifier.

However, Kargel does not specify any characteristics of his identifier, only a few unrelated details of use;

The same can be said for recently discovered (21 Jun. 2012) U.S. Pat. No. 7,975,920 (which was developed years after these patent documents were published)—although a random identifier is noted, it could be any simple random number, and there is no specification (as this patent provides) that the random identifier is constructed to be near impossible to guess, extract, predict, or pre-calculate—thereby assuring it is near impossible to forge any type of document with my extreme RSID, or any detrimental number of documents of this invention;

H) e) 1) This invention improves significantly on Kargel by the use of Random, Symbolic Identifiers (FIG. 5 items 5B, 5J2-BALLOT ID in the form of a Random Symbolic Identifier).

The Random Symbolic Identifier (RSID) is comprised of a group of randomly selected symbols, which are arranged in a combination that is unique among all RSID's of a Voting Session. Thus each MASTER Ballot part and each RECEIPT Ballot part(s) that comprise a WHOLE Ballot are uniquely identifiable among all ballots (and is also unique among all Voter Registration Forms) of a Voting Session.

H) e) 2) The RSID of FIG. 5-item 5B, 5J2 is encoded and correlated to a unique barcode FIG. 5-item 5J1 so as to facilitate rapid, automated optical scanning.

H) e) 3) A unique aspect and benefit of this invention is that the RSID is a random identifier which prevents anyone with any ballot from fabricating a series of ballots, by incrementing or decrementing values in reference to any known ballot identifier.

H) e) 4) This invention shall also include the provision to include a sequential series of symbols, or a repeatable pattern of symbols, should the Officials of the Voting Session desire such a feature. It should be noted that an implementation of either would require corresponding adjustment to this invention, including the understanding that the term RSID would imply either a sequence or pattern for this invention document; It is beyond the scope of this document to speculate at all the possible combinations of symbol sequences or patterns may created for either potential request.

H) e) 5) Furthermore, this invention shall also include the methods whereby no group of unique symbols are assigned to uniquely identify any ballot—authentication thereby relies primarily upon the Security Elements of the Ballot. The steps of research, computerized data mining of Eligible Voters, mailing ballots, exchanging ballots, and any parts of this invention would include any “no ballot id” version of this invention.

H) e) 6) This document considers use of the RSID of steps H)e)1) to H)e)4), with the implied claims to include other Ballot ID methods that may be applied instead sequential symbols/numbers in lieu of RSID(s)).

H) f) A very significant improvement of this invention is to make the RSID of steps H)e)1) to H)e)4) to be extremely difficult to guess. The purposes of the RSID is to enable verification by computer of the ballot identity as an authentication test of validity and to prevent counterfeiting of a multitude of ballots. The actual number of symbols to use for the RSID of this invention must be calculated, based on the number of voters anticipated, perception of security desired for making the RSID extremely difficult to guess, balanced with the data storage needs, scanning error rate, computer processing error rate and extra communication required for having a large number of symbols comprising each RSID; also taking into consideration the total number of ballots issued, expected replacements, anticipated number of enquiries, verifications, authentications, publications, etc.

Using at least one, and possibly two, or more, concatenated symbolic characters as a Random Symbolic ID (RSID) would provide unique identity security of every single ballot (depending on the number of ballots issued) for a single Voting Session. To understand how this is so, consider that ONE symbolic character can be represented by a unique combination of a sequence of eight (or more) computer binary digits in range of 00000000 to 11111111. Each sequence of binary digits has a Base 10 numeric equivalent value:

| ASCII characters | Binary code | Base 10 value |
|---|---|---|
| A | 01000001 | 65 |
| B | 01000010 | 66 |

Concatenating characters increases the number of binary digits that can be interpreted to represent larger binary and numeric (base 10) numbers, as well as for a plurality of counting base methods such as base 8 (octal), base 16, etcetera.

| ASCII characters | Binary code | Base 10 value |
|---|---|---|
| BA | 01000010 01000001 | 16961 |
| AB | 01000001 01000010 | 16706 |

Each unique concatenation is a unique combination of symbolic characters. The positional ordering sequence of the concatenated symbolic characters has a unique binary value and a correspondingly unique, equivalent numeric value that can be used to identify a specific sequence of concatenated symbolic characters.

Therefore each and every unique concatenation of symbolic characters also has a unique numeric value associated only with that specific combination of symbolic characters when using a consistent method of assigning each character symbol to only one binary value. (1×10E3=1,000 1×10E4=10,000 the maximum value of the most significant digit of the binary number is calculated by 2EX where X=number of binary digits.)

Consider the following:

| ASCII | Binary | Total “N” | 2 exp “N” = |
|---|---|---|---|
| Characters | Digits | Binary Digits | Maximum Value |
| 8 × | 8 = | 64 | 1.8 × 10E19 |
| 16 × | 8 = | 128 | 3 × 10E38 |
| 24 × | 8 = | 192 | 6 × 10E57 |
| 32 × | 8 = | 256 | 1 × 10E77 |

To understand how large these numbers are, consider that the Planet Earth has about 3.6×10E51 atoms; the entire Universe about 10E78 to 10E81 atoms.

(2004) reference note 1—http://mathforum.org/library/drmath/view/59178.html

How effective is a 16 character (128 binary digits) RSID (3×10E38) for voters ?

If we divided RSIDs among the entire human population of Earth: 7,000,000,000 3×10E38/7×10E9=4.28×10E28=42,800,000,000,000,000,000,000,000,000 unique RSID combinations available to EACH person on Earth. Guess which ONE their Ballot was given ! A super-computer capable of 4.28×10E12 guesses per second=4.28×10E28/4.28×10E12=1×10E16 seconds/(365 days×24 hours×3600 seconds)=317×10E6=317,000,000 YEARS to enumerate each possible RSID available for ANY Ballot given to each person on Earth !! At best it may take a 100 years to lucky guess one valid RSID—but then who has that ballot ?! So forgery on any large scale (or even of a single ballot) is essentially eliminated !! Especially when used in conjunction with other security elements such as embedded holograms, privacy passcodes, etc. This inventions unique application of these aforementioned mathematical facts are such that any attempts to counterfeit any Ballots are futile, as without a valid RSID, a ballot is rejected by the Voting Session computers. There is no point trying to fake multiple copies of a known BALLOT VOTING RSID, as only one BALLOT VOTING RSID is considered in the vote records and tallies. When two or more ballots having an identical BALLOT VOTING RSID are detected, the ballots prior and subsequent votes are nullified, then all ballots with the identical BALLOT VOTING RSID are extracted and processed electronically and/or manually to inspect each Ballot composition and Security Elements for Authentication and Validation to certify which ONE ballot to tally for a Vote. Other steps such as including the Voter Registration card with each Ballot acts to pre-screen possible forgeries and also trace sources of forgery if necessary.

Therefore it is also absolutely vital that ALL valid BALLOT VOTING RSID's created by the Voting Session Officials be kept absolutely secret before and during the voting session; further said RSID symbols may be further data compressed; said RSID may be further appended or prefixed by any number of data symbols used for error detection and/or error correction, usage designation identifier, data encryption security;

In one application of use of this invention, only the person casting their MASTER Ballot should know the BALLOT VOTING RSID being used when casting their vote. The optional use of a VALIDATION RSID can further help to enable Voters to check their Ballot is valid for use, without revealing the final BALLOT VOTING RSID. Alternatively, the BALLOT VOTING RSID is used for both pre-vote validation and then also for casting a ballot. Any ballot may be cast optionally in conjunction with the use of a BALLOT PASSCODE (FIG. 5, item 5A) that is not revealed until time to use the ballot (similar to bank ATM card PIN=personal identifier number);

H) g) To further reduce errors in computer ballot processing a warning is included (FIG. 5, item 2D=ballot processing warning), to reduce the amount of manual processing.

H) h) To further reduce and detect errors, each type of RSID symbols (FIG. 5, items 5B, 5J2 are also scanned and compared to each other as well as the RSID derived from the correlated barcode (FIG. 5, item 5J1) for corroboration of the RSID.

H) i) SECURITY ELEMENTS portion—This is another unique feature of this invention with respect to other inventions of the scope of this art. This feature is a vital feature to ensure the integrity of the ballot, in order to guarantee the final vote tallies are not unfairly influenced by the creation of fictitious voters. Security Elements (FIG. 5 item 2D, 5H, 5I1, 5I2; Voter signature/private voter password and date ballot cast as per FIG. 6 items 6A,6B in correlation-comparison with Voter Registration FIGS. 1A,1B, items 15L1, 15L2) are designed to assist with authentication of any Ballot, whereby the Security Elements may also be comprised of any number of components Random Symbolic Identifier codes of steps H)e) to H)h), sequential symbolic identifiers, grouped symbolic identifiers, physical characteristics or devices, optical characteristics, structures or devices, electronic characteristics, devices or structures, magnetic characteristics, fields or devices, organic or inorganic chemicals, biological materials, genetic materials or genetic structures or genetic sequences, special materials, crystal structures, plastics, metals, gas emissions, electromagnetic radiation, radioactive materials, optical emissions, natural fibers, man-made fibers, microfilm dots, microscopic writing, embossing, impressions, watermarks, seals of authenticity, and any other physical structures, or any other properties, affixed or associated with any ballot; and options for decoding-encoding elements of every RSID so as to locate the RSID elements within a plurality of data structures for data correlation-comparisons, security-authentication;

H) j) LIMITS OF USE portion—The variety of Voting Sessions possible requires that this section of the Ballot be considered as a variable data area. The LIMITS OF USE area of the Ballot contains several data fields, whereby any single data field may be displaying any number of any data fields, in any number of combinations of data fields, having correlated data for each data field logically inter-related to each other and furthermore defining the correlation for each distinct group of ballots, using correlated information derived from various sources of information. The LIMITS OF USE area may also be considered a generic “BALLOT DATA SUB-CONTAINER” that is separate and distinct from both the “BALLOT SENDING DATA CONTAINER” and the “BALLOT RECEIVING DATA CONTAINER” when using methods of marking, identification, encapsulating or otherwise hiding ballot internal details (eg such as, but not limited to RSID) when implementing printing, distributing, receiving, sorting, validating, tallying, certifying, error detecting, error correcting of any number of documents WHOLE ballots, MASTER BALLOT parts of WHOLE BALLOTS, RECEIPT BALLOT parts, WHOLE Voter Registrations, MASTER Voter Registration parts of WHOLE Registrations, any other documents or parts;

Voting Region sub-portion (FIG. 5, items 5C, 5E, 5F, 5G, 5K1, 5K2=ballot region info) identified within the LIMITS OF USE portion of a Ballot is used to describe the Scope of a Voting Session sub-portion (FIG. 15—ER Voting Regions).

Voting Region also refers to a variable group of attributes—Province or State, Municipality, Zone, Poll Station, Postal or Zip Code. The groups of Voting Region attributes are used for data storage, and may also be components of the Voting Region, depending on the Scope of the Voting Session. Any number of Voting Region attributes may be visible on Voter

Registration (FIGS. 1,2) or Information Forms (FIGS. 3,4) MASTER Ballots and the correlated RECEIPT Ballots (ref. FIGS. 5-10, 18, 20, 23), Delivery Confirmation/Ballot Activation Forms (FIG. 24), Electronic Voting RECEIPTS (FIG. 25,26), Voting Reports, Process Reports, Calculations, Tallies, Summaries (FIG. 28-30), etcetera or as specified by Officials to meet the needs of any Voting Session.

H) j) 1) VOTING REGION IDENTIFIER (FIG. 5-items 3A3,4,5 and FIG. 5, items 5E,F,G=VotingRegionID) sub-portions of the LIMITS OF USE portion is a unique identifier or group of identifiers used to further define the scope of application of the ballot such that it is correlated to (but not limited to) a geographic area, or, a subset of a group of people or legally recognized entities, etcetera; as correlated to FIG. 15; and also whereby FIG. 5-items 5K1 is a composite barcode correlated to the values of FIG. 5-FIG. 5, items 5E,F,G which can alternatively be displayed as separate barcodes as per FIG. 9, items 3E2b,c,d correlated to FIG. 9 items 3Eb,c,d.

H) j) 2) Referring to FIG. 9—item 3E1b,c,d forms a Voting Region Name Description for ease of human interpretation to facilitate ballot exchanges and other human processing; and 3E2b,c,d are correlated barcodes to facilitate electronic-optical machine processing. Refer to FIG. 9-item 3E1b1 is the Zone Identifier Number; item 3E1b2 is a Zone Name Description for item 3E1b1; item 3E2b1 is a barcode for items 3E1b1 and/or 3E1b2;

H) j) 3) Refer to FIG. 9—Item 3E1c1 is a Polling Station identifier, an attribute (component) of the Voting Region identifier, used to organize Ballots and facilitate analysis. Item 3E1c2 is a barcode correlated to the value of item 3E1c1.

H) j) 4) Refer to FIG. 9—item 3E1d1 is a Province-State attribute of the Voting Region (as correlated to FIG. 15); item 3E1d2 is a Date component of the Voting Session; item 3E2d2 is a barcode correlated to the value of the concatenated items 3E1d1 and 3E1d2. Item 3E1d1 & 3E1d2 may also be considered as the Voting Session Host Identifier (VSHID) used to uniquely identify, distinguish & organize a variety of ballots per any Voting Session.

H) j) 5) an optional item is a Postal-Zip Code identifier (as referred to by FIG. 15), an attribute (or component) of the Voting Region and of the ZONE ID to facilitate analysis of voter responses. Postal-ZipCode Identifier may have a barcode correlated to description values.

H) j) 6) Refer to FIG. 9, item 3E1a is a Title of the Elected regarding the purpose of the ballot being a Candidate Election to fulfill the elected Duty. Item 3E1a2 is the abbreviation e symbols for the UNIQUE code associated to the Political Duty, which may be used for election accounting of ballots, or verification for ballot exchange, other ballot processing, or ballot cost accounting. Item 3E1a3 is a barcode correlated to the value of item 3E1a2.

H) j) 7) Refer to FIG. 9—item 3D1a,b refers to Ballot Delivery Due Time and Due Date identifiers—Delivery Due Date (item 3D1a) and Delivery Due Time (item 3D1b) describes the latest date and time the ballot is required to be delivered to the designated receiver(s) of the Voting Session, in order for the Ballot to be considered for any Official processing. Item 3D2 is a barcode with value correlated to concatenated or numeric value(s) of 3D1a,b.

H) j) 8) So far descriptions have looked at the constituent components of various types of ballots which have general groupings, whereby FIGS. 5, 7, are examples of “Candidate Ballots”; whereby FIG. 9,20 is an example of a “Proposal Ballot”; FIG. 18, 23 comprised of Candidates and Proposals (“Hybrid” Ballot).

H) j) 9) In the case of a Proposal Ballot (FIGS. 9, 20), any number of proposals are presented and each are given AT MOST ONE unique proposal identifier (PropID) that is correlated to the ONE correlated proposal, and further correlated to the sub-portion allocated to record the voters choice(s). Each proposal unique identifier (PropID) may also be assigned any number of barcodes correlated to the value of the associated PropID, and/or to any number of the value(s) of the voter choice(s) available; and the further degree of democratic freedom of choice is given in FIG. 9 whereby a voter may print the name and/or description of their preferred proposal(s) not already on the ballot, and then vote on their “write-in” proposal(s). Proposal Ballot Security Elements (Voter signatures and dates as FIG. 10 items 4A4, 4A5 in correlation-comparison with Voter Registration FIG. 1, items 15L1, 15L2) are designed to assist with authentication of any Ballot,

H) j)10) FIG. 18, 23—Hybrid Ballot of Candidates and Proposals (“Hybrid” Ballot), a Voter may mark to select the desired number of candidates and/or proposals;

H) j)11) VOTING REGION—refers to FIG. 5 (items 3A3,4,5 5E,F,G) FIG. 9 (items 2B1,2,3, 3E1b,c,d), FIG. 18, FIG. 23 and correlates to FIG. 15 “Voting Region”—is used to reduce human error when exchanging or processing ballots; an alternative is the use of an integrated Region-Poll Identifier that identifies any number of sub-regions within a Zone or Region ID; whereby the Region Name description eases human interpretation, and for each figure, each single barcode or group of amalgamated/combined barcodes is correlated to the values of (but not limited to):Region Name, Region ID, Poll Station ID.

H) k) To further reduce and detect errors, the identifier symbols of any descriptive human readable text of any ballot, form or document fields may also be scanned at the same time and compared to values of the respective scanned barcode(s) values for corroboration—and the additional options for decoding-encoding and evaluating the aforementioned identifier symbols to the data contained by the elements within any number of n-dimensional matrices of the correlated VOTING RSID via associated decoded-encoded coordinates referred to in H)i) or any other data of this invention;

H)j) As the steps, means methods and processes described involve people and devices that are not perfect in design, function or operation, all aspects of this invention shall also include, but not otherwise be limited to:

1) All methods within the broad scope of data processing tasks may be applied to this invention; in particular this invention includes the means and methods of acquiring data from any remote or local data source, or any type of ballots conforming to Voting Session rules;

2) The steps of locating, detecting, reading, receiving, interpreting, translating, correcting, and transmitting any number of, any type of, and any combination of Security Elements: holograms, symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing and any other physical structures associated with a ballot or a plurality of WHOLE Ballots, MASTER Ballots, RECEIPT Ballots, Voter Registration Forms, Voter Registration RECEIPTs physical or electronic data containers, or any other type of documents or containers, data items or data transmissions of this invention;

3) the tasks of locating, reading, receiving, detecting, translating, correcting, interpreting and transmitting any number of, any types of data items are performed by any combination of:

a) any number of Official(s) of any type;

b) any number of data acquisition devices;

c) any number of communication networks;

d) any number of other man-made device or plurality of devices;

e) the methods of transmitting data to, and receiving data from, any number of humans, computers, devices, telephones, the Internet or any other communications networks; including the methods of translating human and device readable codes to any number of methods, modes, protocols, of data communications, data-signal error corrections;

f) the methods of locating, receiving, detecting, interpreting, translating, reporting, and transmitting error free data; or correcting: compromised, erroneous or duplicate data;

g) any steps, means, methods and processes of monitoring, acquiring, detecting, receiving, transmitting, acknowledgement, confirmation, verifying or correcting of any compromises, errors, duplicate data; and furthermore, any steps, means, methods and processes of monitoring, acquiring, detecting, receiving, transmitting, verifying effects of any

corrections or other actions taken;

i) optionally applying Voter anti-tamper methods of Voter Person Security Items of: personal hand-written signatures, personal initials, hand written signing dates, private passwords, passcodes, pass-phrases, public personal: symbol combinations, icons or graphics;

j) utilizing ballot activation documents (e.g. FIG. 27) prior to voting;

k) providing Voters receipts to confirm voting successful completing and a copy of voting;

4) a) and the further steps and methods of employing a plurality of computers running a plurality of software programs as functioning independently or cooperatively via any number of any types of networks and/or any types of communications systems;

b) and further steps and methods of creating any number data organization structures of generic conceptual group types as group formation categorizations, and of creating any number of groups of said group types so as to be usable instances of group types to enable further data organization, security partitioning, and coordinated processing and voting system optimization; and further assigning any number of attributes and attribute values to each group and to a plurality of groups; and the further step of creating and assigning any number of groups to be subordinate to any number of other groups; and the further steps of correlating groups to groups, correlating groups to attributes, correlating data to attributes;

creating a plurality of modal groups for each method of voting; creating and correlating a plurality of data structures to each said modal group and to each sub-group categorization (such as, but not limited to: user, system, external) and to a plurality of correlated sub-group attributes (such as, but not limited to: process, services, events) within each sub-group categorization;

c) the steps and methods of creating a plurality of data organization groups for each mode and method of voting so as to provide collecting, sorting, separating and organizing a plurality of data items, any types of RSIDs, documents, forms, containers, objects, events, groups, communications, processes, or any item of this invention;

d) the steps and methods of creating a plurality of RSID whereby:

The RSID and RSID group type symbols must be pre-determined, and the number of symbols to use for the RSID of this invention must be pre-calculated, based on the number of voters anticipated, level of security desired for making the RSID extremely difficult to guess, balanced with the data storage needs, scanning error rate, computer processing error rate and extra communication required for having a large number of symbols comprising each RSID; also taking into consideration total number of Ballots issued, expected replacements, anticipated number of enquiries, verifications, authentications, transactions, secure communications, etc.;

RSID groups are sized to differentiate usages (such as, but not limited to: Ballot RSIDs—32 symbols, Voter Registration form RSID—16 symbols, Registered Voter RSID—24) and/or composed of different and/or similar groups of reference symbols of the RSID group types (such as, but not limited to: Ballot RSID—symbol groups A (24 symbols) and B (16 symbols), Voter Registration—symbol group A,C, Containers—symbol group B,C); Constructing an RSID is comprised of the steps and methods whereby:

(A) defining the maximum number of Random Symbolic Identifiers needed to ensure that each RSID is unique and extremely difficult to guess, infer and predict; first determining the minimum number of RSIDs required by considering data such as, but not limited to: the number of Potential Voters according to Research steps, the number of correlated RSIDs per each type of objects and events of this invention; a plurality of Officials utilize any number of Voter lists to estimate, calculate and generate an estimated number of required RSIDs per Voter that are constructed to differentiate and accommodate all types of, and any number of each required RSID secured items such as, but not limited to: documents (such as, but not limited to: Ballots, Voter Registration forms, Voter-Proxy Language Registration forms), containers, security labels, Voter Lists, Potential Voters, secure data items, securely identified transactions, transaction receipts (such as but not limited to: internet voting transaction receipt, telephone voter registration transaction receipt), secured Receipts, secure validations-authentications of any types of documents, secure tagging identification of Official Vote Processing Devices, secure data communications, estimated number of containers, estimated number of voter registrations, expected number of Ballot replacements, estimated number of registration transactions, voting transactions, estimated number of Receipts generated, anticipated number of enquiries, verifications, authentications, publications, communications events, communications data security info, secure document and container scanning activities, secure external data objects;

(B) and for each aforementioned type of group classification, the further steps of calculating and generating an estimated extra number of RSIDs that are marked inactive and stored separately for rapid assignment as the need arises;

(C) and the steps and methods of creating any number of any type of RSID (such as, but not limited to: Random Symbolic Identifier, Sequential Symbolic Identifier, Group Pattern Random Symbolic Identifier, Group Pattern Sequential Symbolic Identifier) used in any type of document or items of this invention (such as but not limited to: Ballots, voter registration forms, containers) such that the steps in creating each RSID and/or group of RSIDs are done in a logical consistent manner such as, but not limited to:

(1) Officials select or create at least one reference group of symbolic characters (which may include numeric symbols and any other symbols or characters graphics or icons from any known human languages or codes) and specify correlated numeric values to each symbol removing redundant and easily confused symbols from each reference group;

(2) (i) assign at least one reference symbol group to at least one group of objects (such as, but not limited to: document objects—such as, but not limited to: Ballots, containers, voter registrations, ballot and registration receipts, transaction receipts);

(ii) assign at least one reference symbol group to any number of event groups of this invention (such as, but not limited to: transactions, communications, error processing);

(iii) assign and combine more than one reference group of symbols for each selected group of objects, and each selected group of events;

(iv) assign particular groups of reference symbols to select objects groups and select event groups of this invention so as to distinguish those selected objects group types and event group types to be distinguished from all other object group types and event group types;

(3) whereby officials determine, perform manual calculations, and/or use and any number of computers running software programs to apply mathematical concepts in estimating and calculating, for each RSID object and event group type (such as, but not limited to: Ballots, Voter Registration forms, Containers, secure internet voting transaction Receipt ids),

(i) total number of unique RSIDs needed per group,

(ii) the largest number of RSIDs needed for each group,

(iii) the total number of RSIDs needed overall;

(iv) the minimum number of symbols needed to generate a sufficiently number of unique permutations of RSIDs so as to be able to create one unique symbol permutation for the required number of RSIDs of each group (example: two letters A, B yields 4 unique permutations AA, AB, BA, BB);

(v) the reiterative steps of pre-defining and inhibiting creating then reviewing and removing any excessively repetitious, confusing or undesirable RSIDs and sub-patterns therein;

(vi) and the further iterative steps of adding any additional number of symbols and symbol permutations so as to increase the number of acceptable RSIDs patterns and acceptable RSID internal patterns to achieve the required total number of symbol permutations needed to assign to each RSID therein each group type;

(vii) Officials assign ONE unique numeric binary value to each symbol or use an existing symbol code set that has symbols and correlated numeric values (such as but not limited to: ASCII character set);

(viii) for each group type, and for each required number of RSIDs of each group, Officials:

(a) randomly selects symbols from the final set (step “vi”) of acceptable symbols until reaching the desired size of the RSID for the group;

(b) concatenates each symbol of each RSID to produce a unique symbol string—a textual embodiment of the RSID which may then be split into sub-groups of symbols for easier human usage and or data processing—but is considered in its entirety);

(c) rejects undesirable RSIDs by limit the number of times a single symbol, or group of symbols, is repeated within each RSID so as to avoid confusion, eliminate undesirable patterns, and to optimize human perceptions of recognizable uniqueness;

(d) assigns a unique binary value to each acceptable RSID by consistently concatenating the correlated binary value assigned to each RSID symbol, then interpreting the assembled binary string as a single binary number (which may then be split into sub-groups of numbers for easier human usage—but is considered and processed in its entirety);

(e) enforce the principle of substantial numeric spacing so that each RSID binary value is unequivocally unique and predominately numerically distant in value from all RSIDs within a group and among all RSIDs;

(ix) and the further steps and methods of correlating any number of RSIDs internal symbol group sub-patterns or directly to any symbols of:

(a) any types of alpha-numeric symbols or any other language graphical or imagery symbols (such as, but not limited to: English alpha-numeric characters, Russian, Greek, Norse, Arabic, Japanese and/or Chinese language symbols);

(b) any number of barcode graphical symbolic representations;

(c) any number of calculated or derived barcode values or symbols;

(4) RSID symbols are consistently applied for each identifier group of any group type, and each group RSID may have extra prefixes, suffixes and/or compressed and/or encrypted so as to remain uniquely differentiated among all identifiers;

(D) for each modal group type and modal group thereof, the steps of creating any number of any type of RSIDs for each group type and for each group of RSIDs and subordinate object, processes, services, events, activities thereof are consistently formed by:

(a) defining the upper limit number of Random Symbolic Identifiers needed to ensure that any one RSID is unique and extremely difficult to guess, by considering:

(i) the number of Potential Voters according to Research steps, and estimated number of Eligible Voters,

(ii) the potential number of RSIDs for each group type of objects, events, activities, processes and services;

(iii) and the further steps of assigning at least one reference symbol group to each “characterization group”, each “modal group” each “object group” each “events group”, each “activities group”, each “process group”, each “services group” of this invention;

(iv) assigning and combining more than one reference group of symbols for each group;

(v) assigning particular groups of reference symbols to select groups of this invention to distinguish those groups from all other groups;

(b) the symbols are pre-determined as a reference set for each RSID group whereby officials determine, perform manual calculations, and/or use any number of computers running software programs to apply mathematical concepts in estimating and calculating, for each group that requires an RSID; (i) total number of unique RSIDs needed per group type, (ii) the number of RSIDs needed for each group of each group type, (iii) the total number of RSIDs needed overall; (iv) the minimum number of symbols needed to generate a sufficiently number of unique permutations of RSIDs so as to be able to create one unique symbol permutation for the required number of RSIDs per group; (v) the iterative steps of pre-calculating and inhibiting creating and then scanning and removing any excessively repetitious, confusing or undesirable RSIDs and internal sub-patterns therein for each group and each group type; (vi) and the further iterative steps of adding any additional number of symbols and symbol permutations so as to increase the number of acceptable RSIDs and/or RSID internal patterns to achieve the required total number of symbol permutations needed to assign to each RSID for each group type and each group therein and for each object, event, service, process, activity therein each group;

(c) Officials assign ONE unique numeric binary value to each symbol or use an existing symbol code set that has symbols and correlated numeric values;

(d) for each group of each group type, and for each required number of RSIDs of each group, Officials: (i) randomly select symbols from the final set (step “b.vi”) of acceptable symbols until reaching the desired size of the RSID for the group type; (ii) concatenate each symbol of each RSID to produce a unique symbol string—a textual embodiment of the RSID (which may then be split into sub-groups of symbols for easier human usage—but is processed in its entirety); (iii) reject undesirable RSIDs by limit the number of times a single symbol, or group of symbols, is repeated within each RSID so as to avoid confusion, eliminate undesirable patterns, and to optimize human perceptions of recognizable uniqueness; (iv) assign a unique binary value to each acceptable RSID by consistently concatenating the correlated binary value assigned to each RSID symbol, interpreting the assembled binary string as a single binary number (which may then be split into sub-groups of numbers for easier human usage—but is considered and processed in its entirety); (v) enforce the principle of substantial numeric spacing so that each RSID binary value is unequivocally unique and predominately numerically distant in value from all other RSIDs within any group and among all RSIDs;

(e) and the further steps and methods of correlating any number of RSIDs internal symbol group sub-patterns or directly to any symbols of:

(i) any types of alpha-numeric symbols or any other graphical language symbols;

(ii) any number of barcode graphical symbolic representations and barcode values;

d) utilizing at least one symmetric and/or asymmetric encryption public and private key pairs, key certificates, encryption algorithms, decryption algorithms, digital signature algorithms to encrypt and/or decrypt at plurality of data such as, but not limited to: voter ballot data sets, voter ballot processing data sets, voter registration data sets, ballot process data sets, ballot casting transaction identifiers;

e) for any types of documents (such as bit not limited to: ballots, voter registration forms, ballot return containers) whereby voter and official data is extracted by scanning and/or capturing an image of said document by using a high speed optical, electronic and/or electromagnetic scanning device or photographic camera, then storing said image and then rendering (physically, optically, electronically and/or electromagnetically) so as to enable applying at least one or a series of reading templates that isolate data fields and enable decoding of position data correlated to said data fields, then extracting data from said data field by use of computers running optical character recognition and/or intelligent character reading programs; further interpreting, storing, tallying, publishing said data set fields;

f) and the further steps and methods of employing a plurality of computers running a plurality of software programs functioning independently or cooperatively employing any number of, and any types of computer neural networks, artificial intelligence software, electronic or optical or electromagnetic vote processing devices and/or communication networks used for data processing, storage, telemetry, communications, security, and for any types of functions or processes of this invention (such as, but not limited to: ballot image capturing, ballot data field reading and decoding, data storage, search and/or retrieval, intelligent image processing, RSID character reading, device assignment & prioritization, resource allocation, data searches, data retrievals, data communications, data security, system access security, voter authentication, registration processing, ballot sorting, tallying, analysis, reporting, error detection, error corrections, error rejections, validation, authentication, certification, forgery detection, forgery rejections, duplicate detections, duplicate rejections, duplicate extractions, document design, printing, Voter Registration, Ballot processing, voter registration research, ballot sorting, distribution, receiving, vote processing device workload balancing) and for any steps and methods of this invention;

g) embodying a voter registration and/or ballot as a smart card having private identifiers and passcodes encoded and embedded in magnetic stripes, holograms and/or micro-devices;

5) the steps and methods further described in the following claims of this invention;

What is claimed is:

1. A method and system of “voter registration and voting” for any number of, and any types of Voting Sessions by methods of postal mail, electronic mail, internet, telephone, cellular phone, mobile data device, facsimile, interactive television, or in person—comprising of:
(i) a plurality of electronic voting systems, operating independently or interconnected via any number of, and any type of networks, whereby each voting system is comprised of at least: one data processing computer running data processing software, any number of telephone communication devices, any number of computers running software programs to process telephone voice audio and facsimile transmissions, any number of internet communication systems, any number of internet communication devices, any number of internet webservers, any number of internet client computers, any number of internet electronic mail server computers, at least one computer security server controlling voting system security, any number of optical document scanners, any number of optical barcode readers, any number of camera devices, any number of magnetic ink printed document processing devices, any number of computer printers, any number of computer CDROM-DVD reader/writer devices, any number of electro-magnetic memory devices, any number of security authentication devices, any number of electronic voting terminals, any number of paper document voting processing devices, any number of interactive television systems devices, any number of computer Uninteruptable Power Supplies, any number of ancillary electronic devices, any number of physical document sorting, counting, processing and handling devices, and any number of any other types of electronic devices, electro-magnetic devices, electro-optical devices or electro-mechanical devices that shall also include any number of: data acquisition devices, electronic, electromagnetic, optical or biological or other computing or analytical devices, communication networks, any type of electronic data transmissions, any other man-made devices, as well as any number of, and, any type of computer software—which are hereafter referred to individually and collectively as “Vote Processing Devices” which are used individually or in any combination with any number of and type of documents, forms, containers, objects, data transmission or data elements of this invention.

2. The voter registration and voting system of claim 1 wherein: at least one Official uses at least one computer running software programs for the purposes of creating, defining, assigning and correlating each type of Security Element such that at least one Official:
(a.i) generates a plurality of Random Symbolic Identifiers (RSIDs) which are constructed so as to be extremely near impossible to guess, derive, extract, predict or pre-calculate; and (a.ii) records and stores each RSID created in an unchangeable form on at least one permanent data storage media, along with the creation dates, times, any other relevant information; (a.iii) assigns at least one RSID to any single ballot, voter registration form, language selection form, ballot envelope, data container, receipt, object, data item or transmission of this invention; (a.iv) consistently assigns to any type of and any number of groupings of similar ballots, voter registration forms, language selection forms, ballot envelopes, data containers, receipts, objects, data items or transmissions—such that at least one RSID is consistently assigned for each ballot, voter registration form, language selection form, ballot envelope, data container, receipt, object, data item or transmission within any group; (a.v) assigns any number of RSIDs to any number of ballots, voter registration forms, language selection forms, ballot envelopes, data containers, receipts, objects, data items or transmissions of this invention; (a.vi) assigns one Ballot Voting RSID to each Ballot; (a.vii) assigns one Validation RSID to each Ballot; (a.vii) assigns one Voter Registration RSID to each eligible voter; (a.viii) assigns one Certified Voter RSID to each certified, registered voter; (a.vii) records the dates, times, and any other relevant information along with the usage assignment notes for each RSID that is assigned;
(b.i) generates a plurality of linear barcode(s), or two dimensional barcode(s), or n-dimensional barcodes, or any other type of value weighted graphical symbolic representations of data; (b.ii) correlating each RSID value of (a) to one barcode numeric value and to one barcode representation; (b.iii) consistently assigns a barcode along with a correlated RSID to any type of and any number of ballots, voter registration forms, language selection forms, ballot envelopes, data containers, receipts, objects, data items or transmissions of this invention; (b.iv) assigns and correlates any number of, and any type of group of character symbols, data values, data elements, numbers, symbols or groups of human readable words—that are regarded as the source(s) of information—so that each unique content from the source(s) of information is correlated to a specific unique barcode pattern which shall be further correlated to a uniquely encoded group of symbols that has a correlated, unique numeric value for each unique barcode pattern and unique source content; (b.v) retrieves or scans any number of any type of data elements or groups of human readable words, numbers and symbols that are regarded as or correlated as the source for the information element for each barcode; (b.vi) corroborates the accuracy of scanning of any number of barcodes, by further comparing the values and/or symbolic representations of each information element of the source to the values or symbols derived from scanning the correlated barcodes; (b.vii) records the results of scanning and corroboration comparison, signaling any number of error messages, and option steps of error verification analysis, error correction, error correction analysis so as to facilitate the accurate scanning of data associated with each barcode, for any number of barcodes and the inter-related source information and correlated numeric values and symbolic values thereof;
(c) defines objects characteristics or properties of materials or man-made devices such as: embedded micro-electronic or micro-optical or micro-chemical devices, holograms, Braille code embossing, optical structures or devices, electronic devices or structures, magnetic fields or devices, organic or inorganic chemicals, biological materials, genetic materials or genetic structures or genetic sequences, specialized man-made materials, crystal structures, plastics, metals, gas emissions, electromagnetic radiation, radioactive materials, optical emissions, natural fibers, man-made fibers, microfilm dots, microscopic writing, embossing, photon-sensitive symbols, photon-sensitive text, or infra-red radiation sensitive (text, symbols or images) on/in materials, electronic codes, optical codes, optical or digitized pictures, codes embedded within optical pictures or digitized pictures, watermarks, or seals of authenticity which are integral, affixed or associated thereto any ballots, voter registration forms, language selection forms, ballot envelopes, data containers, receipts, objects, data items or transmissions, or to any number of Voter Personal Security Items, or to any number of Vote Processing Devices of this invention.

3. The voter registration and voting system of claim 1 wherein: at least one Official: (a) employs any number and combination of “Vote Processing Devices” and computers running software for the purpose of determining the names of Potential Voters, and their contact information of said Potential Voters; (b) records the Potential Voters names, contact information, dates, times, and any other relevant voter-registration qualifying information; (c) and the further steps of determining from step “(a)” which are Eligible Voters; (d) then correlates each Eligible Voter to a single Eligible Voter List which is correlated to the Voting Region or Voting Caste the Voter is affiliated with; (e) sends and makes available a plurality of Voter Registration forms to any type of Voter, and any number of Voters; (f) evaluates, certifies and registers all Voters that properly and adequately reply in time with a complete Voter Registration form that qualifies them to be designated to the Certified Registered Voters List.

4. The voter registration and voting system of claim 1 wherein:
(a) at least one Official sends or makes available, at least one ballot, voter registration form, language selection form, ballot envelope, data container, receipt, object, data item or transmission of this invention to any type of Voter—with the restriction of sending Ballots for Voting to each Voter only if their name is already on the Certified, Registered Voters List;
(b) and the further step of at least one Official sending any number of ballots, voter registration forms, language selection forms, ballot envelopes, data containers, receipts, objects, data items or transmissions of this invention to any number of, and any types of Voters—with the restriction of sending Ballots for Voting to each Voter only if there name is already on the Certified, Registered Voters List;
(c) Official(s) recording for each Voter, notes of the dates, times, and any other relevant information of each single ballot, voter registration form, language selection form, ballot envelope, data container, receipt, object, data item and transmission sent to the Voter.

5. The voter registration and voting system of claim 1 wherein: a plurality of any type of Voters receives at least one:
(a) voter registration forms, language selection forms, data containers, receipts, objects, data items or transmissions of this invention;
(b) a plurality of Eligible, Registered Voters receiving at least one Whole Ballot, any number of ballot envelopes, data containers, receipts, objects, data items or transmissions of this invention; and further wherein: within any Voting Region, any number of Certified Registered Voters, or their designated legal proxy, may optionally exchange any number of times, any number of valid, authentic Ballots, that are useable within their Voting Region and Jurisdiction for the currently active or impending Voting Session; and whereby any number of Certified Registered Voters or their proxy, use a Validation RSID assigned to communicate to at least one Official as to whether the Ballot they may exchange their ballot for has a valid RSID;
(c) and further whereby: after participating or disregarding the integral options for exchanging ballots, any number of Voters, complete any number of ballots, voter registration forms, language selection forms, ballot envelopes, data containers, receipts, objects, data items or transmissions of this invention, then optionally write-in any alternative candidate choices or proposals, then affix or assign their personal security items to the aforesaid, then return the aforesaid to at least one Official or a plurality of Officials, using any number of Return Containers.

6. The voter registration and voting system of claim 1 wherein: at least one Official:
(a) receives any number of ballots, voter registration forms, language selection forms, ballot envelopes, data containers, receipts, objects, data items or transmissions and Voter personal security items of this invention—from any number of Voters, and any types of Voters;
(b) records notes for each Voter submission: the dates, times, and any other relevant information along with data about each and all received ballots, voter registration forms, language selection forms, ballot envelopes, data containers, receipts, objects, data items, transmissions and Voter personal security items; then chooses to either:
(c) accepts for processing any number of ballots, voter registration forms, language selection forms, ballot envelopes, data containers, receipts, objects, data items or transmissions of this invention, which DO have a valid, usable RSID, or,
(d) refuses to accept for processing any number of ballots, voter registration forms, language selection forms, ballot envelopes, data containers, receipts, objects, data items or transmissions of this invention, which DO NOT have a valid, usable RSID, or, (e) accepts and segregates any number of items or transmissions of this invention, which do have a valid, but duplicate RSID—and then reviews the authenticity of a plurality of objects, data items or transmissions, and then acting to certify and restore the valid objects, data items or transmissions to relevant processing, and then amends all related records accordingly;
(e) and for all instances of a valid RSID then processing all timely received ballots, voter registration forms, language selection forms, ballot envelopes, data containers, receipts, objects, data items or transmissions of this invention which are validated and certified by first acquiring, recording and storing an image of the entire ballot, form, container, receipt, then for the said image, enhancing, scaling and rendering said image for scanning the associated RSID symbols and the RSID barcode by selecting an appropriate document scanning template, or a series of scanning templates, designed to isolate desired data fields for data capture and/or imaging, and extracting the correlated values of said data fields by employing optical character recognition software and/or intelligent character reading software for extracting, reading and decoding the extracted data fields values so as to compare to the corresponding Official records of valid RSID values previously created, recorded and stored,—whereby for matching RSID values are deemed valid—(i) processing each voter registration form, language selection form, ballot envelope, data container, receipt, object, data item or transmission is deemed valid for scanning; (ii) scan each of the aforesaid having a valid RSID, to extract any number of: Voter information items, Voter personal security items, Official data elements, Security Elements, alignment marks and scan zone coordinate marks which are then recorded, correlated, analyzed, error checked, authenticated or rejected, tallied, and stored; or, (iii) scan each ballot that is deemed having a valid RSID, extracting any number of: Voter Selections, Voter Write-In choices, Voter personal security items, Official data elements, Security Elements, alignment marks and scan zone coordinate marks from any number of required portions of the Ballot which are then recorded, analyzed, error checked, authenticated or rejected, tallied, and stored;
(f) enable each voter to validate their voter registration or cast ballot vote processing accuracy by using their privately known Ballot Voting RSID or Voter Registration RSID and any number of Official PassCodes and/or any number of Voter Personal Security items, so as to confirm Official processing accuracy or to make amendments, optionally by referring to correlated private internet webpages and any number of official records;
(g) at the end of the voting session, the total number of voters is published, and all ballots received are tallied, summarized and published, along with a complete list of all timely received, and all other valid, Ballot RSIDs that were assigned to Ballots for public validation, corrections and amendments as may be required.

7. The voter registration and voting system of claim 1 wherein:
(i) and the further steps and methods, whereby the actions, functions, operations and processing of this invention are performed by any combination and any number of any plurality of Official persons, designated agents, any number of “Vote Processing Devices”;
(ii) and the further steps and methods of the voting system of this claim, whereby any number of Officials, Officials appointees, utilize any number of combination(s) of “Vote Processing Devices” to send, receive or process any number of, and any type of: documents, forms, containers, and any number of data elements therein and any correlated information thereof, and also any number of and any type of: data files, data transmissions or any other objects or data of this invention—whereby any number of Officials use any combination of, and any number of Vote Processing Devices and any number of types of computer software programs to facilitate any number of tasks, such as, but not limited to the steps and methods to perform:
(a) research, identify, define, design, create, amend, correlate, associate, link, verify, authenticate, certify, prepare, organize, sort, assemble, record, store, print, publish, distribute, send, transmit, receive, create, assign, attach, link, embed, photograph, image process, image enhance, record, data scan, data detect, data reject, data store, data retrieve, electronically scan and detect, optically scan and detect, electromagnetically scan and detect, copy, duplicate, tally, count, calculate, search, sort, organize, mark, label, tag, identify, data encrypt, data decrypt, data convert, data translate, language translation, data reconstruction, data compression, data decompression, data inventory, data organization, data encoding, data decoding, data storage, data indexing, data retrieval, data linking, data embedding, data extraction, data manipulation, data optimization, task planning, data design, data software design, data tracking, data storage, data retrieval, random number creation, symbolic character design, printing, package labeling, package identification, package tracking, data security, document tracking, document identification, acknowledging, error identification, error recording, error correction, error transmission, error reception, error reporting, error authenticating, data reporting, data communicating, data printing, data publishing, transmitting data, receiving data—either internally by Officials or: to or from any number of, and any types of: Voters, legal entities, electronic devices, communications networks or “Vote Processing Devices”;
(b) translating human and device readable codes to modes, protocols or methods of communication, transmission, data storage, data indexing, decryption, encryption, compression, decompression of any data;
(c) locating, receiving, detecting, interpreting, translating, reporting, transmitting error free data;
(d) locating, receiving, detecting, interpreting, translating, reporting, and correcting compromised data, erroneous data, duplicate data or duplicate transmissions;
(e) enhance processing speed and/or accuracy of processing (scanning, imaging, reading, decoding, storing, searching, retrieving, analyzing, authenticating, validating, tallying, reporting, publishing) for any number of, and, any type of ballots, document(s), forms, containers and any other objects of this invention by assigning, correlating, affixing, attaching or embedding any number of markings, electro-magnetic fields, optical scanning markings, optical alignment markings or optical skew markings to ensure proper optical scanning, and/or proper electromagnetic processing;
(f) and the further steps and methods of enabling optical or physical orientation such as: a darkened, or highlighted or cut-away corner, V-notch, circular, rectangular or shaped hole punch(es) and/or markings) that is to be consistently implemented so as to assist in expediting sorting, organizing, scanning, counting, accounting or enumeration of any number of: documents, forms, containers and any objects of this invention;
(g) whereby Officials actively take steps to ensure the accuracy of data as well as to preserve data integrity, and ensure data longevity, data security and voter privacy.

8. The voter registration and voting system of claim 1 wherein: any type of Security Elements, are applied to any type and any number of documents of this invention, so as to preserve the integrity of Voting Session for any documents, data records, data communications, data containers, data storages whereby Security Elements are:
(A) any number voters create and assign passcode(s), password(s), signature(s), initials or any other uniquely identifiable physical marking(s), audio and/or video recording(s), electronic, electromagnetic, chemical, biological, physical structure and/or bio-metric data submission(s);
(B) any number of Official created linear barcode(s) or two dimensional barcode(s) or any other type of value weighted graphical symbolic representations of data; and the steps and methods of assigning any number of, and any type of: character symbols, data values, data elements, numbers, symbols or groups of human readable words, that are regarded as the source(s) of information, so that each unique content from the source(s) of information is correlated to a specific barcode pattern which shall be correlated to a uniquely encoded group of symbols that also has correlated, a unique numeric value for each unique barcode pattern and unique content of information; and for corroboration of accuracy, the further steps and methods of comparing the values and/or symbolic representations of each information element to the values or symbols derived from scanning the correlated barcodes; and the further steps and methods to retrieve or scan any number of any type of data elements or groups of human readable words, numbers and symbols that are regarded as or correlated as the source for the information element for each barcode; and for corroboration of accuracy, the further steps and methods of comparing the values and/or symbolic representations of each information element to the values or symbols derived from scanning the correlated barcodes; and the further steps of recording the results of comparison, signaling any number of error messages, and option steps of error verification analysis, error correction, error correction analysis so as to facilitate the accurate scanning of data associated with each barcode, and any number of barcodes;
(C) any number of Officially recognized characteristics or properties of materials or man-made devices such as: embedded micro-electronic or micro-optical or micro-chemical devices, holograms, Braille code embossing, optical structures or devices, electronic devices or structures, magnetic fields or devices, organic or inorganic chemicals, biological materials, genetic materials or genetic structures or genetic sequences, specialized man-made materials, crystal structures, plastics, metals, gas emissions, electromagnetic radiation, radioactive materials, optical emissions, natural fibers, man-made fibers, microfilm dots, microscopic writing, embossing, photon-sensitive symbols, photon-sensitive text, or infra-red radiation sensitive (text, symbols or images) on/in materials, electronic codes, optical codes, optical or digitized pictures, codes embedded within optical pictures or digitized pictures, watermarks, or seals of authenticity which are integral, affixed or associated thereto any document of this invention or any number of Vote Processing Devices of this invention;
(D) a plurality of Random Symbolic Identifiers (RSIDs) are manufactured by Officials using at least one computer running software programs such that: (i) each RSID is manufactured to be unique among all RSIDs of the Voting Session; (ii) each RSID is comprised of randomly selected symbols (chosen from a pre-defined reference group of symbols) that are directly usable by the Voters and Officials; (iii) officials estimate the total number of RSIDs required and thereafter calculate a larger quantity of character symbol permutations so as to completely accommodate the total number of RSIDs required, while also acting to remove undesirable symbol permutation patterns; (iv) during assembly, the quantity of selectable pre-defined symbols chosen is consistently the same for each usage type of RSID; (v) all of the selected RSID symbols are concatenated to produce one unique string of symbols to be the resultant manufactured RSID; (vi) each RSID pre-defined symbol of the preceding steps is consistently assigned a binary value or base X numbering system value (where X is any chosen number) which is the assigned symbol numeric value; (vii) for each manufactured RSID string, and for all of the symbols within each RSID, Officials consistently assemble a concatenated string of the assigned symbol numeric values that is directly correlated to the symbols within the RSID and is designated as the numeric value of the RSID; (viii) as a result of the preceding, each RSID is a unique group of symbols, and each RSID has a correlated unique numeric value—both of which are made to be near impossible to guess, derive, extract, predict or precalculate—and therefore whatever document or electronic file or data transmission uses an RSID is assured of protection against forgery as the voting system will reject invalid RSIDs and will also set flag and set aside any duplicate RSIDs; (ix) further said RSID symbols may be further data compressed; (x) said RSID may be further appended or prefixed by any number of data symbols used for error detection and/or error correction, usage designation identifier, data encryption security;
(E) and the further steps and methods whereby:
(i) Officials organize each type and group of RSID's to be rapidly retrievable with a minimum of processing for authentication and validation, which may be achieved by merging implementations of data storage, search, retrieval methods that is applied to any number of, and any type of data storage structures that are correlated to any number of flat-file, linked list, array, table, n-tree, object-oriented or relational databases and/or file structures or any combinations thereof, which are stored, accessed, indexed and manipulated by computer running software programs and that are communicating with any number of peer and/or supervisory computers and any number and combination of Vote Processing Devices using any number of communications systems and computer networks via any number of, and any types of communication devices, computer security devices and any number of types of computer software so as to effectively and efficiently process data—for optimal data storage, retrieval, integrity, longevity, security, privacy;
(ii) all created RSIDs are permanently recorded to at least one unalterable, immutable form of data storage that is securely stored;
(F) and the further steps and methods whereby officials create, assign and correlate any number of RSIDs, to any number of documents, any number of data containers, any number of data communications of this invention;
(G) and the further steps and methods of assigning, correlating and encoding each RSID and RSID numeric value and correlated RSID symbol string value to any number of barcodes and correlated barcode numeric values and derived barcode symbol-characters of prior step “B”;
(H) and the further steps and methods whereby:
(i) ALL valid RSID's created by Officials, except for any RSIDs received by all Registered Voters, or used for examples or testing purposes, are kept absolutely secret from all other Voters before and during a voting session;
(ii) any public RSID used for testing, examples or information purposes are disallowed in Eligible Voter Registrations, Voting Ballot counts and tallies;
(iii) Officials enable validation of any number of, and any type of RSID, by providing for each Voter, controlled access to a session limited number queries of valid RSIDs for any Document(s), Form(s), Container(s) or data record(s) of this invention,
(I) and the further steps and methods to securely mark, record, associate, attach, enclose, encrypt, embed any number of any type(s) of Security Elements of this claim to any number of documents, containers, data transmissions, data storages or data retrievals or any authentication processes for any claims of this invention.

9. The voter registration and voting system of claim 1 wherein: a Certified Registered Voter List is developed by one or more Officials who:
(A) use any number and combination of Vote Processing Devices to query various computer databases to gather, sort and record data to identify any viable Potential Voters;
(B) assign each identified person or legal entity of the preceding step “A”, a unique Potential Voter Identifier (PVID) which is public, and also a private, internal use RSID, and the further steps of correlating each Voter, public PVID and private, internal use PV-RSID;
(C) assign each Voter Identifier and each correlated PV-RSID of the preceding step “B” to be linked to and correlated to any number of lists, forms, documents, ballots, data containers, faxes, internet web-pages, internet emails, or any other information data of this invention;
(D) deliver or make available any number of incomplete Voter Registration forms by postal mail, electronic mail, facsimile, mobile data device, interactive television, interactive telephone, and/or by internet webpages for any number of Voters to complete and return deliver to Officials who receive for review, certification, amending or rejecting of each Voter Registration received;
(E) assemble at least one of each type of Voters Lists;
(F) conduct research to determine each Voter eligibility then assigns any number of Potential Voters to, at most, one type of Voter List of the preceding step;
(G) determine for any number of Potential Voters their unique geo-political voting region identifier or unique voting caste identifier and thereafter correlates each Potential Voter (based on their status according to step “D” of this claim) to a specific correlated Voters List assigned to the correlated geo-political voting region or voting caste;
(H) each Potential Voter is assigned a Voter Registration Status attribute so as to define whether the Voter has been registered to Vote in the Voting Session, and the further step whereby the attribute value is set by default to FALSE, NO or otherwise according to Voting Session Rules;
(I) Officials employ computers running software programs to query reliable data systems so as to determine whom will be eligible to vote during the Voting Session, and also gathers data as to how to contact those Eligible Voters and other Potential Voters;
(J) Officials create, print, distribute any number of Voter Registration forms to any number of Eligible, Potential and Unknown Voters;
(K) each WHOLE Voter Registration form is comprised of at least two parts, such that one part has exactly one MASTER Voter Registration form and the second part is comprised of any number of RECEIPT Voter Registration form(s);
(L) and the further step such that each MASTER and RECEIPT parts of each WHOLE Voter Registration is assigned at least one unique identifier, a Voter Registration Identifier (VRID) that is used to correlate MASTER or RECEIPT parts thereof, and to distinguish each Voter Registration form (and each MASTER, RECEIPT constituent parts) from among all other Voter Registrations forms, and the VRID is unique among all identifiers of this invention;
(M) for each WHOLE Voter Registration form, the component MASTER Voter Registration form part and all component RECEIPT Voter Registration forms parts (for the same WHOLE Voter Registration form) are correlated to each other by sharing the same unique Voter Registration Identifier (VRID) that is directly printed, embedded, affixed or otherwise magnetically encoded or electronically linked and correlated to each constituent part (MASTER, RECEIPT(s)) and also for each WHOLE Voter Registration form, for any form of presentation, storage, retrieval, processing, authentication, communication;
(N) each RECEIPT Voter Registration form is manufactured to be easily distinguishable from the MASTER Voter Registration form using any combination of word markings (e.g. RECEIPT) and symbols in any number of languages, any number of different colors, different texture, or different materials, different physical, electronic, electromagnetic, or optical representation, or any other form of visual, audio or tactile representation or markings that serves to noticeably differentiate and identify each RECEIPT Voter Registration form so as to be distinguished from every MASTER Voter Registration form—and may optionally include printing, affixing, attaching, linking, correlating or embedding any number of Security Elements consistently to a specific area for each part of each Voter Registration form parts (MASTER, RECEIPT);
(O) each WHOLE Voter Registration form (and each MASTER part and each RECEIPT part) is comprised of any number of portions, with at least one portion containing voting session name, voting session type, Voter Registration Identifier (VRID), at least one portion for recording voter identification, at least one portion for recording the voters legal name(s), any number of portions for recording the voter signature, at least one portion for recording the date of Registration form completion, any number of portions to record the preferred language(s) of the Voter which may used with or in lieu of the Voter Language Selection form;
(P) each Voter Registration form is allocated any number of portions for Voters or Officials to mark and record information elements for any number of: (i) personal identifiers, (ii) official defined passwords, (iii) voter defined passwords, (iv) printed names, (v) official signature(s), (vi) voter signature(s) (vii) date information, (viii) proxy assignments information, (ix) proxy signature(s), (x) location information (xi) contact information, (xii) voter alternative addresses, (xiii) proxy contact information, (xiv) voter or proxy: (a) telephone number(s), (b) cell phone or mobile phone numbers, (c) internet skype contact numbers, (d) electronic mail address(es), (e) internet webpage(s) for (i) online dialogue or (ii) to leave messages, (f) any other contact methods information;
(Q) at least one portion is assigned to any number of Voter Permanent Address Identifier (VPAID) with any number of portions for additional physical address information elements—whereby each Voter Permanent Address Identifier is unique among all VPAIDs and among all identifiers of this invention, yet any VPAID is not unique among voters as several voters may reside at the same VPAID address;
(R) each Potential Voter is correlated to any number of VPAID(s) of prior step “Q”;
(S) at least one portion is assigned to any number of Voter Mailing Address Identifier (VMAID) with at least one portion for additional physical address information elements—whereby each Voter Mailing Address Identifier is unique among all VMAIDs and among all identifiers of this invention, yet any VMAID is not unique among voters as many voters may share a same address;
(T) each Potential Voter is correlated to any number of Voter Mailing Address Identifiers;
(U) any number of additional portions are provided by Officials for any number of other types of useful, relevant information;
(V) and the further steps and methods of Officials physically or electronically delivering—any number of Voter Registration form(s) and any number of Voter Registration Data Return Container(s) to any number of Eligible, Potential, or Unknown Voters;
(W) and the further steps whereby at least one Official generates any number of uniquely identified Voter Registration internet webpages and further secures each webpage by encoding the internet URL for each Voter Registration webpage so as to be obscured by encoding the assigned Voter Registration ID that is made very hard to guess using such methods as those to create a Ballot Voting RSID; and the further steps such that each webpage accepts the potential voter input data which is error checked and then submitted with other non-input “hidden” submission data which is then correlated to the Voter Registration ID, and then to aforementioned Voter Registration Data and any other Voter Language Selection data;
(X) any number of Eligible, Potential and Unknown Voters receive, properly complete and return any number of Voter Registrations, keeping at least one REGISTRATION RECEIPT document copy for themselves for processing verification and self-identification; and the further steps whereby any number of Potential Voters register to vote by:
(i) properly and accurately completing their Voter Registration form,
(ii) completing and keeping any number of duplicate RECEIPT copy(s),
(iii) separating MASTER from RECEIPT copy(s), then return delivering at least ONE completed MASTER Voter Registration form(s) to Officials, either in person or by proxy delivery service or via a Voter Registration RETURN Data Container(s) with any required markings according to Voting Session Rules;
(iv) separating MASTER from RECEIPT copy(s), then return delivering any number of completed MASTER Voter Language Selection form(s) to Officials, either in person or by proxy delivery service or via a Voter Registration RETURN Data Container(s) with any required markings as per Voting Session Rules;
(Y) Officials receive any number of Voter Registration forms for validation processing;
(Z) The further steps and methods whereby: (i) at least one Official generates any number of internet webpages that shall then be correlated to each submitted voter registration and assigned one unique Voter Registration ID; and (ii) the further steps and methods whereby for each Officially Approved Voter Registration, at least one Official generates a Voter Language Selection internet webpage and then directly correlates each Voter Registration to the inputted Voter Language selection and associated data; (ii) and the further steps and methods whereby for each Officially Approved Voter Registration generate exactly one unique and privately accessible internet web page that is via the unique Ballot Voting RSID that is further encoded so as to be part of the Internet URL for the private webpage; and (iii) the further steps and methods whereby a voter can use any number and any type of electronic devices so as to connect to the Internet, telephone, interactive television system, or cell phone communications systems to securely access, input, verify, validate, review, amend, submit, retrieve, store, record, print or save—personal information and personal choices so as to complete: (i) any number of Voter Registration(s) or constituent parts thereof, (ii) any number of Voter Language selection forms or constituent parts thereof; (iii) any number of MASTER Ballot(s) or constituent parts thereof; (iv) any number of any other types of documents of this invention;
(AA) at least one Official records as part of Voter Registration, any number of portions of the Voter Language Selection information;
(AB) for any number of any types of Voters, Officials correlate any number of Languages for each Voter so as to provide language translations for any number of documents of this invention, as well as to provide spoken text of documents for the visually impaired;
(AC) for each physical or electronic version of the Voter Registration form, the value of the Voter Registration Identifier is correlated to any number of electromagnetically detectable magnetic ink symbols and/or readable optical symbolic codes (such as barcodes or pattern codes) or holographic images or to any number of any other type of Security Elements;
(AD) for each Master part or RECEIPT part of a Voter Registration (VReg) form and for each Voter Language Selection (VLS) form that is received by Officials, at least one Official records the information provided using Vote Processing Devices and then at least one Official acts to determine whether each received Voter Registration form and whether each Voter Language Selection form was properly completed, and the further steps whereby for incorrectly completed VReg form or VLS form submissions, the incorrectly completed form is rejected, and for successful submissions, the VReg form or VLS form is accepted, recorded and electronically stored; and the further step whereby for each correctly completed VReg forms, and for each correctly completed and correlated VLS form, Officials change the correlated Voter Registration Status attribute value to TRUE for submitted data that is accurate and verified by at least one Official; and the further steps whereby Officials certify any number of accurately verified Voters to be eligible to vote and then add them to the Certified Registered Voters list; embodying a voter registration and/or ballot as a smart card having private identifiers and passcodes encoded and embedded in magnetic stripes, holograms and/or micro-devices; creating and distributing a plurality of said smart cards to each Certified Registered Voter and to a plurality of Certified Registered Voters.

10. The Voting Session system of claim 1 wherein: Official(s) create, print, distribute, receive, sort, scan, image, read, decode, analyze, interpret, validate, authenticate, certify, error detect, tally, store, retrieve, publish and further process any number of WHOLE BALLOTS, whereby:
(A) each WHOLE Ballot is comprised of at least one part, whereby one part is the MASTER Ballot and any number of RECEIPT Ballot parts;
(B) each MASTER and RECEIPT parts of each WHOLE Ballot are assigned at least one shared, yet unique Ballot Random Symbolic Identifier (BALLOT-ID RSID), which is prominently visible on the WHOLE Ballot (and component MASTER and RECEIPT parts) so as to distinguish the considered WHOLE Ballot (and all of its component parts) from all other WHOLE Ballots and those other whole ballot component parts;
(C) each RECEIPT Ballot is manufactured so as to be easily distinguishable from the MASTER Ballot to the using any combination of additional word markings (such as word RECEIPT), raised symbols (such as Braille codes), as well as any number of different colors, different texture, or different materials, different physical, electronic, electromagnetic, or optical representation, or any other form of representation that noticeably differs from that which is used to manufacture the MASTER Ballot, that may include any number of Security Elements;
(D) each WHOLE Ballot component MASTER Ballot and all of the RECEIPT Ballots of the same WHOLE Ballot are correlated to each other by sharing the same unique BALLOT-ID RSID that is printed, embedded or linked to each MASTER and RECEIPT Ballot part;
(E) at most one Ballot-ID RSID is created and assigned to each WHOLE Ballot and constituent parts thereof; further creating a plurality of WHOLE Ballots and a plurality Ballot RSIDs for each Voting Session;
(F) each Ballot-ID RSID is correlated to a barcode which has an encoded symbol and symbol value equal to the concatenated symbols correlated numeric value of the RSID;
(G) at most, one private Ballot Voting RSID is created and assigned to each Ballot-ID RSID and kept hidden until the voter is prepared to make ballot choices and cast said ballot;
(H) at most one Official PassCode RSID is correlated to each BALLOT-ID RSID and/or each Ballot Voting RSID for the purpose of providing additional security for Vote Casting for each Whole Ballot MASTER part;
(H) each Voter creates any number of Voter PassCode (aka Voter PassWord) which are then correlated to each BALLOT they vote with, for the purpose of providing additional security for Vote Casting for Ballot MASTER part;
(I) for each type of PassCode (Official, Voter) each PassCode is correlated to one WHOLE Ballot and one correlated MASTER Ballot, and to each correlated RECEIPT Ballot;
(J) for each PassCode (Official, Voter) is kept hidden from view by a removable covering or openable container which is constructed in such a way that the only way for any PassCode to be viewable will automatically create evidence of having been revealed, thereby indicating that the Ballot may be already used or subject to unauthorized copying or future use;
(K) for each Ballot PassCode, any number of Security Elements may be printed, assigned, linked, correlated or embedded, for each correlated WHOLE Ballot and each correlated constituent part (MASTER or RECEIPT) by at least one Official;
(L) any number of Ballot PassCode of any type (Official, Voter) are correlated by Officials to any number of, and any type of, optically and/or electronically scannable identification marker codes, selection choices, data fields, symbolic codes, optical barcodes or electromagnetic codes which are associated with, attached to or embedded within any portion of any type of Ballot;
(M) for every Ballot, Officials allocate portions for Voters to mark and record information such that there are any number of portions for
(i) selecting any number of candidates,
(ii) selecting any number of proposals,
(iii) elements of voting information;
(iv) Security Elements;
(v) ballot processing markings;
(N) each MASTER Ballot part and each correlated RECEIPT Ballot part is subdivided into, and comprised of any number of portions:
(i) at least one Election Info portions—these portions provide information to enable the voter to independently make informed decisions regarding the ballot:
(i.1) at most one unique Voting Session Identifier, and any number of correlated Voting Session Details Identifiers which may be distinctly unique, or, optionally merged and encoded, so as to be correlated to any number of, and any type of optically and/or electronically scannable identification marker codes or any other symbolic codes, optical barcodes, or electromagnetic codes correlated, attached or embedded to each Voting Ballot, to facilitate automated processing;
(i.2) any number of correlated human-readable symbolic characters (graphical symbols, alphabetic or numeric character symbols that are correlated to any number of: Voting Session Identifiers, Voting Session Detail Identifiers, correlated reading templates and/or marker codes;
(i.3) at least one portion defining the scope of ballot application;
(i.4) at least one portion identifying the type of ballot;
(i.6) at least one portion of instructions for completing the ballot;
(ii) at least one Vote Selection portion—this portion provides information to enable the voter to independently make clearly informed decisions regarding the ballot selection options by providing specific information such as:
(ii.1) the title of political position which may optionally be repeated and also include a Candidate Position Identifier which may be further correlated to any number of scannable barcodes, electromagnetic or optical codes and materials, or other symbolic identifiers embedded or attached to each Voting Ballot;
(ii.2) at least one portion for a description of the voting region the ballot is correlated to any number of region data elements: (a) Voting Region NAME, (b) Voting Region IDENTIFIER, (c) Poll Stations IDENTIFIER, that may optionally be repeated and each are further correlated to any number of scannable marker and/or position codes, any number of correlated barcodes, any number of correlated RSIDs, or any number of symbolic codes or markings so as to facilitate automated processing and/or error detection and error processing;
(ii.3) at least one portion for Voting Information—(a) how many candidates to select and (b) how to properly select the candidates of choice;
(ii.4) at least one portion for Candidates and/or at least one portion for Proposals
(a) any number of candidate identifiers and descriptions of candidates to reduce selection errors;
(b) optional description(s) of each candidate's political party affiliation;
(c) any number of proposals identifiers and correlated descriptions of proposals;
(d) at least one portion for candidates selection and/or at least one portion for proposal selection area which contains at least designated “vote marking area” for each candidate or each proposal that is used to receive a Voter marking of the voter's choice of candidate(s) or proposal(s), so that each “vote marking area” is placed to clearly correlate to data of prior steps “(a-c)”; and any number of candidate “write-in” areas and/or any number of proposal “write-in” areas so that each “write-in area” is placed to clearly correlate to data of prior steps “(a-c)”;
(e) a plurality of data element location-position coordinates for each “vote marking area” and each “write-in area” of prior step “(d)”, any number of location-position coordinates portion of the ballot for correlating data elements therein, such that the location-position coordinates are derived from pre-defined vertical and horizontal areas and/or “reading templates” which are used independently or in conjunction with scan alignment markings and/or scan position markings to isolate and uniquely identify the position of all data elements within the ballot document, and is used to facilitate the extraction of data from the ballot by deriving and correlating the identity of each data element on the ballot to the scanned value found at the coordinates of each correlated data element;
(f) any number of Voter Write-In areas having any number of sub-areas to write or print the Voters alternative preferred candidate(s) given legal names and/or optionally the name of the political party and/or any number of alternative proposals that are the voter's preferred choice(s); and further steps and methods of having at least one area for each voter write/print in the legal name of a candidate that is to be used to mark the voter selection that is further correlated to each correlated voter write/print candidate legal names and correlated political party;
(iii) at least one Ballot ID portion—the ballot identification area comprising of, but not limited to:
(iii.1) any number of Security Elements, are embedded or associated in some way as to be inextricably linked to the Ballot, for the purpose of authenticating the Ballot for the Voting Session;
(iii.2) at least one Ballot Identifier—whereby each MASTER and RECEIPT Ballots that comprise a WHOLE Ballot are correlated to each other, and is uniquely identifiable among all other MASTER Ballots and all other RECEIPT Ballots of a Voting Session; and further step and methods that each Ballot Identifier is assigned at least one Random Symbolic Identifier (RSID); referred to as the “Ballot-ID RSID”; and the further step of methods by which each Ballot-ID RSID may be further encoded and correlated to a unique barcode symbol having a derived numeric value or symbolic string value equivalent to the correlated RSID derived numeric value or symbolic string value; and the further step of validating the Ballot is authentic and usable by submitting the Ballot-ID RSID to query the Official records of all valid Ballot-ID RSIDs; and the further step of any number of Voters casting a Master Ballot using a Ballot-ID RSID;
(iii.3) at most one Ballot Voting RSID—whereby each Whole Ballot and constituent Master and Receipt parts are assigned at most one private, hidden RSID that is revealed at the time of voting so as to enable the Ballot to be authenticated and certified for scanning, recording and tallying the Voter selected choices; and the further step that each “Ballot Voting RSID” may be further encoded and correlated to a unique barcode symbol having a derived numeric value or symbolic string value equivalent to the correlated RSID's derived numeric value or symbolic string value; and the further methods of validating the Ballot is authentic and usable by submitting the Ballot Voting RSID to query the Official records of all valid Ballot Voting RSIDs; and the further step of any number of Voters casting a Master Ballot using a Ballot Voting RSID;
(iii.4) at most one BALLOT PASSCODE (a.k.a. Ballot PassCode RSID) that is used in several ways to: (a) enable the Ballot-ID RSID or Ballot Voting RSID to be use for voting; and, (b) to prevent unauthorized access to electronic reporting of the Ballot Selections or any other information associated with a Ballot Voting RSID or Ballot-ID RSID; (c) whereby the Voting PassCode RSID may be optionally hidden to enable Ballot Validation using the Ballot-ID RSID without risking enabling of the Ballot-ID RSID to be used for Voting or access to Voter information; (d) whereby the Ballot PassCode RSID is constructed to be sufficiently different in length and/or composition so as to not be easily confused with the Ballot Voting RSID;
(iv) at least one LIMITS OF USE portion—defines any limitations of the Ballot and is comprised of data elements:
(iv.1) at most one Expiry Date, Time—is the final date and/or time after which the Ballot is no longer useful for the Voting Session;
(iv.2) any number of Due Dates and Due Times for receiving by Officials for tallying;
(v) a plurality of ALIGNMENT MARKS portions—whereby for any number of WHOLE, MASTER, or RECEIPT Ballots and any documents, forms or containers of this invention may each include any number of:
(v.1) alignment marks, alignment graphics, electronic encoding, magnetic fields, and/or any form of index identifiers for accurate orientation of optical, magnetic, electronic scanning device(s) so as to facilitate the accurate scanning of data on any ballot in reasonable condition; and to further provide location coordinates for any data elements therein;
(v.2) and the further steps for printed ballots or any other printed documents of this invention, of including darkened, highlighted or cut-away corner(s) or notched edge(s) so as to enable rapid sorting, identical orientation for scanning or filing;
(v.3) a plurality of location-position marks, pre-defined data field coordinates, and/or pre-defined data field “reading templates”;
(vi) at most one Voter Signature Portions—any number of spaces allocated for the Voter to place their personal signature mark or private voter password directly upon, or otherwise correlated to, any number of their master ballots and/or any number of their receipt ballots so as to provide further means of authentication and ballot tamper proofing;
(vii) at most one Voter Signature Date portions—any number of spaces allocated for the Voter to write or print the date that they signed (per (vi)) their ballot and/or ballot receipt;
(O) any number of encapsulating container or removable cover may be applied to a MASTER ballot or any other document such that the cover obscures essential, private data and may also reveal any amount of public, necessary to know information, by methods comprising of:
(i) completely obscured BALLOT VOTING RSID of prior step “N(iii.3)” that is within a sealed SENDING BALLOT DATA CONTAINER (physical or electronic), or,
(ii) BALLOT-ID RSID of prior step “N(iii.2)” that is visible through a viewing window of the sealed SENDING BALLOT DATA CONTAINER, so the partial Whole Ballot RSID provides enough data for verification, with disclosing the Voting Ballot RSID, or,
(iii) visible BALLOT-ID RSID paired with a completely obscured Official created BALLOT PASSCODE RSID that can only be made visible by the detectable removal of a temporary cover or by controlled access to an electronic presentation;
(iv) any number of visible BALLOT VALIDATION RSIDs are used to validate the ballot is genuine, and that is also correlated with a hidden (covered) BALLOT VOTING RSID and a hidden BALLOT PASSCODE RSID (Official created) which are revealed at ballot casting by removing the temporary cover(s);
(P) Officials enable methods for rapid automated optical scanning, electro-magnetic field processing, or high speed photographic picture taking and data analysis—for any number of and any type of documents of this invention; and for each physically printed or optically-visually rendered or electronically or electromagnetically rendered WHOLE Ballot and any other document of this invention, there are any number of electronic processing scanning markings used for marking boundaries of scannable data areas of detection within portions of voter and/or officials data areas so as to identify scannable data areas for scanning, imaging, enhancing, photographing, enhancing, reading and decoding by use of: (i) data start markers, (ii) data stop markers and/or (iii) combined data start/stop markers and further: (iv) optical alignment (a.k.a. skew) detection markings to ensure proper optical scanning detection for alignment error detection, alignment error measurement, alignment error messaging, alignment error correction for any number of portions of any number of and any type of physical document or physical data container of this invention; (v) Official employ any number of computers running software programs to provide any number of data processing steps and methods to: automatically provide data extraction, alignment measurement, data alignment correction, data orientation measurement, data orientation correction—for any number of portions of any type of documents;
(Q) Officials consistently mark, shape, or cut any number of corners of each MASTER Ballot part, and optionally each RECEIPT Ballot part, so as to enable a consistent method to orient, identify and/or sort to assist in sorting, organizing, scanning, counting by any number of humans and/or any combinations of any number of Vote Processing Devices;
(R) and the further steps and methods whereby Officials use the BALLOT VOTING RSID, and/or, BALLOT-ID RSID in whole or in part, as a derivable, integral component to encode or enable tracing or correlation of any number of, and any types of: data files, internet webpages, data storages, data transmissions, documents, ballots, registration forms, data containers, any type of data sets, any type of communications, and/or any type of objects of this invention.

11. The voter registration and voting system of claim 1 wherein at least one Official:
(A) encapsulates any number of WHOLE Ballots and each WHOLE Ballots correlated constituent components (MASTER, RECEIPTS) so as to facilitate any number of claims or processes of this invention while also ensuring Ballot contents security;
(B) associates, correlates, marks, attaches or embeds any number of, and any type of Security Elements, to any number of encapsulating containers of prior step “(A)”;
(C) associates, correlates, marks, attaches or embeds any number of RSID, to any number of encapsulating containers of prior step “(A)”;
(D) associates, correlates, marks, attaches or embeds any number of barcodes to any number of encapsulating containers of prior step “(A)”;
(E) correlates, records and stores for each encapsulated Ballot of prior steps “(A)” each of the Security Elements of steps “(B), (C), (D), (E)”;
(F) further correlates unique Registered Voter Identifiers (RVID's), private Voter RSIDs, to any number of Ballots and Security Elements of prior steps (A) to (E);
(G) and the further steps and methods whereby any number of Officials provide any number of, and any types of VOTERS and Officials with the means, materials, options and methods so as to enable any number of, and any types of Voters, any number of Officials, to mark on the OUTSIDE or EXTERNAL VIEW of each RETURN DATA CONTAINER with any number of unique RETURN DATA CONTAINER Security Elements, any number of RETURN VOTER-ID RSID BARCODE(s), and any number of correlated RETURN DATA CONTAINER IDENTIFIER SYMBOLS that are correlated to their respective RETURN DATA CONTAINER Security Elements, any number of RETURN DATA CONTAINER IDENTIFIER VERIFICATION VALIDATION text, numbers and/or symbols;
(H) and the further steps and methods whereby any number of Officials provide any number of, and any types of VOTERS to:
(i) mark and/or correlate their personal signature or any other private identifying information social security number, private password) and any number of Security Elements Ballot RSID, Ballot passcode) to be hidden from visibility and contained on the INSIDE of any number of, and any type paper, electronic) of SENDING DATA CONTAINERS and type of RETURN DATA CONTAINERS REGISTRATION FORMS RETURN ENVELOPES, MASTER BALLOT RETURN ENVELOPES, ELECTRONIC DATA CONTAINERS;
(ii) and the further steps whereby any number of ELIGIBLE VOTERS apply the methods of step “(G)” to actively mark, on the OUTSIDE or EXTERNAL VIEW of each RETURN DATA CONTAINER (MASTER BALLOT RETURN PAPER ENVELOPES, RECEIPT VOTER REGISTRATION ELECTRONIC DATA CONTAINER, DOCUMENT RETURN ENVELOPES, FORMS RETURN ENVELOPES, BALLOT RETURN ENVELOPES) with:
(i) any number of unique RETURN DATA CONTAINER RSID BARCODE(s);
(ii) any number of RETURN DATA CONTAINER RSID SYMBOLS that are correlated to the alpha-numeric value of the RETURN DATA CONTAINER RSID BARCODES;
(C) and the further steps and methods of enclosing, attaching or correlating:
(i) any number of election documents VOTER REGISTRATION MASTER part(s), VOTER REGISTRATION RECEIPT part(s), MASTER BALLOTS, RECEIPT BALLOTS);
(D) and the further steps and methods of correlating any number of RSIDS (such as, but not limited to WHOLE BALLOT VOTING RSID, VOTER REGISTRATION RSIDs), and any correlated SYMBOLS and alpha-numeric values thereof, to be further correlated to any number of BARCODES WHOLE BALLOT RSID BARCODE, VOTER REGISTRATION RSID BARCODE), with any type SENDING, HOLDING, RETURN, VERIFY, COUNT, CERTIFIED, FINALTALLY, STORAGE) DATA CONTAINER(s) (such as, but not limited to BALLOT RETURN DATA CONTAINER(s)), MASTER BALLOT RETURN DATA CONTAINER(s)) and the associated DATA CONTAINER RSID(s) with correlated DATA CONTAINER BARCODE(s) and any other types of DATA CONTAINER MARKING SYMBOL(s);
(E) and the further steps and methods whereby any number of Voters (or Voter Proxies) actively sends, transmits, or delivers, or, conveys:
(i) any number of MASTER Ballots,
(ii) any number of RECEIPT Ballots,
(iii) any number of, and any type of documents, forms or data of this invention;
(iv) any number of any type of DATA CONTAINERS of this invention—to any number of Officials, other interested persons or legal entities.
(F) whereby any number of Officials and/or any number of Officials, Official appointees/designates, Officials subordinate electronic devices and manual methods to actively send, transmit, or deliver at least one WHOLE Ballots (and it component MASTER, RECEIPT parts), and at least one correlated, pre-marked BALLOT Data Return Container of steps (A) to (G), to each Certified, Registered Voter;
(G) and the further steps and methods whereby any number of Officials and/or any number of Officials, Official appointees/designates, Officials subordinate electronic devices and to passively make available and/or to actively send, transmit, or deliver any number of, and any type of items of this inventions (BALLOTS, DOCUMENTS, FORMS, DATA CONTAINERS, telephone transmissions, internet web-pages, internet emails, faxes, interactive television transmissions) to any number of, and any combination of types of interested parties (Voters, News Media, Political Candidates, Government Officials, Voting Session Officials);
(H) and the further steps and methods of subsequently recording or amending any or all of the important, relevant data associated with any number of attributes associated with each type of Voter—in correlation with, or independent of, each type of crucial voting document (such as: each MASTER Ballot, each WHOLE Voter Registration Form, each Voter Language Selection form, each RECEIPT Ballot, or any other documents or “Data Containers”).

12. The voter registration and voting system of claim 1 wherein: any number of Voters and any number of Officials:
(A) act to determine the usefulness and validity of any number of, and any type of: Ballots, Registration forms, any other documents or Data Containers, or data records or data transmissions by correlating: any number of Security Elements and any number of non-Security Element portions, Election Information portion, Due Date portion, Due Time portion), and comparing to Official records utilizing any number of, any combinations of Vote Processing Devices—to transmit and receive information, as well as to provide data for the confirmation, rejection, or error messages as to the validity of each and any number of documents, data containers, communications or data information of this invention;
(B) performs any number of additional steps before revealing a Ballot Voting RSID or PassCode RSID, and before marking or casting their Ballot(s), to determine whether any number of WHOLE Ballots or constituent parts (MASTER, RECEIPT) were already used to Vote;
(C) and the further steps that if the Ballot is confirmed as not previously having been used to vote, any number of Voters may exchange, any number of times, any number of WHOLE Ballots they possess for other any number of similar WHOLE Ballots possessed by any number of other trusted Voters Eligible Voters, Proxy Voters) or exchange with any number of Voting Session Officials or their designated agents;
(D) and the further step whereby the Voter optionally does NOT open the sealed or encrypted WHOLE Ballot Container to verify the validity of the Ballot;
(E) and the further steps and methods whereby each the Voter DOES use any number of BALLOT VALIDATION RSIDs (in whole or in part), and/or any number of BALLOT VALIDATION PASSCODES (in whole or in part), as well as any other information and security elements displayed to verify Ballot usability and validity;
(F) and the further steps and methods whereby each BALLOT VALIDATION RSID and any number of correlated BALLOT VALIDATION PASSCODES or SENDING BALLOT CONTAINER ID are used to authenticate and verify exactly one WHOLE Ballot Container and any number of WHOLE BALLOT VOTING RSIDs within the correlated WHOLE Ballot Container, without revealing any WHOLE BALLOT VOTING RSID to anyone handing or exchanging any number of WHOLE Ballot Containers, until such time a WHOLE Ballot Container is opened at least one (WHOLE, MASTER, RECEIPT) BALLOT VOTING RSID(s) are revealed and further authenticated in correlation with any number of associated BALLOT VALIDATION RSID(s) and any other information associated with the WHOLE Ballots or WHOLE Ballot Container from which the WHOLE Ballot was extracted;
(G) and the further steps and methods of any number of Voters and any number of Officials and any number of any other Interested Parties validating any number of:
(i) Voting Ballot RSIDs (in whole or in part),
(ii) Voting Ballots correlated Ballot PassCode RSIDs—by comparing to Official records using any number of voting, registration and/or communications methods;
(H) and the further steps and methods whereby if it is determined that a Ballot Voting RSID has not been used to vote, then any number of Eligible, Registered Voter then completes any number of WHOLE Ballots whereby each Voter does any number of combinations of these following sub-steps (a),(b),(c) whereby for sub-step:
(a)(i) chooses any number of pre-defined Candidates and/or
(a)(ii) chooses any number of pre-defined Proposals on their MASTER ballot—by marking the MASTER part of the WHOLE Ballot, whereby the mark may be a circle, X, filled in circle, line, or any other style of mark in any form (physical, optical, electronic, and/or electromagnetic as per Rules of the Voting Session,
(a.iii) thus manually or automatically creating a duplicate mark on each RECEIPT part of every correlated WHOLE ballot that shares the same RSID;
(b.i) any Voter may be given the option to manually print or write-in, or use a typing device or electronic device interface to type in on the Voter's MASTER part of their WHOLE Ballot, any number of candidate names of the Voter's choice and/or any number of Proposals of the Voter's choice
(b.ii) whereby any number of Voters then chooses any number of their newly printed-written-in Candidates and/or any number of their newly printer-written-in Proposals of sub-step (b.i) by marking the MASTER part of the WHOLE Ballot, whereby the mark may be a circle, X, filled in circle, line, or any other style of mark, in whatever form (physical, optical, electronic, and/or electromagnetic) as per Rules of the Voting Session,
(b.iii) thereby manually or automatically creating a duplicate entry on each RECEIPT part of the WHOLE Ballot that shares the same RSID or any other method of MASTER-RECEIPT parts of every correlated WHOLE Ballot;
(c) and the further steps and methods whereby any number of Voters Personal Security Item mark and/or correlate their personal signature or any other private identifying information such as a Voter Private Password to any number of MASTER Ballots and to any number of RSID or otherwise correlated RECEIPT Ballots;
(d) and the further steps and methods whereby any number of Voters mark and/or correlate the date and/or time of completion to any number of MASTER Ballots and/or any number of RSID or otherwise correlated RECEIPT parts of each WHOLE Ballots;
(e) and the further steps and methods whereby any number of Voters mark and/or correlate RECEIPT Ballot, any number of: (e.i) personal signatures or Voter Private Password; (e.ii) and the further steps and methods whereby any number of Voters mark and/or correlate the date the ballot was signed or cast and/or any other time identifying information to any number of RECEIPT Ballots; (e.iii) and step whereby a plurality of Voters keep any number of RECEIPT Ballots that are correlated to their completed MASTER Ballot part of their WHOLE Ballot.

13. The voter registration and voting system of claim 1 wherein: at least one Official does accept, receive, acknowledge, sort, organize, record, store, tally, calculate, summarize, print or publish or otherwise process:
(A) a plurality of “voting documents”:
(i) Voter Lists;
(ii) Voter Registrations;
(iii) Voter Language Selections;
(iv) Voter Ballots;
(v) Data Containers;
(vi) Security Items;
(vii) Data Items; Data Transmissions;
(B) and the further steps and methods whereby EACH created “voting documents” (Voter Registration forms, Voter Language form, Ballot, Data Container) is assigned at least one new, unique data record containing at least one variable content data fields, and all records are stored in at least one data system which comprises of a new record identifier, date, time, location, and any number of other attributes are updated as needed to describe the various data and status conditions for each “voting document”;
(C) (i) and the further steps and methods whereby for processing (scanning, imaging, enhancing, reading, decoding, storing and correlating) of Voter Ballots includes said processing of data fields for each portion containing any number of candidates, proposals or any number of both candidates and proposals, which are each further correlated with any number of barcodes and further correlated with a portion of the area assigned to mark or record each voter voting information at least one Voting Region Identifier for any number of subsidiary Voting Region Identifiers, any number of polling station identifiers, any number of Postal Code-Zip Code identifiers, any number of geographic location identifiers at least one election type identifiers, any number of due date identifiers, any number of due time identifiers, any number of activation and/or expiry date identifiers, any number of activation and/or expiry time identifiers at least one Election Identifiers, at least one Voting Session identifiers, any number of Security Elements, at least one BALLOT VOTING RSID, or at least one Registration RSID, any number of PassCode RSIDs, any number of Validation RSIDs, any number of Validation PassCodes;
(ii) and the further steps and methods of processing (scanning, imaging, enhancing, reading, decoding, storing and correlating) each item of each Voter Ballot to a data field within the same unique data system record;
(iii) and the further steps and methods of providing a data retrieval key value for rapid location and retrieval of the aforesaid data-items;
(D) (i) and the further steps and methods of processing (scanning, imaging, enhancing, reading, decoding, storing and correlating) for any number of Voter Registrations processing for each Voter Registration, at least comprising of: any number of voter personal identifiers, at least one printed family names, at least one printed first name, any number of middle initials, at least one signatures and/or signed initials, any number of date information, at least one address information, any number of non-mail contact information, any number of email addresses, any number of cellphone numbers, any number of home phone numbers, any number of work phone numbers, any number of proxy voter: family names, first names, middles initials, addresses, telephone contacts, emails, signatures and/or initials; (ii) correlating and storing each item of each Voter Registration to a data field within the same unique data system record; (iii) providing a data retrieval key value for rapid location and retrieval of the aforesaid data-items;
(E) and the further steps and methods of processing (scanning, imaging, enhancing, reading, decoding, storing, correlating) for any number of and/or a plurality of Voter Language forms and all the relevant information therein;
(F) (i) the steps and methods of processing any number of personal identifiers, as well as the steps and methods for each Ballot, Registration or Language form of correlating of each aforementioned identifier or to the respective barcodes or other optical scanning markings or encodings, or electronic processing markings or encodings; (ii) and the further steps and methods of creating, assigning, attaching, linking and processing additional encoding for electronic or optical MASTERs to ensure accurate processing;
(G) and the further steps and methods of data storage, retrieval and organization of received Ballots, Voter Registrations and Voter Language forms so as to be easier to record, tally, identify, sort, store, locate, retrieve, publish or otherwise process;
(H) whereby Officials create, distribute and otherwise process any number of acknowledgements for each WHOLE Voter Registrations, MASTER Voter Registrations, RECEIPT Voter Registrations, WHOLE Ballots, MASTER Ballots, RECEIPT Ballots, WHOLE Voter Language forms, MASTER Voter Language forms, RECEIPT Voter Language forms, received from any number of Eligible Voters any number of: Potential Voters, Certified Registered Voters, Unknown Voters, Ineligible Voters, designated proxies or any other approved legal entities;
(I)(i) whereby Officials receive any number of: MASTER Ballots, RECEIPT Ballots, Voter Registration forms, Language Selection forms, Containers, Transaction Receipts, or any other documents, objects, data or data transmissions or communications of this invention;
(ii) whereby at least one Official accepts or rejects the validity and authenticity of each MASTER Ballots, RECEIPT Ballots, Voter Registration forms, Language Selection forms, Containers, Transaction Receipts or any other documents, objects, data or data transmissions or communications of this invention;
(iii) whereby at least one Official validates then accepts for recording and tallying any number of AUTHENTICATED, VALID MASTER Ballots, RECEIPT Ballots, Voter Registration forms, Language Selection forms, Containers, or any other documents, objects, data or data transmissions or communications;
(iv) whereby at least one Official verifies (manual visual comparisons, optical-electronic data scanning, computers running software programs performing signature-address validation comparisons) for each voter and/or proxy signature and any number of contact and/or address information located INSIDE or OUTSIDE of the BALLOT RETURN DATA CONTAINER or any other type of DATA CONTAINER so as to be compare to the signature, contact, address data recorded on the MASTER Voter Registration Form submitted prior to Whole Ballot delivery;
(v) whereby at least one Official either: (a) accepts the ballot as being from a registered voter, and then forwards the ballot for further processing associated with completing processing of the vote, or, (b) rejects the ballot and then takes steps of either returning the ballot and ballot-address-signature card to the voter for amendment(s) or, holds the ballot and ballot-address-signature card for further processing of investigations; and (c) for any type, and any number of documents, forms, data containers, objects, data transmissions, data storages that are “items” found to contain an RSID or any other UID determined to have been previously submitted, then: (c.i) both the duplicate and first object or data are each uniquely marked with new distinct RSIDs, recorded, tallied, removed and stored separate from all other valid, authenticated, certified objects or data for further investigation and authentication; (c.ii) Officials act to resolve which of the duplicates items are authentic and true, using Security Elements, then separately store the false object or data; (c.iii) Officials restore, certify, and tally each authentic, valid item. (d) the further steps of restoring each and all validated ballots, or final rejecting any un-validated ballots; (d) and the steps of recording and storing all Voter Personal Security Items that were provided for use by the correlated Voter and any number of Officials.

14. The voter registration and voting system of claim 1 wherein:
(i) any number of Voters request any number of replacements of any number of: Ballots, Voter Registration forms, Voter Language Selection forms, and any other documents, containers or data transmissions of this invention—the further steps whereby any number of Officials determine, for each Voter, the appropriateness whether to provide any number of replacements for any number of Voters whom are requesting replacements; (iii) and the further steps whereby any number of Officials either refuses or provide any number of any type of replacement documents to any number of Voters; (iv) and the further steps and methods whereby at least one Official records all relevant data regarding the replacement items provided and the recipient voter the item was provided to, then accurately amends each correlated Official record.

15. The voter registration and voting system of claim 1 wherein: at least one Official receives and investigates and number of Voter complaints of errors or omissions pertaining to any number of Voter Registrations, or, or any number of cast Ballot selections, (WHOLE, MASTER, RECEIPTs) or Ballots (WHOLE, MASTER, or RECEIPTs) or both Voter Registrations and Ballots, along with all relevant details, then Officials or their designated agents proceed to investigate whether to accept or reject each Voter request to amend any errors, record the Official findings of the investigation, and when required, Officials amend any number of disputed records, tallies, summaries, calculations, and publications for any number of Voter Registrations (WHOLE, MASTER, RECEIPTs) or Ballots (WHOLE, MASTER, or RECEIPTs), WHOLE Ballot Containers, Voter Information Containers, in accordance with the findings and Voting Session Rules, then any number of times, Officials verify each amendment was completed accurately, or resubmit any number of amendments, then provide a report to each complainant Voter and any number of other interested parties.

16. The voter registration and voting system of claim 1 wherein:
(i) each Data Container is assigned an RSID to be a unique CONTAINER VALIDATION RSID which is correlated to exactly one DATA CONTAINER;
(ii) and the further steps and methods whereby any number of CONTAINER VALIDATION RSIDs are correlated to any number of WHOLE BALLOT VOTING RSIDs within a WHOLE BALLOT CONTAINER;
(iii) and the further steps and methods whereby any number of CONTAINER VALIDATION RSIDs are printed, embedded, attached, correlated or otherwise associated with the publicly visible exterior of any number of WHOLE BALLOT CONTAINERs along with any number of details of the voting session, and any number of Security Elements are displayed clearly and prominently so as facilitate equitable ballot use and validation for exchanges by clarifying exactly which elections and voting region the WHOLE Ballot Containers internal WHOLE BALLOT VOTING RSIDs correspond to, and what time frame these items are useful for;
(iv) and the further steps and methods whereby if the WHOLE BALLOT CONTAINER is physical, said container is sealed so there may only be access to the internal Ballots by noticeably revealing access has occurred;
(v) and if the said WHOLE Ballot container is electronic, that the MASTER and RECEIPT Ballot voter sets of ballot choices and correlated voting data may not be easily revealed without decryption using any number of VALIDATION PASSCODES or other methods of controlling Voter and public access.

17. The voter registration and voting system of claim 1 wherein:
(A) the steps and methods whereby a plurality of voters and/or proxy voters use any number of, any type and combination of electronic devices to connect to the Internet, telephone or cell phone communications systems, or interactive television system, or electronic mail system to securely access, input, verify, validate, review, amend, submit, retrieve, store, record, print or save—personal information and personal choices to complete:
(i) any number of Voter Registration(s) or constituent parts thereof,
(i) any number of Voter Language selection forms or constituent parts thereof;
(iii) any number of MASTER Ballot(s) or constituent parts thereof;
(iv) any number of any other types of documents of this invention;
(iv) and the further steps and methods of any number of Voters submitting privately and securely to Officials all necessary data so as to enable Voter Registration, Voter Language Selection, and Voter Ballot Casting (a.k.a. “ballot voting”) reviewing or casting of any number of ballots for each registered voter, proxy or appointees;
(B) and the further steps whereby: any number of Officials and/or any number of third-parties provide services of:
(i) Official Computer Authentication—the steps and methods whereby any number of voters using computers, telephones or any other devices are provided with—any number of secure telephone lines, internet connections (HTTPS, SSL) and any amount of computer authentication data issued by a third party certificate authority so as to validate the authenticity of the official computers and communications systems being used for voting and communications are legitimate and authorized for use;
and (ii) the further steps and methods of:
(a) official computer and data storage hacker protection—the steps and methods whereby any number of official computers, telephones or any other devices and communications systems are provided with enhanced security software, equipment, personnel and procedures to ensure the electronic voting systems availability and reliability for use for authorized users, and the further steps and methods of providing any number of security measures to ensure the integrity and reliability of the voting system processes, such as, but not limited to, any number of: data transmissions, data receptions, data error corrections, document processing document validations, certifications, calculations and publications); and the further steps and methods whereby:
(b) Internet Identity Masking—the steps and methods whereby any number of Voters using computers connected to the internet for voting employ IP (internet provider) masking to hide their unique voter internet address identity by enabling each internet voter to appear as another unrelated IP address to any number of election computers; and the further steps and methods whereby IP masking employs (but is not limited to) software from third parties that connect to commercial or privately owned computer and routers so as to use the third party IP addresses as an alias for the voter, &/or connect any number of public or private masking network systems whereby internet routers encrypt the data and originating voters IP address so as to hide the voters data from internet users and further hide each voter's original IP and computer identity from the election computer systems, or employ clinet side software to make the sending device IP address and/or MAC machine identifier; and the further steps whereby:
(c) Voting RECEIPT Encryption—to ensure data integrity of RECEIPT ballots by reducing the possibility of falsification and ballot tampering—the steps and methods whereby any number of election computers encrypt any number of ballot RECEIPT information (ballot RSID, voter selection validation codes, RECEIPT sequence ID, RECEIPT validation code, date and time stamp) so that any number of public encrypted ballot RECEIPT codes (PUB-EBRC) are created to obscure the original ballot RECEIPT voting information by using at least one private encryption digital number (a private encryption key: PRI-KEY) and a private encryption algorithm (PRI-ENALG), and the further steps and methods whereby each original ballot RECEIPT information is recoverable from the correlated public encrypted ballot RECEIPT code (PUB-EBRC) by applying manually or by computer, the correlated private RECEIPT encryption key (PRI-KEY) and the correlated private RECEIPT encryption algorithm (PRI-ENALG) to the correlated public encrypted ballot RECEIPT code (PUB-EBRC); and the further steps and methods:
(i) whereby any number of public encrypted ballot RECEIPT codes (PUB-EBRC) are each correlated to the respective ballot RSID;
(ii) whereby any number of public encrypted ballot RECEIPT codes (PUB-EBRC) are optionally printed on the face of the ballot; (iii) whereby any number of ballot information data elements are NOT printed on each ballot to preserve privacy of data ballot RSID);
(iii) whereby any number of private encryption algorithms (PRI-ENALG) of this step are unique overall this invention and at least at least one private encryption key (PRI-KEY) is unique for each PRI-ENALG of this invention;
(iv) whereby any number of public encryption algorithms (PUB-ENALG) and public encryption keys (PUB-KEY) are provided and employed to enable general public validation of ballot RECEIPTs data and ballot RECEIPT codes without revealing the private encryption algorithms (PRI-ENALG) or private encryption keys (PRI-KEY);
(v) whereby to facilitate machine scanning, any number of barcodes and/or other symbolic marking codes are generated and correlated to any number of ballot information data elements and any number of public encrypted ballot RECEIPT codes, then printed on or incorporated into the ballot RECEIPT;
(vi) whereby to facilitate machine scanning, any number of geometric shapes, lines and/or other symbolic marking codes to be used for orientation or alignment are generated then printed on, or otherwise incorporated into the ballot RECEIPT
(C) and further steps whereby having successfully registered to cast a Ballot, a plurality voters and/or proxy voters each (a) may optionally first activate the ballot for use, applying the steps and methods of any number of BALLOT ACTIVATION DOCUMENTS, submitting Ballot Validation RSID and BALLOT PASSCODE in person, by telephone, internet, fax, email, etc.) or, (b) omits prior step and then opens any number of WHOLE Ballot Containers they possess, and (ii) the further steps and methods whereby the Voter is enabled to vote either in person, by mail, electronically or optically after revealing, viewing and using the Ballot PassCode RSID which may be delivered to the Voter separately from the WHOLE Ballot, or is within the WHOLE Ballot Container, and/or, printed on or associated with the MASTER Ballot, and the further step where the Ballot Passcode is also printed on the RECEIPT Ballot by Voting Officials, or, is not printed on the RECEIPT Ballot and must then be manually recorded by the Voter, and the further step where the Ballot PassCode on the RECEIPT may also have a removable covering for privacy; and the further steps and methods whereby a Ballot PassCode is used in conjunction with a BALLOT VOTING for that same WHOLE Ballot, MASTER Ballot or RECEIPT Ballot; and (iii) the further steps whereby any number of Voters complete by applying any number of: voter signature or voter private password, ballot signing date, ballot selection(s) and write-in choice(s) then submit Ballot Voting RSID, BALLOT PASSCODE for any number of MASTER Ballots and the further step of generating and then retaining any number of correlated RECEIPT Ballots for each MASTER Ballot completed; (iv) and the further steps and methods whereby any number of Voters deliver any number of MASTER Ballots to Election Officials or Officially Designated Recipients for tallying, as well as any number of successful completion RECEIPT CONFIRMATION that are delivered to each successful Voter by methods in person paper receipts, postal mail paper receipts, or electronic mail receipts, fax, tele-texting, interactive television, or internet website post-submit web-page(s), and to any number of third parties to verify the integrity of the Voting Session; and (v) the further steps and methods of INTERNET VOTING, whereby the steps and methods of INTERNET Validation and Internet Voting are performed by any number of Voters and the steps and methods used are (v1) use the Internet to connect to at least one Official Internet Voting Website that is secured from unauthorized manipulation; (v2) navigate from any number of webpage menus to a secure webpage form used for validation; (v3a) where upon accessing this webpage, an Internet Validation Session ID (IVALSID) is created by the Official Computers and correlated to each particular connected Voter; (v3b) obtains and utilizes any number of authentication certificates from any number of certificate authorities that are correlated to the respective IVALSID or IVOTSID; (v4) whereafter any number of connected Voters then enter a VALIDATION RSID or BALLOT VOTING RSID on their local computer Internet Browser webpage form and submit that form to the Internet Validation System (IVALS) for processing according to (but not limited to) claim 9; (v5a) whereafter the IVALS correlates the IVALSID to the RSID submitted, records this information along with, but not limited to: the Voter computer IP address, date and time, (v5b) the Official computer system employers computer running software programs and people to determine whether there have been statistically numerous RSID MASTERs from the Voter computer IP address for a given time period, and if so, communicates Denial Of Service (DOS) to the Voter and stops further processing of any number of offending Voter submitted RSID's; (v5c) whereby if there is no Denial of Service, the IVALS continues to determine whether the submitted VALIDATION RSID or correlated BALLOT VOTING RSID is valid and any number of other information items; (v5d1) whereby if the Voter enters a VALIDATION RSID that is determined to be valid, the voter is shown STATUS information of the Ballot (such as but not limited to: VOTED-OK, READY2VOTE, DISABLED) that is correlated to the VALIDATION RSID, but is NOT shown the BALLOT VOTING RSID, BALLOT PASSCODE nor any BALLOT SELECTIONS of the Voter; (v5d2) whereby if the Voter enters a BALLOT VOTING RSID that is determined to be valid, the voter is shown STATUS information of the Ballot (such as but not limited to: VOTED-OK, READY2VOTE, DISABLED) as well as the VALIDATION RSID, BALLOT VOTING RSID; (v5d3) whereby the IVALS prompts the Voter, a limited number of times, to provide any number of BALLOT VOTING PASSCODE on a secure website form; (v5d4) whereby any number of Official people and/or computers running software programs, determine whether the BALLOT VOTING PASSCODE provided in step (v5d3) is correlated to the BALLOT VOTING RSID of step (v5d1,2); and (v5d5) the further steps and methods of to determine whether the number of attempts to provide a VALID BALLOT VOTING PASSCODE has exceeded limitations; and (v5d6) the further steps and methods of temporarily disabling the BALLOT if the number of attempts to provide a VALID BALLOT VOTING PASSCODE if step (v5d5) are found has exceeded limitations; (v6) and the further steps and methods according to this claim, whereby if the Voter enters a BALLOT VOTING PASSCODE RSID that is determined to be valid, and the BALLOT VOTING RSID has NOT been disabled then the voter receives the VALIDATION RSID, VOTER SELECTIONS and any number of other information items associated with of the BALLOT VOTING RSID; and (v7) the further steps and methods according to this claims whereby if the ballot has not been cast, the voter is provided (but not limited to) the options to vote or not vote; and (v7a) the further steps and methods of the choice of NOT VOTE, the Voter exits Internet Validation System (IVALS) without adversely disabling the Ballot from future use; and (v7b) the further steps and methods upon the Voter choice to VOTE: (v7b1) the Voter is connected by Official Voting Computer to the Internet Voting System (IVOTS) webpage; (v7b2) a unique Internet Voting Session ID is generated, stored and associated with the BALLOT VOTING RSID provided by the Voter; (v7b3) the IVOTS provides the Voter with any number of choices such as, but not limited to, any number of: (v7b3i) Candidates, (v7b3ii) Proposals, (v7b3iii) related information items (such as but not limited to: web page hyper-links to Candidate biographies, hyper-links to Candidate political party affiliations and policies, hyper-links to Proposal descriptions), (v7b3iv) options to process the Voting form (SUBMIT, CANCEL, RESET, PAUSE, SAVE, EXIT); (v7b3v) options to store and communicate selections made, (SAVE2DISK, PRINT, PUBLISH, EMAIL); and (v7b4) the further steps and methods whereby the Voter completes and submits their Ballot selections; (v7b5) then any number of errors are detected and identified to the Voter by the IVOTS computer software, (v7b6) whereby any number of corrections are made, any number of times, by each Voter until ALL Ballot selections are error free, (v7b7) whereby the Voter submits the Ballot Selections for final processing to the IVOTS, and (v7b8) the further steps and methods whereby if the Ballot Selections are processed successfully, (v7b8i) a unique IVOTS RECEIPT ID is generated, then correlated to the IVOTS Session ID and further correlated to the BALLOT VOTING RSID and BALLOT VOTING PASSCODE, and further correlated to the BALLOT VALIDATION RSID that is correlated to the BALLOT VOTING RSID; and (v7b8ii) the further steps and methods whereby the IVOTS RECEIPT ID, Session ID, BALLOT VOTING RSID, BALLOT VOTING PASSCODE, BALLOT VALIDATION RSID, Ballot Selections and any number of other related information items are permanently and redundantly stored, then transmitted securely to, and received by, but not limited to: any number of Election Officials, Political Parties, Candidates, and any number of other approved third parties for processing actions, verification and/or accounting in any number of formats; using the unique, private Ballot RSID as part of an Internet address to organize and privately store each voter webpage, as well as tallies and summaries of voter selections employing any number of methods of processing; and (v7b9) the further, optional, steps and methods for each INTERNET Ballot, of detecting, reporting, and stopping processing of appropriate Ballot cast via IVOTS upon detecting NOT timely receiving the PRINTED MASTER or RECEIPT Ballot, or, disregarding any number of failures of delivery of any number of PRINTED MASTER or RECEIPT Ballots that are correlated to an INTERNET Ballot cast via the Internet Voting System (IVOTS); and (v8) the further steps and methods of transmitting any number of RECEIPT CONFIRMATION documents to each voter either electronically, (using methods webpage form, email to each voter provided email, or paper receipt documents) to each voter who has successfully submitted their ballots in person or electronically; and (v9) the further steps of applying any number of the aforementioned steps and methods, actions, data or results any number of times, to any number of Ballots, Voters, Officials, or other legal entities, by any number of Voters, Officials or other legal entities; and (w) the further steps and methods of TELEPHONE VOTING, whereby the steps and methods used are (w1) Telephone Validation—whereby (w1a) any number of Voters use a telephone to connect to the Telephone Validation System (TVALS); (w1b) any number of Official computers running software programs creates a Telephone Recording Session (TELVALID) that is automatically identity labeled and correlated to the Telephone Validation Session; (w1c) any number of Official computers running software programs obtains and utilizes any number of authentication certificates from any number of certificate authorities that are then correlated to the TELVALID; (w1d) any number of Official recording devices are automatically connected and record the Telephone Validation Session; and (w1e) any number of Official computers running software programs optionally determine the Voter Telephone Number to detect issues excessive RSID guessing; (w1f) the voter uses the telephone keypad, verbally words, or any other acceptable methods to navigate through any number of menus and any number of menu options to interact with the validation menu; (w1g) each Voter then uses an approved method (keypad tones, verbal words, text message menu option selections) to enter a BALLOT VALIDATION RSID or BALLOT VOTING RSID; (w1h) the TVALS records the RSID and correlates it to the TELSID along with the date, time and optional voter telephone number; (w1i) Official TVALS system then determines whether any statistically significant issues are related to the voter telephone number or RSID provided, and if so, then communicates Denial Of Service to the voter; otherwise, (w1j) proceeds to determine whether the BALLOT VALIDATION RSID or correlated BALLOT VOTING RSID are valid along with any number of other information items; (w1k) whereby if the Voter enters a BALLOT VALIDATION RSID that is determined to be valid, the voter is informed of the STATUS information of the Ballot that is correlated to the BALLOT VALIDATION RSID, but is NOT informed of the BALLOT VOTING RSID, BALLOT PASSCODE nor any BALLOT SELECTIONS made by the Voter, and if a valid BALLOT VALIDATION RSID correlated to valid, enabled, BALLOT VOTING RSID was provided by the voter, the voter is given the option to vote via telephone such that on selecting the choice to NOT VOTE, the voter then exits the Telephone Validation System; otherwise, on selecting VOTE, the Voter is connected to the Telephone Voting System and asked to provide a BALLOT VOTING RSID; (w2a) whereby if the Voter enters a BALLOT VOTING RSID that is determined to be valid, the voter is informed of the STATUS information of the Ballot as well as the BALLOT VALIDATION RSID, BALLOT VOTING RSID; (w2b) a Telephone Voting Session (TELVOTID) is automatically created and correlated to the Telephone Validation Session; (w2c) TELVOTS or any number of Voters obtains and utilizes any number of authentication certificates from any number of certificate authorities that are then correlated to the TELVOTID; (w2d) any number of recording devices are automatically connected and record the Telephone Voting Session; and (w2e) optionally, the Voter Telephone Number to detect issues of excessive RSID guessing and/or attempted security breaches; (w2f) each telephone voter uses the telephone keypad, verbally words, or any other acceptable methods to navigate through any number of menus and any number of menu options to interact with the validation menu; (w2g) whereafter the TVALS prompts the Voter, a limited number of times, to provide the BALLOT PASSCODE; (w2h) whereafter the Voter provides a PassCode, preferably the one correlated to the BALLOT VOTING RSID; (w2i) whereafter any number of officials determine whether (w2i1) the BALLOT PASSCODE provided by the Voter is correlated to the BALLOT VOTING RSID thus is VALID, (w2i2) the number of attempts to provide a VALID BALLOT PASSCODE has exceeded limitations which results in disabling the BALLOT; (w2j) whereby if the Voter enters a BALLOT PASSCODE RSID that is determined to be valid, and the BALLOT VOTING RSID has not been disabled, the voter receives the VALIDATION RSID, VOTER SELECTIONS and any number of other information items associated with of the BALLOT VOTING RSID, and (w2k) if the ballot has not been cast, the voter is provided with (but not limited to) the options to vote or not vote; (w2l) whereupon the choice of NOT VOTE, the Voter exits Internet Validation System (IVALS); (w3a) otherwise upon the Voter choice to VOTE: (w3a1) the Voter is connected by Official Voting Computer to the Telephone Voting System (TVOTS); (w3a2) a unique Telephone Voting Session ID is generated, stored and associated with each BALLOT VOTING RSID provided by the Voter; (w3a3) the TVOTS provides each Voter with any number of choices (w3a4i) Candidates, (w3a4ii) Proposals, (w3a4iii) related information items (such as but not limited to: menu-options for Candidate biographies, menu options to Candidate political party affiliations and policies, menu-options to Proposal descriptions), (w3a4iv) menu options to process the Voting form (SUBMIT, CANCEL, RESET, SAVE, EXIT); (w3a4v) menu-options to store and communicate selections made, (SAVE2DISK, PRINT, PUBLISH, EMAIL); and (w3b1) the further steps and methods whereby the Voter completes and submits their Ballot selections then any number of errors are detected and identified to the Voter by the IVOTS computer software, (w3b2) whereafter any number of corrections are made, any number of times by the Voter until all the Ballot selections are error free; (w3b3) whereafter the Voter submits the Ballot Selections for final processing to the IVOTS; (w3b4) if the Ballot Selections are processed successfully, a unique IVOTS RECEIPT ID is generated, that is then correlated to the IVOTS Session ID and further correlated to any number of other Voting System Identifiers and data the BALLOT VOTING RSID and BALLOT PASSCODE, and further correlated to the VALIDATION RSID that is correlated to the BALLOT VOTING RSID; and); and (w3b5) the further steps and methods of transmitting any number of RECEIPT CONFIRMATION documents to each voter either electronically, (using methods webpage form, email to each voter provided email, or paper receipt documents) to each voter who has successfully submitted their ballots in person or electronically; and (w4a) the further steps and methods whereby any type of Voting System IDs and data items the IVOTS RECEIPT ID, Session ID, BALLOT VOTING RSID, BALLOT PASSCODE, VALIDATION RSID, Ballot Selections and any number of other related information items are permanently and redundantly stored, then transmitted securely to, and received by entities any number of Election Officials, Political Parties, Candidates, and any number of other approved third parties, for publishing, investigation, verification and accounting in any number of formats (physical, optical, electromagnetic and/or electronic); (w4b) the further steps and methods such as but not limited to: using the unique, private Ballot RSID as part of an Internet address to organize and privately and redundantly store each voter webpage, as well as tallies and summaries of voter selections; and (w4c) the further, optional, steps and methods for each TELEPHONE Ballot, of detecting, reporting and stopping processing of the appropriate TELEPHONE Ballot cast via TVOTS upon detecting NOT receiving the PRINTED form of the MASTER or RECEIPT Ballot(s), or, disregarding any number of failures of delivery of any number of PRINTED MASTER or RECEIPT Ballots that are correlated to a TELEPHONE Ballot cast via the TVOTS; and (w5) the further steps of applying any number of the aforementioned steps and methods, actions, data or results any number of times, to any number of Ballots, Voters, Officials, or other legally recognized entities, by any number of Voters, Officials or other legal entities; and (x) the further steps and methods of Validation and Voting by Fax or Email (x1) whereby the Voter follows in general the modified previous steps and methods of Internet and Telephone Validation and Voting, such that any number of Voters generally do, but are not limited to: (x1a) obtains and utilizes any number of authentication certificates from any number of certificate authorities; (x1b) any facsimile device or computer running facsimile software or document processing software or email software or any other combination of electronic devices and/or software in conjunction with any number of and any types of communications system and methods to connect to the FAX-EMAIL Validation System (FEVALS); (x2a) whereupon successfully connecting, a unique FAX-EMAIL Validation ID (FEVALID) is generated and associated with the fax-email session; (x2b) FEVALS and/or any number of Voters obtains and utilizes any number of authentication certificates from any number of certificate authorities that is correlated to each respective, originating FEVALID; (x2c) the type of connection is determined (FAX or EMAIL) and is logged along with the date, time, and optionally, the Voter telephone number or email address; (x2d) the Voter then submits the VALIDATION RSID to the FEVALS; (x2e) whereafter the FEVALS receives the VALIDATION RSID, or BALLOT VOTING RSID, then employs any number of steps and methods according to (but not limited to) claim 9 along with computers running software for optical image and character recognition so as to securely receive and process the faxed or emailed data faxed image of validation data, email text data, email attached data file, such as, but not limited to PDF image file) to validate any number data items using any number of computers, running computer software programs optical character recognition software and/or intelligent character recognition software; (x2f) whereby officials transmits the validation results to the voter, using the appropriate communication method based on the type of connection or response method (EMAIL, FAX or optional VOICE MESSAGE or TEXT MESSAGE); (x2g) whereby the Voter then receives the validation status of the ballot, form, document or container, as to whether it is valid and if so, whether the item has already been used; (x2h) if the BALLOT VOTING RSID was provided and was determined not to have been previously used and the ballot is enabled to be cast, the Voter FAX-EMAIL is automatically connected to any number of Fax-Email Voting System (FEVOTS) computers and/or Officials and automatically exited from the Facsimile-Email Validation System (FEVALS); (x2i) whereby, for each BALLOT VOTING RSID received, the FEVOTS system takes actions (x2i1) create a FAX-EMAIL Voting Session ID (FEVOTID) that is then correlated to the BALLOT VOTING RSID then stored redundantly and processed; (x2i2) FEVOTS and/or any number of Voters obtains and utilizes any number of authentication certificates from any number of certificate authorities that is correlated to each respective, originating FEVOTID; (x2i3) the FEVOTS then provides a limited number of opportunities to enter the correct Ballot PassCode before locking out the BALLOT VOTING RSID from voting until released by Election Officials; (x2i4) scan the Voter email or fax message to determine whether there is an image file of the Ballot showing Voting Selections of Candidates, Proposals, or other choices, along with the Ballot Voting PassCode and (x2i5) if any number of these items are found, then the FAX-EMAIL Voting System (FEVOTS) enacts the steps and methods to determine if the submitted BALLOT VOTING PassCode provided is valid, (x2i6) in the case the Ballot PassCode was incorrect, the Voter is notified of denial of Voting, and no further processing of the Ballot occurs, otherwise, (x3) if the FEVOTS determines the Ballot PassCode DOES correlate to the BALLOT VOTING RSID, then: (x3a) the methods whereby the FEVOTS employs any number of people, and any number of computers running software optical character recognition programs to determine exactly which candidates, proposals or other choices were selected on the Ballot; (x3b) the further steps and methods whereby any number of errors are detected and identified to the Voter by FEVOTS computers running software programs and any number of human Officials, (x4) whereafter any number of corrections are made, any number of times by the Voter until ALL Ballot selections are error free; (x5) whereafter the Voter submits the Ballot Selections for final processing to the FEVOTS; (x6) if the Ballot Selections are processed successfully, a unique FEVOTS RECEIPT ID (FEVOTS-RECID) is generated, then correlated to the FEVOTS Session ID and further correlated to Voting System Identifiers BALLOT VOTING RSID, BALLOT PASSCODE, VALIDATION RSID for the correlated BALLOT VOTING RSID; and (x7) the further steps and methods of transmitting any number of RECEIPT CONFIRMATION documents to each voter either electronically, (using methods webpage form, email to each voter provided email, or paper receipt documents) to each voter who has successfully submitted their ballots in person or electronically; and (x8) the further steps and methods whereby any type of Voting System ID, FEVOTS RECEIPT ID, Session ID, BALLOT VOTING RSID, BALLOT VOTING PASSCODE, BALLOT VALIDATION RSID, Ballot Selections and any number of other related information items are permanently and redundantly stored, then transmitted securely to, and received by, but not limited to: any number of Election Officials, Political Parties, Candidates, and any number of other approved third parties for verification, investigation and accounting in any number of formats approved third parties, for publishing, investigation, verification and accounting in any number of formats (physical, optical, electromagnetic and/or electronic); (x8) and the further optional steps and methods of using the unique, private Ballot RSID as part of an Internet address to organize and privately store each voter webpage, as well as all actions, tallies and summaries of voter selections; and (x9) the further, optional, steps and methods for each FAX-EMAIL Ballot, to detect, report and (x9a) stop processing of the appropriate FAX-EMAIL BALLOT cast via FEVOTS upon detecting any types of critical failures, failure of timely RECEIPT of the PRINTED MASTER or RECEIPT Ballot, or, (x9b) of disregarding any number of failures of non-critical events; delivery of any number of PRINTED MASTER or RECEIPT Ballots correlated to a FAX-EMAIL Ballot cast via FEVOTS;
(Y) and the further steps and methods of each voter (i) affixing any number of personal identifiers their personal signature, personal verification data, private password, personal email address, and any number of date or time information to any number of paper, or electronic ballots, registration forms, data containers or any other types of documents of this invention MASTER voter registration form, MASTER language preference form, WHOLE ballot RECEIPT part, and (ii) further steps and methods of affixing per step (Y)(i) either INSIDE (preferred to protect private sensitive data), or, upon the OUTSIDE, or any combination thereof per items, so as to be upon or within any type of RETURN CONTAINER of this invention; and the step of any number of voters or proxy voters generating a digital signature or applying their voter registration identifier and employ at least one digital signature algorithm to digitally sign their ballot, and/or voter registration and/or voter language selection, any types of containers, and/or any number of affidavits for ballot replacement;
(Z) for any number of Ballots being cast, any number of Official may optionally first determine if the ballot has previously been activated for use by any number of BALLOT ACTIVATION DOCUMENTS and then separating Ballot processing as per Voting Session rules;
(AA) and for the aforesaid steps and methods, the further steps and methods of applying any number of symmetric and/or asymmetric digital data encryption key pairs, digital key certificates by using computers running software programs employing encrypting algorithms and/or decrypting algorithms to digitally sign, digitally authenticate, encrypt, decrypt, read and/or secure any number of: voter ballot data sets, voter registration data sets, voter language data sets, voter personal security items, any types of containers, any types of system data sets, any types of processing data sets, any types of transaction identifiers, ballot images, registration form images, language selection form images, container images, any types of voter identification images, any types of document images, any types of affidavits, any types of documents, communications, data storages, images, reports or tallies of the invention.

18. the voter registration and voting system of claim 1 wherein: Officials provide steps and methods for each Ballot, Voter Registration, Voter Language Form, or any other items related to the Voting Session that is received, such that a certified copy is made available to at each Eligible Voter for verification and error detection, and that at least one means, method and opportunity of reporting errors is provided, and the further steps and methods whereby any number of Officials, or any number of Eligible Voters, or at least one designated representative (proxy) that possess the unique combination of the BALLOT VOTING RSID and PassCode RSID for each disputed Voter Registration or Ballot submits the Voter Registration or Ballot electronically to Officials, or, any number of errors are reported by presentation of any number of sufficiently intact physical Ballot (WHOLE, MASTER or RECEIPT), or any number of Voter Registrations (WHOLE, MASTER, or RECEIPT), or Voter Language forms (WHOLE, MASTER, RECEIPT), or any number of WHOLE Ballot Containers by any number of Potential Voters, Eligible Voters or designated representative (proxy) Voters for each disputed: Voter Registration, Voter-Proxy Language Selection form, Ballot (WHOLE, MASTER, RECEIPT), or Container; and the further steps and methods whereby for any number of special persons or other special legal entities that are authorized by a Voter owning an appropriate, bona fide RECEIPT, to be given access to any electronic, digital, or any other transformed version of any printable Ballot, Form, Document or Container of this invention, the Officials will provide a certified copy or representation of any number of items identified as Crucial Integrity Data Items; and the further steps whereby at least one Official provides each Voter with at least one method, and at least one opportunity, to verify or correct the accuracy of the Official Record of any record, tally, calculation, summary, or publication pertaining to any certified ballots or certified ballot vote selections; and the further steps and methods whereby any number of Voters, or authorized legal entities, use their RECEIPT Ballot and any number of methods to verify the accuracy of ballot processing or any other document/record processing, using a telephone, cellular phone, interactive television, personal data communications device, or, a computer connected to the Internet, television network, cable TV data network, or tele-communications network, or in-person using any combinations of optical, electronic, electromagnetic personal and/or Official Vote Processing Devices, any number of Voters verify or reject any Official record, tally, calculation, summary, or publication of their MASTER Ballot or voting selections made on their MASTER Ballot; and the further steps and methods whereby any number of Voters notify Officials to investigate and correct any number of errors discovered; and the further steps and methods whereby at least one Official records each Voter request to investigate, with all relevant details; and the further steps and methods whereby any number of Officials proceed to investigate whether to accept or reject each Voter request to amend any number of errors, then report to any number Voters and/or authorized legal entities, as to whether an amendment is required as requested, along with each Official findings of the investigation which is all duly recorded in the official records; and the further steps and methods if required, whereby at least one Official then amends the records, tallies, summaries, calculations, and publications to correct the records and tallies of any number of MASTER Ballots, or voter selections made on the MASTER Ballots, in accordance with the findings and the Rules of the Voting Session; and the further steps and methods whereby at least one Official verifies any amendments were completed accurately; and the further steps and methods whereby at least one Officials records in the Official records, and reports to any number of Voters or other interested legal entities as to when the amendments are completed, along with the results of the Official verification of the amendments; and the further steps and methods whereby at least one Official provides each Voter with at least one method, and at least one opportunity, to accept or reject the accuracy of any amended records, tallies, summaries, calculations, or publications; and whereby any number of Voters verify correctness or report errors of any number of amendments.

19. The voter registration and voting system of claim 1 wherein:
(A)(i) at least one Official generates any number of internet webpages and any number of official use only intra-net webpages and/or printable document visual renderings that shall then be correlated to each submitted voter registration and assigned one unique Voter Registration Identifier and that is correlated to the set of registration data and set of registration system data and set of registration processing data for each Voter Registration Identifier;
and (ii) the further steps and methods whereby for each Officially Approved Voter Registration, at least one Official generates a Voter Language Selection internet webpage and any number of official use only intra-net webpages and/or printable document visual renderings that are each correlated to said Voter Registration Identifier and to the set of voter language data and set of language system data and the set of voter language selection processing data for each submitted Voter Language selection;
(iii) whereby for each Officially Approved Voter Registration at least one Official generates exactly one unique and privately accessible internet web page with a webpage internet address that is correlated via the unique Voter Registration that is further encoded so as to be part of the Internet URL for the Ballot private webpage; further said webpage is protected by a voter changeable password requiring authentication to change said password; and any number of official use only intra-net webpages and/or printable document visual renderings that shall then be correlated to each unique Voter Registration Identifier;
(iv) for each submitted Ballot-ID RSID and/or Ballot Voting RSID generating any number of internet web-pages and/or any number of official use only intra-net web-pages that are directly correlated to the set of voting data, set of voting system data and/or the processing data set for each Ballot-ID RSID thereof said Ballot-ID RSID and/or Ballot Voting RSID; and any number of official use only intra-net webpages and/or printable document visual renderings that shall then be correlated to each submitted Ballot Voting RSID and/or Ballot-ID RSID; said webpage internet address that is correlated via the unique Ballot Voting RSID and/or Ballot-ID RSID that is further encoded so as to be part of the Internet URL for the Ballot private webpage.

20. The voter registration and voting system of claim 1 wherein:
(i) officials creating a plurality of organizational groups each comprising of any number of sub-groups and correlated attributes thereof for organizing a plurality of: any type of data, any type of RSIDs, any types of processes, any types of transactions, any types of documents, ballots, voter registrations, proxy registrations, language selection forms, containers, data encryption key pairs, encrypted data, encrypted ballots, encrypted voter registrations, any type of events, any type of errors, any type of communications, any type of images, tallies, reports, publications, webpages, official records, voter data, security elements;
(ii) a plurality of computers running artificial intelligence programs performing distributed processing and optimization of: task prioritization and workload balancing among a plurality of vote processing devices, and further providing distributed processing and optimization for any number of data processing tasks, processes, steps and/or methods of the invention;
(iii) Officials verify, validate, certify then publish the final amended records, tallies, calculations, summaries and reports pertaining Voter Registrations, Ballots, and any other relevant aspect of the Voting Session;
(iv) after all ballots are tallied and imperative issues are resolved according to Voting Session rules, at least one Official declares the Voting Session as completed.
